(19) United States
(12) Patent Application Publication
(10) Pub. No.: US 2026/0159448 A1
(43) Pub. Date: Jun. 11, 2026

(54) CONCRETE ADMIXTURES

(71) Applicant: CARBONCURE TECHNOLOGIES INC., Dartmouth (CA)

(72) Inventors: George Sean MONKMAN, Halifax (CA); Kevin CAIL, Sarasota, FL (US); Paul J. SANDBERG, Venice, FL (US); Alex HANMORE, Halifax (CA); Diane PRAUGHT, Waverly (CA); Yogiraj SARGAM, Halifax (CA)

(21) Appl. No.: 19/100,795

(22) PCT Filed: Aug. 2, 2023
(86) PCT No.: PCT/US2023/029354

§ 371 Date: Feb. 3, 2025

Related U.S. Application Data
(60) Provisional application No. 63/394,554, filed on Aug. 2, 2022.

(51) Int. Cl. C04B 28/04; C04B 24/18; C04B 24/26; C04B 24/32; C04B 40/00; C04B 103/30; C04B 103/40; C04B 111/00

(52) U.S. Cl. CPC C04B 28/04; C04B 24/18; C04B 24/2641; C04B 24/32; C04B 40/0039; C04B 2103/302; C04B 2103/304; C04B 2103/408; C04B 2111/00019

(57) ABSTRACT

Provided are methods and compositions utilizing one or more admixtures in combination with carbon dioxide in cement mixes, such as cement mixes comprising aggregates (concrete), for example carbon dioxide at a dose of 0.01 to 5% by weight cement and one or more admixtures.

### CROSS-REFERENCE

This application is related to the following co-pending patent applications: application Ser. No. 15/650,524, filed Jul. 14, 2017; Application Ser. No. 15/703,522, filed Sep. 13, 2017; and Application Ser. No. 63/573,109, filed Oct. 16, 2017, which are incorporated herein by reference. This application claims priority to U.S. Provisional Patent Application No. 63/394,554, filed on Aug. 2, 2022, which is incorporated by reference herein in its entirety.

### BACKGROUND

Admixtures have been used in concrete and mortar since at least the Roman Empire. The Romans found that certain materials such as milk, blood and lard, as well as organic materials such as molasses, eggs and rice paste allow greater workability in cementitious mixtures. While the first patent for calcium chloride in concrete goes all the way back to 1873 in Germany, modern admixture technology started with basic air-entraining agents, retarders, accelerators and water reducers in the 1930s in North America. Recently there has been great advancements in the use of water reducers and other types of admixtures to produce cement mixes, e.g., concrete, that are easier to place and/or of greater strength. In addition, addition of carbon dioxide to concrete mixes at low doses, essentially using carbon dioxide as an admixture, has also produced concrete mixes with improved characteristics. It is desirable to produce cement mixes, e.g., concrete, using carbonation and one or more additional admixtures to produce cement mixes, e.g., concrete, with improved characteristics.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows power curves for cement with various carbon dioxide concentrations (Example 2).

FIG. 2 shows energy curves for cement with various carbon dioxide concentrations, with energies at 16 hours highlighted (Example 2).

FIG. 3 shows energy at 16 hours vs. the CO2 dose (Example 2).

FIG. 4 shows power curves for cement with various carbon dioxide concentrations, Exshaw GUL cement (Example 3).

FIG. 5 shows energy curves for cement with various carbon dioxide concentrations, Exshaw GUL cement (Example 3).

FIG. 6 shows plot of energy at 20 hours vs the CO2 dose, Exshaw GUL cement (Example 3).

FIG. 7 shows power curves for cement with various carbon dioxide concentrations, Exshaw GUL cement and an admixture (PAANa, sodium polyacrylate), a dispersant, at 0.08%. (Example 4).

FIG. 8 shows energy curves for cement with various carbon dioxide concentrations, Exshaw GUL cement and an admixture (PAANa, sodium polyacrylate), a dispersant, at 0.08%. (Example 4).

FIG. 9 shows plot of energy at 20 hours for cement with various carbon dioxide concentrations, Exshaw GUL cement and an admixture (PAANa, sodium polyacrylate), a dispersant, at 0.08%. (Example 4).

FIG. 10 shows power curves for cement with various carbon dioxide concentrations, Exshaw GUL cement and an admixture (PAANa, sodium polyacrylate), a dispersant, at 0.16%. (Example 5).

FIG. 11 shows energy curves for cement with various carbon dioxide concentrations, Exshaw GUL cement and an admixture (PAANa, sodium polyacrylate), a dispersant, at 0.16%. (Example 5).

FIG. 12 shows plot of energy at 20 hours for cement with various carbon dioxide concentrations, Exshaw GUL cement and an admixture (PAANa, sodium polyacrylate), a dispersant, at 0.16%. (Example 5).

FIG. 13 shows plot of power for cement with various carbon dioxide concentrations, Exshaw GUL cement and an admixture, GCP Zyla 610, a polycarboxylate Ether (PCE) based water reducer, at 0.2%. (Example 6).

FIG. 14 shows plot of energy for cement with various carbon dioxide concentrations, Exshaw GUL cement and an admixture, GCP Zyla 610, a polycarboxylate Ether (PCE) based water reducer, at 0.2%. (Example 6).

FIG. 15 shows plot of energy at 20 hours for cement with various carbon dioxide concentrations, Exshaw GUL cement and an admixture, GCP Zyla 610, a polycarboxylate Ether (PCE) based water reducer, at 0.2%. (Example 6).

FIG. 16 shows plot of power for cement with various carbon dioxide concentrations, Exshaw GUL cement and an admixture, GCP Zyla 610, a polycarboxylate Ether (PCE) based water reducer, at 0.8%. (Example 7).

FIG. 17 shows plot of energy for cement with various carbon dioxide concentrations, Exshaw GUL cement and an admixture, GCP Zyla 610, a polycarboxylate Ether (PCE) based water reducer, at 0.8%. (Example 7).

FIG. 18 shows plot of energy at 20 hours for cement with various carbon dioxide concentrations, Exshaw GUL cement and an admixture, GCP Zyla 610, a polycarboxylate Ether (PCE) based water reducer, at 0.8%. (Example 7).

FIG. 19 shows plot of power for cement with various carbon dioxide concentrations, National Lebec Type IL cement (Example 8).

FIG. 20 shows plot of energy for cement with various carbon dioxide concentrations, National Lebec Type IL cement (Example 8).

FIG. 21 shows plot of energy at 20 hrs vs the carbon dioxide dose for cement with various carbon dioxide concentrations, National Lebec Type IL cement (Example 8).

FIG. 22 shows plot of power for cement with various carbon dioxide concentrations, National Lebec Type IL cement and an admixture, 0.385% Euclid Plastol 6400, a polycarboxylate Ether (PCE) based high range water reducer (Example 9).

FIG. 23 shows plot of energy for cement with various carbon dioxide concentrations, National Lebec Type IL cement and an admixture, 0.385% Euclid Plastol 6400, a polycarboxylate Ether (PCE) based high range water reducer (Example 9).

FIG. 24 shows plot of energy at 20 hrs vs the carbon dioxide dose for cement with various carbon dioxide concentrations, National Lebec Type IL cement and an admixture, 0.385% Euclid Plastol 6400, a polycarboxylate Ether (PCE) based high range water reducer (Example 9).

FIG. 25 shows plot of power for cement with various carbon dioxide concentrations, National Lebec Type IL cement and an admixture, 0.385% Euclid Plastol 6400, a polycarboxylate Ether (PCE) based high range water reducer (Example 10).

FIG. 26 shows plot of energy for cement with various carbon dioxide concentrations, National Lebec Type IL cement and an admixture, 0.385% Euclid Plastol 6400, a polycarboxylate Ether (PCE) based high range water reducer (Example 10).

FIG. 27 shows plot of energy at 20 hrs vs the carbon dioxide dose for cement with various carbon dioxide concentrations, National Lebec Type IL cement and an admixture, 0.385% Euclid Plastol 6400, a polycarboxylate Ether (PCE) based high range water reducer (Example 10).

FIG. 28 shows plot of power for cement with various carbon dioxide concentrations, National Lebec Type IL cement and an admixture, 0.37% Sika Plastocrete 161, a lignin polymer based water reducer (Example 11).

FIG. 29 shows plot of energy for cement with various carbon dioxide concentrations, National Lebec Type IL cement and an admixture, 0.37% Sika Plastocrete 161, a lignin polymer based water reducer (Example 11).

FIG. 30 shows plot of energy at 20 hours for cement with various carbon dioxide concentrations, National Lebec Type IL cement and an admixture, 0.37% Sika Plastocrete 161, a lignin polymer based water reducer (Example 11).

FIG. 31 shows plot of power for cement with various carbon dioxide concentrations, National Lebec Type IL cement and an admixture, 0.59% MasterPolyheed 997, a lignosulfonate triethanolamine based medium-range water reducer (Example 12).

FIG. 32 shows plot of energy for cement with various carbon dioxide concentrations, National Lebec Type IL cement and an admixture, 0.59% MasterPolyheed 997, a lignosulfonate triethanolamine based medium-range water reducer (Example 12).

FIG. 33 shows plot of energy at 20 hours for cement with various carbon dioxide concentrations, National Lebec Type IL cement and an admixture, 0.59% MasterPolyheed 997, a lignosulfonate triethanolamine based medium-range water reducer (Example 12).

FIG. 34 shows effect of admixture alone and admixture with carbon dioxide on set time (Example 13).

FIG. 35 shows plot of power for cement with various carbon dioxide concentrations, National Lebec Type IL cement and an admixture, 0.39% Euclid Eucon WR, a lignosulphate based water reducer (Example 14).

FIG. 36 shows plot of energy for cement with various carbon dioxide concentrations, National Lebec Type IL cement and an admixture, 0.39% Euclid Eucon WR, a lignosulphate based water reducer (Example 14).

FIG. 37 shows plot of energy at 20 hours for cement with various carbon dioxide concentrations, National Lebec Type IL cement and an admixture, 0.39% Euclid Eucon WR, a lignosulphate based water reducer (Example 14).

FIG. 38 shows plot of power for cement with various carbon dioxide concentrations, National Lebec Type IL cement and an admixture, 0.29% MasterGlenium3030, a polycarboxylate Ether (PCE) based high range water reducer (Example 15).

FIG. 39 shows plot of energy for cement with various carbon dioxide concentrations, National Lebec Type IL cement and an admixture, 0.29% MasterGlenium3030, a polycarboxylate Ether (PCE) based high range water reducer (Example 15).

FIG. 40 shows plot of energy at 20 hours for cement with various carbon dioxide concentrations, National Lebec Type IL cement and an admixture, 0.29% MasterGlenium3030, a polycarboxylate Ether (PCE) based high range water reducer (Example 15).

FIG. 41 shows plot of power for cement with various carbon dioxide concentrations, National Lebec Type IL cement and an admixture, 0.49% Sika Viscocrete 1000, a polycarboxylate Ether (PCE) based high range water reducer (Example 16),

FIG. 42 shows plot of energy for cement with various carbon dioxide concentrations, National Lebec Type IL cement and an admixture, 0.49% Sika Viscocrete 1000, a polycarboxylate Ether (PCE) based high range water reducer (Example 16).

FIG. 43 shows plot of energy at 20 hours for cement with various carbon dioxide concentrations, National Lebec Type IL cement and an admixture, 0.49% Sika Viscocrete 1000, a polycarboxylate Ether (PCE) based high range water reducer (Example 16).

FIG. 44 shows effect of admixture alone and admixture plus carbon dioxide on set time (Example 17).

FIG. 45 shows plot of power for cement with various carbon dioxide concentrations, National Lebec Type IL cement and an admixture, 0.26% GCP Zyla 640, a polycarboxylate Ether (PCE) based water reducer (Example 18).

FIG. 46 shows plot of energy for cement with various carbon dioxide concentrations, National Lebec Type IL cement and an admixture, 0.26% GCP Zyla 640, a polycarboxylate Ether (PCE) based water reducer (Example 18).

FIG. 47 shows plot of energy at 20 hours for cement with various carbon dioxide concentrations, National Lebec Type IL cement and an admixture, 0.26% GCP Zyla 640, a polycarboxylate Ether (PCE) based water reducer (Example 18).

FIG. 48 shows plot of power for cement with various carbon dioxide concentrations, National Lebec Type IL cement and an admixture, 0.20% SikaControl Air 160, an air entraining admixture (Example 19).

FIG. 49 shows plot of energy for cement with various carbon dioxide concentrations, National Lebec Type IL cement and an admixture, 0.20% SikaControl Air 160, an air entraining admixture (Example 19).

FIG. 50 shows plot of energy at 20 hours for cement with various carbon dioxide concentrations, National Lebec Type IL cement and an admixture, 0.20% SikaControl Air 160, an air entraining admixture (Example 19).

FIG. 51 shows compressive strength at 7 days for a concrete mixture comprising carbon dioxide and a mid-range water reducing admixture (Example 20).

FIG. 52 shows compressive strength at 7 and 28 days for a concrete mixture comprising carbon dioxide and a water reducing admixture (Example 20).

FIG. 53 shows plot of energy for cement with various water to cement ratios and carbon dioxide concentrations (Example 21).

FIG. 54 shows energy at 16 hours vs. the CO2 dose (Example 21).

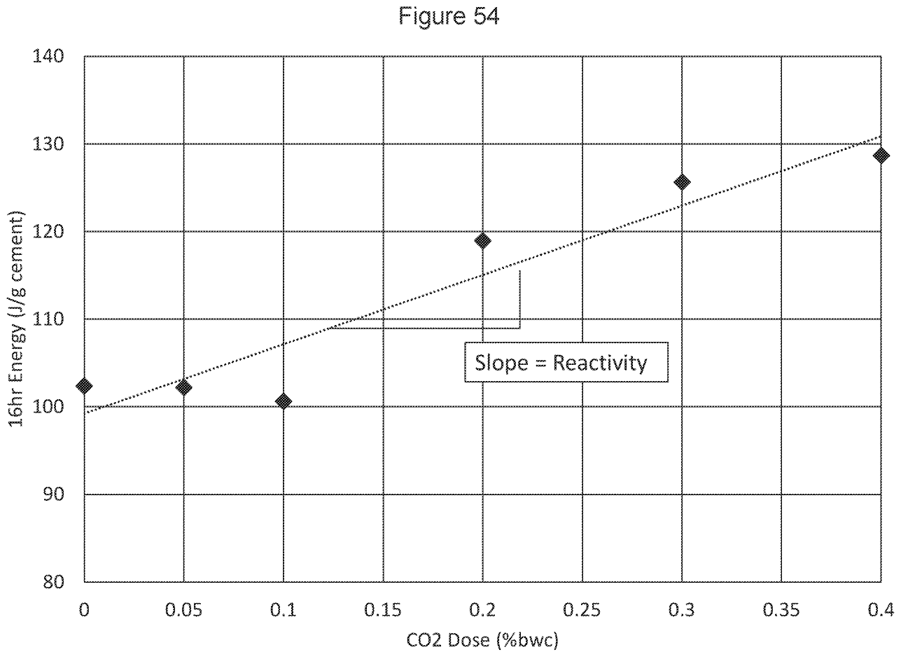

FIG. 55 shows reactivity vs. the water to cement ratio (w/c) (Example 21).

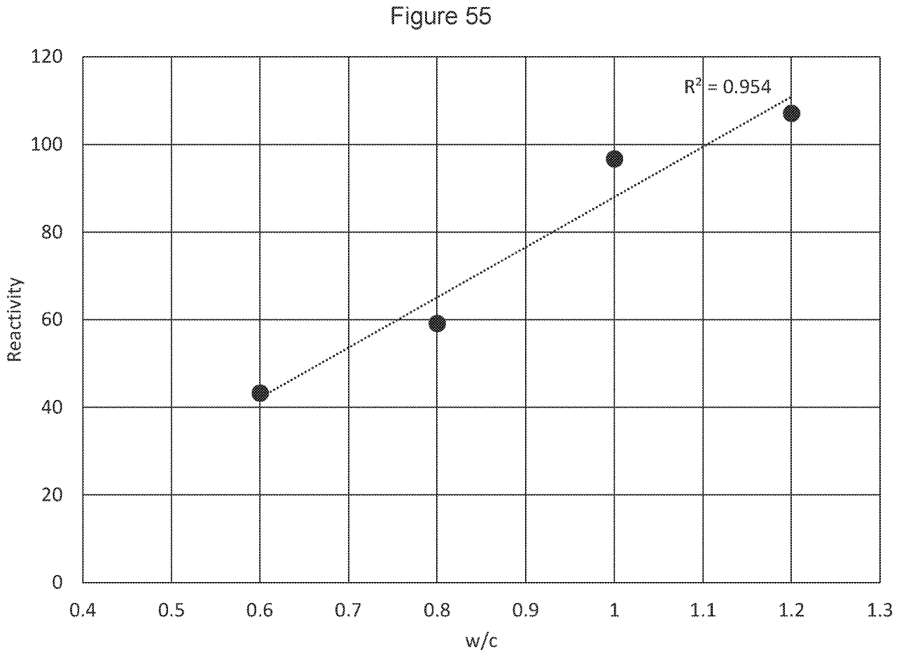

### DETAILED DESCRIPTION

It has been found that carbonation of wet cement mixes (i.e., a mix that comprises cement, e.g., hydraulic cement such as Portland cement, and water; including mortar and concrete mixes comprising cement, water, and aggregate) can reduce the carbon footprint of structures made from the cement mix by re-absorbing carbon dioxide during the carbonation and, often, by imparting greater strength to the hardened cement mix compared to uncarbonated mix, e.g., greater strength at any or all of 1, 7, or 28 days. Because the carbonated mix has greater strength, it can be possible to use less cement and/or to replace more cement with supplementary cementitious material (SCM), thus further reducing the carbon footprint of the cement mix and the structures made with such a mix. See, e.g., PCT Publication No. WO2016082030, incorporated herein by reference in its entirety.

Compositions and methods described herein provide for the addition of carbon dioxide to wet cement mixes, and also addition of at least one admixture. As is known in the art, an admixture is any material or composition, other than the hydraulic cement, aggregate and water, that is used as a component of the cement mix, e.g., hydraulic cement mix, such as concrete or mortar to enhance some characteristic, or lower the cost, thereof. The admixture may be added before, during, and/or after addition of the carbon dioxide, or in divided doses added at different times relative to addition of carbon dioxide. In addition, the admixture may be added before, during and/or after the contacting of water and cement to produce a wet cement mix, or in divided doses at different times relative to contacting of water and cement to produce a wet cement mix; in certain embodiments, one or more admixtures may be added with mix water, or added before or after mix water is added. In general, the timing of addition of an admixture relative to the time of contact of carbon dioxide with the wet cement mix, or relative to contacting water and cement to produce a wet cement mix, is expressed herein relative to the time of first contact of carbon dioxide with the wet cement mix or relative to the time of first contact of water and cement mix.

In certain embodiments the methods and compositions of the invention utilize addition of a plurality of different admixtures, in combination with carbonation of a wet cement mix. Two or more of the admixtures, for example 3, 4, 5, 6, 7, 8, or more than 8 admixtures, may be combined in a single “cocktail,” e.g., dissolved or dispersed in aqueous medium or other appropriate medium. This cocktail may be used alone or in combination with additional admixtures. Typically, admixtures are used in wet mix operations, such as ready-mix or precast operations, and the compositions and methods herein will be described in terms of a ready-mix operation, but it will be appreciated that other types of operations involving wet cement mixes are encompassed by the description, possibly with modifications, as will be apparent to one of skill in the art.

Without being bound by theory, it is thought that carbonation of a wet cement mix produces homogenously distributed nanoparticles of calcium carbonate in the wet cement mix that can act both physically and chemically to enhance hydration and other reactions as the wet cement mix reacts. Thus, admixtures may be useful in this milieu in many different ways, including but not limited to:
developing or stabilizing Ca²⁺ in solution
preventing carbonate reaction products from coarsening or flocculating
modulating the carbonate reaction product size or geometry
promoting homogenous nucleation of CaCO₃, e.g., in solution and not on a surface
influencing the interaction of the CO2 with sulfates, ferrites alkalis, magnesiates, and/or aluminates. This can be either inhibiting or promoting interaction
influencing the action of the sulfates, ferrites, alkalis, magnesiates, and/or aluminates. This can be either inhibiting or promoting their activity
offsetting acceleration provided by the CO₂ (e.g., with a retarder)
offsetting workability loss associated with the carbonation (e.g., with a plasticizer)
controlling, modifying or otherwise impacting the nature of the carbonate reaction product formed
controlling, modifying or otherwise impacting the development of hydration products that develop on the carbonate product (see, e.g., Moghaddam et al., J. Materials Chem. A, DOI 10 1039/c6ta09389b, 2016)

Methods and compositions of the invention include the addition of carbon dioxide to a wet cement mix, while the mix is mixing. In a ready-mix operation, the mixer (e.g., drum of a ready-mix truck, or central mixer) is typically first loaded with a significant portion of the mix water, e.g., 60-70% of the final amount. Cement is then released into the mixer and mixes with the water. Throughout the mix process aggregates, if used, are also added; as the amount of aggregate generally is far larger than amounts of cement or water, it is important that its addition be of sufficient duration. The addition of carbon dioxide can occur at any time after the first contact of cement with the water. The timing of addition of carbon dioxide may depend on what admixture or admixtures have been added to the cement mix before carbon dioxide addition (e.g., as part of the mix water), as in certain instances it can be important that reactions of the admixture or admixtures progress to a certain point to ensure optimal effects in combination with the carbonation. The form of carbon dioxide may be any suitable form, e.g., solid, gaseous, liquid, and/or supercritical carbon dioxide. In certain embodiments, the carbon dioxide is added as a mixture of solid and gaseous carbon dioxide formed from liquid carbon dioxide. The dose of carbon dioxide may be any suitable dose, for example, as described in PCT Publication No. WO2016082030. In certain embodiments, the dose of carbon dioxide is 0.001-10.0% by weight cement (bwc), for example 0.001-5.0% or 0.001-2.0% of 0.001-1.0% or 0.005-1.0% or 0.005-0.5% bwc. Use of certain admixtures may permit larger doses than would otherwise be possible, e.g., by retarding early set induced by high doses of carbon dioxide in mixes with particular types of cement. In some applications, e.g., 3D printing with cement mixes such as concrete, an admixture that can control the rate of stiffening, in conjunction with a suitable dosage of carbon dioxide, may be especially useful. For example, carbonated cement mix, e.g., hydraulic cement mix for use in a wet cast operation may have workability/flow characteristics that are optimized via addition of an admixture. As another example, carbonated mixes may have strength characteristics, e.g., compressive strength at one or more time points, that are optimized by addition of an admixture. In some cases, the mix design will already call for an admixture, whose effect on the properties of the mix may be affected by the carbonation, requiring coordination of the timing of the admixture in relation to the carbon dioxide addition, or other manipulation. In addition, an admixture may be used to modulate one or more aspects of the carbonation itself, for example, to increase the rate of uptake of the carbon dioxide.

In certain cases, carbonation of the cement mix, e.g., hydraulic cement mix may affect flowability of a cement mix, e.g., hydraulic cement mix, i.e., a concrete mix, to be used in a wet cast operation, such as in a ready mix truck transporting the mix to a job site. Thus in certain embodiments in which a carbonated mix is produced (such as for use with a ready mix truck), one or more admixtures may be added to modulate the flowability of the carbonated mixture, either before, during, or after carbonation, or any combination thereof, such that it is within a certain percentage of the flowability of the same mixture without carbonation, or of a certain predetermined flowability. The addition of carbon dioxide, components of the mix, e.g., concrete mix, and/or additional components such as one or more admixtures, may be adjusted so that flowability of the final mix is within 50, 40, 30, 20, 10, 8, 5, 4, 3, 2, 1, 0.5, or 0.1% of the flowability that would be achieved without the addition of carbon dioxide, or of a certain predetermined flowability. In certain embodiments, the addition of carbon dioxide, components of the mix, and/or one or more admixtures, may be adjusted so that flowability of the final mix is within 20% of the flowability that would be achieved without the addition of carbon dioxide, or within 20% of a predetermined desired flowability. In certain embodiments, the addition of carbon dioxide, components of the mix, and/or one or more admixtures, may be adjusted so that flowability of the final mix is within 10% of the flowability that would be achieved without the addition of carbon dioxide, or within 10% of a predetermined desired flowability. In certain embodiments, the addition of carbon dioxide, components of the mix, and/or one or more admixtures, may be adjusted so that flowability of the final mix is within 5% of the flowability that would be achieved without the addition of carbon dioxide, or within 5% of a predetermined desired flowability. In certain embodiments, the addition of carbon dioxide, components of the mix, and/or one or more admixtures, may be adjusted so that flowability of the final mix is within 2% of the flowability that would be achieved without the addition of carbon dioxide, or within 2% of a predetermined desired flowability. Any suitable measurement method for determining flowability may be used, such as the well-known slump test. Any suitable admixture may be used, as described herein.

In certain embodiments an admixture is added to the carbonated mix, cither before, during, or after carbonation, or a combination thereof, under conditions such that the carbonated mix exhibits strength, e.g., 1-, 7-, 28 and/or 56-day compressive strength, within a desired percentage of the strength of the same mix without carbonation, or of a predetermined strength, e.g., within 50, 40, 30, 20, 15, 12, 10, 9, 8, 7, 6, 5, 4, 3, 2, 1, 0.5, or 0.1%. In certain embodiments, the addition of carbon dioxide, components of the mix, and/or one or more admixtures, may be adjusted so that strength at a given time point of the final mix is within 20% of the strength that would be achieved without the addition of carbon dioxide, or within 20% of a predetermined desired strength. In certain embodiments, the addition of carbon dioxide, components of the mix, and/or one or more admixtures, may be adjusted so that strength at a given time point of the final mix is within 10% of the strength that would be achieved without the addition of carbon dioxide, or within 10% of a predetermined desired strength. In certain embodiments, the addition of carbon dioxide, components of the mix, and/or one or more admixtures, may be adjusted so that strength at a given time point of the final mix is within 5% of the strength that would be achieved without the addition of carbon dioxide, or within 5% of a predetermined desired strength. In certain embodiments, the addition of carbon dioxide, components of the mix, and/or one or more admixtures, may be adjusted so that strength at a given time point of the final mix is within 2% of the strength that would be achieved without the addition of carbon dioxide, or within 2% of a predetermined desired strength. In certain embodiments the strength is a compressive strength. Any suitable method to test strength, such as flexural or compressive strength, may be used so long as the same test is used for samples with and without carbonation; such tests are well known in the art.

In certain embodiments, the use of both admixtures and carbonation lead to compressive strengths greater than for just admixture, just carbonation, or just cement alone. It has been found that different cements have different properties upon carbonation, and also react differently to a given admixture. Thus the invention includes, compositions and methods for increasing the compressive strength, at one or more time points, of a carbonated cement mixes, e.g., a concrete mix, via the use of one or more admixtures, where the compressive strength of the carbonated cement mix plus admixture is greater than the compressive strength of the carbonated cement mix alone.

In certain embodiments an admixture is added to the carbonated mix, either before, during, or after carbonation, or a combination thereof, under conditions such that the mix exhibits strength, e.g., 1-, 7-, 28 and/or 56-day compressive strength, greater than that of the same carbonated mix without admixture, such as at least 0.5, 1, 2, 3, 4, 5, 6, 7, 8, 9, 10, 12, 15, 17, 20, 25, 30, or 40% greater and/or no more than 1, 2, 3, 4, 5, 6, 7, 8, 9, 10, 12, 15, 17, 20, 25, 30, 40, 60, or 80% greater, preferably at least 5% greater, more preferably at least 10% greater, even more preferably at least 15% greater. In some cases, a cement mix, such as a concrete mix, in which a particular cement is used, does not demonstrate a desired strength increase with carbonation alone; this is generally due to variations in responsiveness of various cement types to carbonation. Thus, addition of one or more admixtures can help achieve a desired increase in strength that would not occur with carbonation alone (at the dose used). Carbonation in these cases can be at any suitable level, such as a dose of at least 0.005, 0.01, 0.05, 0.1, 0.2, 0.3, 0.4, 0.5, 0.6, 0.7, 0.8, 0.9, 1.0, 1.1, 1.2, 1.3, 1.4, 1.5, 1.7, or 2.0% by weight cement (bwc) and/or not more than 0.01, 0.05, 0.1, 0.2, 0.3, 0.4, 0.5, 0.6, 0.7, 0.8, 0.9, 1.0, 1.1, 1.2, 1.3, 1.4, 1.5, 1.7, 2.0, or 2.5%, preferably 0.005-2.5%, more preferably 0.01-1.5%, even more preferably 0.01˜1.0%. The admixture or admixtures may be any suitable admixture, such as an admixture as described herein, at any suitable dose, such as those described herein. In certain embodiments, the admixture comprises a polymer, such as a polycarboxylate or polycarboxylate derivative, e.g., polycarboxylate ether, such as a polycarboxylate or polycarboxylate derivative, e.g., polycarboxylate ether, as described herein. The admixture can be provided in any suitable composition; in certain embodiments, some or all of the admixture is provided as a mixture with water wherein at least part of the water is wash water, e.g., carbonated wash water, from a concrete operation, or treated wash water, such as wash water, e.g., carbonated wash water, treated to remove particulate matter, e.g., clarified wash water, as described more fully elsewhere herein.

Reactivity of a concrete mix can be indicative of its compressive strength. Reactivity can be measured using any suitable technique, for example, calorimetry. See Examples. In general, the energy produced by a cement mixture as it cures can be indicative of the compressive strength of the cement mixture after setting and hardening, e.g., a higher rate of energy increase can be indicative of a higher compressive strength to be achieved after setting and hardening. Thus, in certain embodiments, provided is a method for increasing reactivity of a cement mix such as a concrete mix, e.g., as measured by calorimetry, comprising carbonating the cement mix and adding one or more admixtures to the cement mix, where the increase in reactivity is shown by an increased rate of energy production as measured by calorimetry, compared to the same mix without carbonation, admixture, or both.

Other properties, such as water absorption, shrinkage, chloride permeability, and the like, may also be tested and adjusted in a similar manner, and to similar percentages, as for flowability and/or shrinkage.

It has been observed that the effects of carbonation and of admixtures on carbonated cement mix, e.g., hydraulic cement mixes is highly mix-specific. In some cases, carbonation improves the properties of a mix, especially in dry cast situations where flowability is not an issue, and no admixture is required. In other cases, especially in wet cast situations where flowability is an issue, one or more admixtures may be required to restore one or more properties of the mix. Whether or not admixture is added, and/or how much is added, to a given batch may be determined by pre-testing the mix to determine the properties of the carbonated mix and the effects of a given admixture. In some cases, the admixture and/or amount may be predicted based on previous tests, or on properties of the cement used in the mix, or on theoretical considerations.

The timing of addition of admixture can be important. At least two aspects of timing typically need to be considered: First, timing of addition of admixture relative to the beginning of mixing of the cement mix can be important, as some admixtures operate best when added early relative to the start of mixing and other later, after chemical and other reactions have proceeded. Second, timing of addition of admixture relative to the addition of carbon dioxide can be important, as carbonation reactions begin very quickly after addition of carbon dioxide; e.g., calcium carbonate particles form quickly, and the mix of metastable polymorphs may change over time as reactions proceed. In some cases, one or more doses of admixture is used, and each dose will have a different timing relative to start of mixing and relative to addition of carbon dioxide. In some cases, one or more doses of carbon dioxide is used, and each dose will have a different timing relative to start of mixing and relative to addition of admixtures. In some cases, more than one dose of an admixture, and more than one dose of carbon dioxide is used.

If more than one admixture is used, all admixtures may be added at once, or their addition may be separated into two or more addition times. In certain cases, an admixture may be interground or otherwise mixed with a cement mix, for example with an alkanolamine or certain air detraining agents, and in these cases admixture will be present at the very start of mixing of cement and water. In certain cases, admixture may be included in the initial mix water, and in these cases admixture will also be present at the very start of mixing of cement and water. In both of these cases, admixture addition to the cement mix will occur before carbon dioxide addition, as carbon dioxide reactions require the presence of both water and cement. In certain cases, e.g., if carbonated water is used as a source of carbon dioxide, admixture addition may occur in the water but before contact with cement. Admixture may also be added at any time after cement mixing commences, up until the time the cement mix is poured; for example, many admixtures are prepared as standard aqueous mixes that are added into mixing concrete until a desired volume of the mix, corresponding to a desired amount of the admixture, has been added to the concrete mix. This can occur before, during, and/or after carbon dioxide addition. In some cases, admixture is added at a job site, for example, after testing the slump of the concrete, additional admixture may be added to adjust the slump.

Thus, the invention includes any of the following, where a first admixture (or mixture of 2, 3, 4, 5, 6, 7, 8, or more than 8 admixtures) is A1; a second admixture (or mixture of 2, 3, 4, 5, 6, 7, 8, or more than 8 admixtures) is A2; a third admixture (or mixture of 2, 3, 4, 5, 6, 7, 8, or more than 8 admixtures) is A3; and a fourth admixture (or mixture of 2, 3, 4, 5, 6, 7, 8, or more than 8 admixtures) is A4, where any of A1, A2, A3, and A4 may be the same or different, or parts of A1, A2, A3, and A4 may be the same or different (e.g., a particular admixture may be present in both A1 and A2 while a second admixture is present only in A1, or only in A2; the foregoing is merely exemplary and it will be appreciated that numerous combinations and permutations are possible):
1) A1 is added as part of mix water prior to addition of cement, or is interground or added to dry cement; cement and mix water are contacted and cement and mix water begin mixing; optionally additional admixture A2, A3, and/or A4 is added to the mixing cement mix after it begins mixing; carbon dioxide is added to the mixing wet cement mix. Carbon dioxide addition may commence within 10, 20, 30, 40, 50, or 60 seconds of the commencement of mixing of cement mix, or within 1, 2, 3, 4, 5, 6, 7, 8, 9, 10, 15, 20, 30, 40, 60, 90, or 120 minutes of the commencement of mixing of cement mix and/or not more than 1, 2, 3, 4, 5, 6, 7, 8, 9, 10, 15, 20, 30, 40, 60, 90, or 120 minutes prior to final placement of the concrete (e.g., carbon dioxide addition at the job site). In some cases, it is desirable to allow reactions in the cement mix/admixture mixture to proceed for a minimum time before addition of carbon dioxide; thus in these cases carbon dioxide addition may not begin until at least 1, 2, 5, 10, 20, 30, 40, 50, or 60 seconds after the commencement of mixing of cement mix (which will contain at least A1), or at least 1, 2, 3, 4, 5, 6, 7, 8, 9, 10, 15, 20, 30, 40, 60, 90, or 120 minutes after the commencement of mixing of cement mix (which will contain A1) and/or not more than 1, 2, 3, 4, 5, 6, 7, 8, 9, 10, 15, 20, 30, 40, 60, 90, or 120 minutes prior to final placement of the concrete (e.g., carbon dioxide addition at the job site). In some cases, carbon dioxide addition may be divided into two or more doses, and the timing of each dose relative to start of mixing (and thus contact with products of contact of A1 with the cement mix) will be different. In cases where A2, A3, and/or A4 is added after mixing commences, carbon dioxide addition may be added before or after addition of the additional admixture, and/or simultaneous with addition of the additional admixture, for example, before and/or during A2 addition; during and/or after A2 addition; before and/or during A3 addition; during and/or after A3 addition; before and/or during A4 addition; during and/or after A4 addition. If carbon dioxide addition commences before addition of A2, A3, and/or A4, it may commence at least 1, 2, 5, 10, 20, 30, 40, 50, or 60 seconds before the addition of A2, A3, and/or A4, or at least 1, 2, 3, 4, 5, 6, 7, 8, 9, or 10 minutes before the addition of A2, A3, or A4; in all of these cases carbon dioxide delivery may continue during and/or after addition of the admixture, or carbon dioxide delivery may cease before addition of admixture. Carbon dioxide addition may commence during the addition of A2, A3, and/or A4 and either cease before addition of A1, A2, and/or A4 is complete or continue after addition is complete. If carbon dioxide addition commences after addition of A2, A3, and/or A4, it may commence at least 1, 2, 5, 10, 20, 30, 40, 50, or 60 seconds after the addition of A2, A3, and/or A4, or at least 1, 2, 3, 4, 5, 6, 7, 8, 9, or 10 minutes after the addition of A2, A3, or A4. In certain cases, carbon dioxide delivery is divided into two or more doses; if A2, A3, and/or A4 is added to the cement mix, the timing of delivery of A2, A3, and/or A4 relative to each of the doses of carbon dioxide may be any suitable timing; e.g., carbon dioxide dose 2, then A2, then carbon dioxide dose 2, then A3; etc. The latter is for illustrative purposes only and any suitable dosing scheme for carbon dioxide and, optionally, A2, A3, and/or A4 may be used. In addition, the timing of addition of A2, A3, and/or A4 relative to the start of mixing (i.e., initial contacting of cement and water) can also be important; thus, addition of any or all of A2, A3, and/or A4 may commence at least 1, 2, 5, 10, 20, 30, 40, 50, or 60 seconds after mixing commences, or at least 1, 2, 3, 4, 5, 6, 7, 8, 9, 10, 12, 15, 20, or 30 minutes after the mixing commences and/or not more than 2, 5, 10, 20, 30, 40, 50, or 60 seconds after mixing commences or not more than 1, 2, 3, 4, 5, 6, 7, 8, 9, 10, 12, 15, 20, or 30 minutes after the mixing commences; in certain cases, one or more of A2, A3, or A4 may be added at a job site, which can be hours after mixing commences.
2) Cement and mix water are contacted and cement and mix water begin mixing; A1 and, optionally, additional admixture A2, A3, and/or A4 is added to the mixing cement mix after it begins mixing; carbon dioxide is added to the mixing wet cement mix. The length of time from start of mixing until A1 is added is dependent on the composition of A1 and the desired effect. For example, A1 addition may commence within 1, 2, 5, 10, 20, 30, 40, 50, or 60 seconds of the commencement of mixing of cement mix, or within 1, 2, 3, 4, 5, 6, 7, 8, 9, 10, 12, 15, 20, or 30 minutes of the commencement of mixing of cement mix, and/or not more than 2, 5, 10, 20, 30, 40, 50, or 60 seconds after the commencement of mixing of cement mix, or not more than 1, 2, 3, 4, 5, 6, 7, 8, 9, 10, 12, 15, 20, or 30 minutes after the commencement of mixing of cement mix. In certain cases, A1 will be added more than 10 minutes after the commencement of mixing of the cement mix. The timing of addition of carbon dioxide to the mix relative to the addition of A1 is also dependent on composition of A1 and likely interactions of carbonation on the effect of A1, and vice versa; thus, carbon dioxide can be added before, during, or after the addition of A1, or any combination thereof. In addition, the dose of carbon dioxide can be divided into two or more doses, with each dose added at a different time relative to addition of A1; for example, an initial carbon dioxide dose before A1 and a second carbon dioxide dose after A1. The same considerations apply to A2, A3, and/or A4, if added to the mix. Carbon dioxide addition may commence within 10, 20, 30, 40, 50, or 60 seconds of the commencement of mixing of cement mix, or within 1, 2, 3, 4, 5, 6, 7, 8, 9, or 10 minutes of the commencement of mixing of cement mix. In certain cases, carbon dioxide will be added more than 10 minutes after the commencement of mixing of the cement mix. In some cases, it is desirable to allow reactions in the cement mix/admixture mixture to proceed for a minimum time before addition of carbon dioxide; thus in these cases carbon dioxide addition may not begin until at least 10, 20, 30, 40, 50, or 60 seconds after the addition of A1 to the cement mix, or at least 1, 2, 3, 4, 5, 6, 7, 8, 9, or 10 minutes after the addition of A1 to the cement mix. In some cases, it is desirable to allow carbonation reactions in the cement mix to proceed for a minimum time before addition of A1; thus in these cases A1 addition may not begin until at least 1, 5, 10, 20, 30, 40, 50, or 60 seconds after the addition of carbon dioxide to the cement mix, or at least 1, 2, 3, 4, 5, 6, 7, 8, 9, or 10 minutes after the addition of carbon dioxide to the cement mix. In some cases, carbon dioxide addition will overlap with addition of A1. In addition, the dose of carbon dioxide can be divided into two or more doses, with each dose added at a different time relative to addition of A1; for example, an initial carbon dioxide dose before A1 and a second carbon dioxide dose after A1. In cases where A2, A3, and/or A4 is added after mixing commences, carbon dioxide addition may be added before or after addition of the additional admixture, and/or simultaneous with addition of the additional admixture, for example, before and/or during A2 addition; during and/or after A2 addition; before and/or during A3 addition; during and/or after A3 addition; before and/or during A4 addition; during and/or after A4 addition. If carbon dioxide addition commences before addition of A2, A3, and/or A4, it may commence at least 1, 2, 5, 10, 20, 30, 40, 50, or 60 seconds before the addition of A2, A3, and/or A4, or at least 1, 2, 3, 4, 5, 6, 7, 8, 9, or 10 minutes before the addition of A2, A3, or A4; in all of these cases carbon dioxide delivery may continue during and/or after addition of the admixture, or carbon dioxide delivery may cease before addition of admixture. Carbon dioxide addition may commence during the addition of A2, A3, and/or A4 and either cease before addition of A1, A2, and/or A4 is complete or continue after addition is complete. If carbon dioxide addition commences after addition of A2, A3, and/or A4, it may commence at least 1, 2, 5, 10, 20, 30, 40, 50, or 60 seconds after the addition of A2, A3, and/or A4, or at least 1, 2, 3, 4, 5, 6, 7, 8, 9, or 10 minutes after the addition of A2, A3, or A4. In certain cases, carbon dioxide delivery is divided into two or more doses; if A2, A3, and/or A4 is added to the cement mix, the timing of delivery of A2, A3, and/or A4 relative to each of the doses of carbon dioxide may be any suitable timing; e.g., carbon dioxide dose 2, then A2, then carbon dioxide dose 2, then A3; etc. The latter is for illustrative purposes only and any suitable dosing scheme for carbon dioxide and, optionally, A2, A3, and/or A4 may be used. In certain cases, A1 will be added as divided doses, each with a different timing, relative to commencement of mixing and relative to addition of carbon dioxide. In certain cases, both A1 and carbon dioxide are added as divided doses. In addition, the timing of addition of A2, A3, and/or A4 relative to the start of mixing (i.e., initial contacting of cement and water) can also be important; thus, addition of any or all of A2, A3, and/or A4 may commence at least 1, 2, 5, 10, 20, 30, 40, 50, or 60 seconds after mixing commences, or at least 1, 2, 3, 4, 5, 6, 7, 8, 9, 10, 12, 15, 20, or 30 minutes after the mixing commences and/or not more than 2, 5, 10, 20, 30, 40, 50, or 60 seconds after mixing commences or not more than 1, 2, 3, 4, 5, 6, 7, 8, 9, 10, 12, 15, 20, or 30 minutes after the mixing commences; in certain cases, one or more of A2, A3, or A4 may be added at a job site, which can be hours after mixing commences.
   Compositions Comprising Admixtures and/or Systems and Methods for Preparing and/or Using Compositions Comprising Admixtures

In certain embodiments, provided herein are compositions comprising one or more admixtures. The composition can comprise any suitable admixture, such as an admixture as disclosed herein. The composition can comprise any suitable number of admixtures as disclosed herein. In certain embodiments, the composition comprises one or more admixtures and water, e.g., an admixture solution. In certain embodiments, the admixture comprises a dispersing admixture, such as a water reducer, for example a high-range water reducer, e.g., PCE. In certain embodiments, the admixture comprises polyacrylate, such as sodium polyacrylate; polycarboxylate, such as polycarboxylate ether; lignin, such as a lignin polymer, a lignosulphate, a lignosulfonate triethanolamine; triethanolamine (TEA); a nitrate, such as sodium nitrate; a thiocyanate, such as sodium thiocyanate; or a combination thereof. In certain embodiments, the admixture comprises a polycarboxylate or polycarboxylate derivate, such as a polycarboxylate ether. In certain embodiments, the polycarboxylate or polycarboxylate derivative is present in an amount from 0.1 to 1% bwc, preferably 0.2 to 1% bwc, even more preferably 0.2 to 0.8% bwc. In certain embodiments, the admixture comprises a lignin or lignin derivative, such as lignosulfate, lignosulfonate, or a combination thereof. In certain, embodiments, the lignin or lignin derivative is present at a concentration of is present in an amount from 0.2 to 8% bwc, preferably 0.2 to 6% bwc, even more preferably 0.3 to 0.5%. In certain embodiments, the admixture comprises a polyacrylate or polyacrylate derivative. In certain embodiments, the polyacrylate or polyacrylate derivative is present in an amount from 0.02 to 0.3% bwc, preferably 0.04 to 0.2% bwc, even more preferably 0.06 to 0.2%. Any suitable source of water can be used, such as a water normally used in concrete production. In certain embodiments, the water comprises potable water. In certain embodiments, the water comprises industrial water. Additionally or alternatively, the water comprises concrete reclaimed water, such as wash water. The water can comprise a mixture of potable and concrete reclaimed water. In this case, any suitable ratio of potable to concrete reclaimed water can be used. In certain embodiments, the concrete reclaimed water, e.g., wash water, comprises solids. In certain embodiments, the solids are not removed prior to combining with the one or more admixtures. In certain embodiments, at least a portion of the solids are removed, e.g., to produce clarified wash water, prior to combining with the one or more admixtures. In certain embodiments, the concrete reclaimed water, e.g., wash water, is carbonated. In certain embodiments, one or more admixtures, e.g., polymer admixtures such as polycarbonate or polycarbonate derivative admixtures, are mixed with wash water from a concrete operation, e.g., wash water that has been carbonated and, in some cases, filtered or otherwise treated to remove solids, e.g., clarified wash water. In certain embodiments, the composition can be combined with cement and/or aggregates to form a cement product as disclosed herein. Carbonation of wash water is further described in PCT Publication No. WO2021/071980.

In certain embodiments, provided herein are methods for producing admixtures. In certain embodiments, the method comprises adding one or more admixtures to water, e.g., to produce an admixture solution. The method can comprise adding any suitable admixture to the water, such as an admixture as disclosed herein. The method can comprise adding any suitable number of admixtures as disclosed herein to the water. In certain embodiments, the method comprises adding a dispersing admixture, such as a water reducer, for example a high-range water reducer, e.g., PCE, to water. In certain embodiments, the admixture comprises polyacrylate, such as sodium polyacrylate; polycarboxylate, such as polycarboxylate ether; lignin, such as a lignin polymer, a lignosulphate, a lignosulfonate triethanolamine; triethanolamine (TEA); a nitrate, such as sodium nitrate; a thiocyanate, such as sodium thiocyanate; or a combination thereof. In certain embodiments, the admixture comprises a polycarboxylate or polycarboxylate derivate, such as a polycarboxylate ether. In certain embodiments, the polycarboxylate or polycarboxylate derivative is present in an amount from 0.1 to 1% bwc, preferably 0.2 to 1% bwc, even more preferably 0.2 to 0.8% bwc. In certain embodiments, the admixture comprises a lignin or lignin derivative, such as lignosulfate, lignosulfonate, or a combination thereof. In certain, embodiments, the lignin or lignin derivative is present at a concentration of is present in an amount from 0.2 to 8% bwc, preferably 0.2 to 6% bwc, even more preferably 0.3 to 0.5%. In certain embodiments, the admixture comprises a polyacrylate or polyacrylate derivative. In certain embodiments, the polyacrylate or polyacrylate derivative is present in an amount from 0.02 to 0.3% bwc, preferably 0.04 to 0.2% bwc, even more preferably 0.06 to 0.2%. In certain embodiments, the water comprises potable water. Additionally or alternatively, the water comprises concrete reclaimed water, such as wash water. The water can comprise a mixture of potable and concrete reclaimed water. In certain embodiments, the method comprising mixture potable and concrete reclaimed water prior to adding the admixture. In this case, any suitable ratio of potable to concrete reclaimed water can be used. In certain embodiments, the concrete reclaimed water comprises solids. In certain embodiments, the method further comprises removing at least a portion of the solids from the water, e.g., to produce clarified wash water, prior to adding the one or more admixtures to the water. In certain embodiments, the method further comprises carbonating the water. In certain embodiments, the method further comprises combining the admixture solution with cement and/or aggregates to form a cement product as disclosed herein.

In certain embodiments, provided herein is an apparatus for preparing an admixture, such as an admixture solution. In certain embodiments, the apparatus is configured to prepare an admixture solution as disclosed herein. In certain embodiments, the apparatus comprises a source of water, one or more sources of admixture (as disclosed herein), and a vessel, wherein the source of water and the one or more sources of admixture are operably connected to the vessel. In certain embodiments, the apparatus is configured to combine water from the source of water and one or more admixtures for the one or more sources of admixture in the vessel. The apparatus can further comprise a mixer configure to combine and/or the admixture and the water. In certain embodiments, the apparatus further comprises a source of gas. Any suitable gas can be used, such as liquid nitrogen or carbon dioxide, preferably carbon dioxide. In certain embodiments, the apparatus further comprises a first conduit operably connected to the vessel at a proximal end of the first conduit, wherein the first conduit allows the admixture solution to flow through it from the proximal end and out of it at a distal end, and a second conduit situated inside the first conduit, wherein the second conduit is operably connected to the source of gas and is configured to allow the gas to flow into it and to flow out of it into the admixture solution in the first conduit. In certain embodiments, the distal end of the first conduit is operably connected to the vessel, such that the admixture solution can be circulated through the first conduit and into the vessel for a desired period of time and/or until the admixture solution achieves a desired level of carbonation. In certain embodiments, the second conduit is perforated. In certain embodiments, the diameter of the first conduit is 0.5-5 inches and the diameter of the second conduit is 0.3-3 inches. In certain embodiments, the apparatus further comprises a control system comprising a sensor to sense a characteristic of the admixture solution and transmit information regarding the characteristic to a controller that process the information from the sensor. Any suitable number of sensors can be used, such as at least 1, 2, 3, 4, 5, 6, 7, 8, 9, 10, 11, 12, 13, 14, 15, 16, 17, 18, or 19 and/or no more than 2, 3, 4, 5, 6, 7, 8, 9, 10, 11, 12, 13, 14, 15, 16, 17, 18, 19 or 20 sensors, for example 1-20 sensors. The sensor can monitor any suitable characteristic of the admixture solution, such as 1) pH of the admixture solution, (2) rate of delivery of carbon dioxide to the admixture solution, (3) total amount of admixture solution in the vessel, (4) temperature of the admixture solution, (5) specific gravity of the admixture solution, (6) concentration of one or more ions in the admixture solution, (7) age of the admixture solution, (8) circulation rate of the admixture solution, (9) timing of circulation of the admixture solution, (10) appearance of bubbles at surface of the admixture solution, (11) carbon dioxide concentration of the air above the admixture solution, (12) electrical conductivity of the admixture solution, (13) optical characteristics of the admixture solution, and (14) amount of admixture added to the admixture solution. In certain embodiments, the control system further comprises an actuator that receives a signal from the controller based, at least in part, on the processed information from the sensor. In certain embodiments, the actuator comprises a valve. In certain embodiments, the controller comprises at least two sensors, wherein the seconds are configured to monitor at least two characteristics. In certain embodiments, the controller comprises at least three sensors, wherein the seconds are configured to monitor at least three characteristics. In certain embodiments, the controller comprises at least four sensors, wherein the seconds are configured to monitor at least four characteristics. In certain embodiments, the controller comprises at least five sensors, wherein the seconds are configured to monitor at least five characteristics. The characteristics can be the same or different, for example, specific gravity and amount of admixture added to the water, and/or temperature. A second example, can include the specific gravity in one or more location in the vessel. In certain embodiments, the source of water comprises potable water. In certain embodiments, the source of water comprises concrete reclaimed water, such as wash water. In certain embodiments, the source of water comprises multiple sources of water, each of which are different, for example a first source of water comprising potable water and a second source of water comprising concrete reclaimed water, and the apparatus is configured to provide a mixture of potable and concrete reclaimed water to the vessel. The apparatus can be configured to provide any suitable ratio of potable to concrete reclaimed water as needed for the intended admixture. IN certain embodiments, the source of water comprises a reclaimer. In other embodiments, the vessel is a reclaimer. In certain embodiments, the apparatus is further configured to remove at least a portion of the solids from the concrete reclaimed water before or after combination with the one or more admixtures.

### Admixtures

TABLE 1
Admixtures for use with carbonated cement

| Chemical | | Cement | |
|---|---|---|---|
| Class | Sub Class | Application | Examples |
| Saccha- | Sugars | Retarder | Fructose, glucose, sucrose |
| rides | Sugar Acids/ | Retarder | Sodium Gluconate, sodium |
| | bases | | glucoheptonate |
| Organic | Polycarboxylic | Plasticizer | Many commercial brands |
| Polymers | Ethers | | |
| | Sulfonated | | |
| | Napthalene | Plasticizer | Many commercial brands |
| | Formaldehyde | | |
| | Sulphonated | | |
| | Melamine | Plasticizer | Many commercial brands |
| | formaldehyde | | |
| | Ligno sulphonates | Plasticizer | Many commercial brands |
| Inorganic | Alkaline Earth | Accelerant | Ca(NO₃)₂, Mg(OH)₂ |
| Salts | Metal Containing | | |
| | Alkali Metal | Accelerant | NaCl, KOH |
| | Containing | | |
| | Carbonate | — | NaHCO₃, Na₂CO₃ |
| | containing | | |
| Alkanol- | Tertiary | Accelerants/ | Triethanolamine, |
| amines | alkanolamines | Grinding | Triisopropylamine |
| | | aids | |
| Phospho- | — | Retarders | Nitrilotri(methylphosphonic |
| nates | | | acid), 2-phosphonobutane- |
| | | | 1,2,4-tricarboxylic acid |
| Surfac- | Vinsol Resins, | Air | Many commercial brands |
| tants | synthetic | Entraining | |
| | surfactants | Agents | |
| Chelating | Various | Retarders | EDTA, Citric Acid, |
| Agents | Chemistries | | nitrilotriacetic acid |

TABLE 2
Compositions of commercially available admixtures

| Name | Composition |
|---|---|
| Polyheed 997 | 5% THEED (tetrahydroxyethyehtylenediamine) |
| (Master Builder) | 1% TEA (tiethanolamine) |
| | 14% Sodium Nitrate |
| | 4% Sodium Thiocyanate |
| | 22% Sodium Lignosulfate |
| Eucon WR | 33% Calcium/Sodium Lignosulfate |
| (Euclid) | 3% TEA |
| Plastocrete 161 | 20-33% Sodium lignosulfate |
| (Sika) | 5% TEA |
| | Corn Syrup |
| Master Glenium | 21% Polycarboxylate |
| (3030) Master | |
| Builders) | |
| Viscocrete 1000 | 32% Polycarboxylate |
| (Sika) | |
| ADVACast 585 | 36% Polycarboxylate |
| (GCP) | |
| Zyła 640 GCP | 3% Polycarboxylate |
| | 4% Sodium Gluconate |
| | 7% Corn Syrup |
| | 1% TEA |
| Plastol 5000 | 30% Polycarboxylate |
| (Euclid) | 5% THEED |
| Exp 950 (GCP) | 39% Polycarboxylate |

In certain embodiments, provided herein are admixtures. Any suitable admixture can be used. In certain embodiments, the admixture comprises a polymer. In certain embodiments, the admixture comprises a linear polymer. In certain embodiments, the admixture comprises a branched polymer, e.g., a comb polymer. In certain embodiments, the admixture comprises a mixture of linear and branched polymers. The ratio of linear to branched polymers in an admixture composition, admixture solution, or a cement mix can be any suitable ratio, such as at least 1:1, 1:2, 1:5, 1:10, or 1:20 and/or not more than 1:2, 1:5, 1:10, 1:20 or 1:40. Any suitable monomer can be used to form the admixture polymer. In certain embodiments, the admixture comprises a polymer backbone comprising acrylic, methacrylic, maleic acids, vinyl, allyl, jeffamine, or combinations thereof. In certain embodiments, the polymer comprises one or more side chains, such as polyethylene oxide. Any suitable chemistry can be used to link the one or more side chains to the polymer, for example ester-, ether-, and/or amide-based linkages. In certain embodiments, the polymer comprises one or more modifications comprising a hydroxyl and/or carboxylic acid group. In preferred embodiments, the admixture is anionic, e.g., comprises a net negative charge. The polymer can have any suitable MW, for example at least 1, 5, 10, 100, 500 and/or no more than 5, 10, 100, 500, or 1,000 kDa, for example 1-1,000 kDa. Exemplary polymers include polyacrylates and polyacrylate derivative, and polycarboxylates, or polycarboxylate derivatives, such as polycarboxylate ethers.

This section summarizes some useful admixtures for use in the methods and compositions herein. For additional listings see Report on Chemical Admixtures for Concrete, Reported by ACI Committee 212, American Concrete Institute, ACI 212.3R-16, ISBN 978-1-942727-80-4, incorporated herein by reference in its entirety.

Admixtures useful in the methods and compositions herein include:

Accelerators: cause increase in the rate of hydration and thus accelerate setting and/or early strength development. In general, accelerating admixtures for concrete use should meet the requirements of ASTM C494/C494M for Type C (accelerating admixtures) or Type E (water-reducing and accelerating admixtures). Examples include inorganic salts, such as chlorides, bromides, fluorides, carbonates, thiocyanates, nitrites, nitrates, thiosulfates, silicates, aluminates, and alkali hydroxides. Of particular interest are calcium-containing compounds, such as CaO, Ca(NO₂), Ca(OH)₂, calcium stearate, or CaCl₂), and magnesium-containing compounds, such as magnesium hydroxide, magnesium oxide, magnesium chloride, or magnesium nitrate. Without being bound by theory, it is thought that, in the case of carbonated cement, the added calcium or magnesium compound may provide free calcium or magnesium to react with the carbon dioxide, providing a sink for the carbon dioxide that spares the calcium in the cement mix, or providing a different site of carbonation than that of the cement calcium, or both, thus preserving early strength development. In addition, the anion, e.g., nitrate from a calcium-containing admixture may influence C—S—H particle structure. Other set accelerators include, but are not limited to, a nitrate salt of an alkali metal, alkaline earth metal, or aluminum; a nitrite salt of an alkali metal, alkaline earth metal, or aluminum; a thiocyanate of an alkali metal, alkaline earth metal or aluminum; an alkanolamine; a thiosulfate of an alkali metal, alkaline earth metal, or aluminum; a hydroxide of an alkali metal, alkaline earth metal, or aluminum; a carboxylic acid salt of an alkali metal, alkaline earth metal, or aluminum (preferably calcium formate); a polyhydroxylalkylamine; a halide salt of an alkali metal or alkaline earth metal (e.g., chloride). Stable C—S—H seeds may also be used as accelerators.

In certain embodiments an accelerator can include one or more soluble organic compounds such as one or more alkanolamines, such as triethylamine (TEA), and/or higher trialkanolamines or calcium formate. The term “higher trialkanolamine” as used herein includes tertiary amine compounds which are tri(hydroxyalkyl) amines having at least one C₃-C₅ hydroxyalkyl (preferably a C₃-C₄ hydroxyalkyl) group therein. The remaining, if any, hydroxyalkyl groups of the subject tertiary amine can be selected from C₁-C₂ hydroxyalkyl groups (preferably C2 hydroxyalkyl). Examples of such compounds include hydroxyethyl di(hydroxypropyl)amine, di(hydroxyethyl) hydroxypropylamine, tri(hydroxypropyl)amine, hydroxyethyl di(hydroxy-n-butyl)amine, tri(2-hydroxybutyl)amine, hydroxybutyl di(bydroxypropyl)amine, and the like. Accelerators can also include calcium salts of carboxylic acids, including acetate, propionate, or butyrate. Other organic compounds that can act as accelerators include urea, oxalic acid, lactic acid, various cyclic compounds, and condensation compounds of amines and formaldehyde.

Quick-setting admixtures may be used in some embodiments, e.g., to produce quick-setting mortar or concrete suitable for shotcreting or for 3D printing. These include, e.g., ferric salts, sodium fluoride, aluminum chloride, sodium aluminate, and potassium carbonate.

Miscellaneous additional accelerating materials include silicates, finely divided silica gels, soluble quaternary ammonium silicates, silica fume, finely divided magnesium or calcium carbonate. Very fine materials of various composition can exhibit accelerating properties. In certain embodiments, admixture can include nucleation seeds based on calcium-silicate hydrate (C—S—H) phases; see e.g., Thomas, J. J., et al. 2009 J. Phys Chem 113:4327-4334 and Ditter et al. 2013 BFT International, January, pp. 44-51, which are incorporated by reference herein in their entireties.

In certain embodiments, a set accelerator including one, two, or three of triisopropanolamine (TIPA), N,N-bis(2-hydroxyethyl)-N-(2-hydroxypropyl)amine (BHEHPA) and tri(2-hydroxybutyl)amine (T2BA) is used, for example, a set accelerator comprising TIPA. Any suitable dose may be used, such as 0.0001-0.5% bwc, such as 0.001-0.1%, or 0.005-0.03% bwc. See U.S. Pat. No. 5,084,103.

In certain embodiments, carbonation of a cement mix is combined with use of an admixture comprising an alkanolamine set accelerator, e.g., TIPA, where the alkanolamine set accelerator, e.g., TIPA, is incorporated in an amount of 0.0001-0.5% bwc, such as 0.001-0.1%, or 0.005-0.03% bwc. In some of these embodiments, the alkanolamine, e.g., TIPA-containing admixture is added before and/or during carbonation, e.g., as part of the initial mix water. In some of these embodiments, the alkanolamine, e.g., TIPA-containing admixture is added after and/or during carbonation. In some embodiments, the alkanolamine, e.g., TIPA-containing admixture is added as two or more doses, which may be added at different times relative to carbonation (e.g., two doses, one before and one after carbonation, etc.). Additionally or alternatively, carbonation may proceed in two or more doses with, e.g., one or more doses of an alkanolamine, e.g., TIPA-containing admixture added before, after, or during one or more of the carbon dioxide doses. Other components may be present in the alkanolamine, e.g., TIPA-containing admixture, including one or more of set/strength controller, set balancer, hydration seed, dispersant, air controller, rheology modifier, colorant, or a combination thereof. Suitable commercially available products include BASF Master X-Seed 55 (BASF Corporation, Admixture Systems, Cleveland, OH). The total dose of carbon dioxide delivered to the cement mix in these embodiments may be any suitable dose, such as those described herein, for example, 0.001-2% bwc, such as 0.001-1.0% bwc, or 0.001-0.5% bwc

Air detrainers: also called defoamers or deaerators, decrease air content. Examples include nonionic surfactants such as phosphates, including tributylphosphate, dibutyl phosphate, phthalates, including diisodecylphthalate and dibutyl phthalate, block copolymers, including polyoxypropylene-polyoxyethylene-block copolymers, and the like, or mixture thereof. Air detrainers also include octyl alcohol, water-insoluble esters of carbonic and boric acid, and silicones. Further examples of air detrainers include mineral oils, vegetable oils, fatty acids, fatty acid esters, hydroxyl functional compounds, amides, phosphoric esters, metal soaps, polymers containing propylene oxide moieties, hydrocarbons, alkoxylated hydrocarbons, alkoxylated polyalkylene oxides, acetylenic diols, polydimethylsiloxane, dodecyl alcohol, octyl alcohol, polypropylene glycols, water-soluble esters of carbonic and boric acids, and lower sulfonate oils.

Air-entraining admixtures: The term air entrainer includes any substance that will entrain air in cementitious compositions. Some air entrainers can also reduce the surface tension of a composition at low concentration. Air-entraining admixtures are used to purposely entrain microscopic air bubbles into concrete. Air-entrainment dramatically improves the durability of concrete exposed to moisture during cycles of freezing and thawing. In addition, entrained air greatly improves concrete's resistance to surface scaling caused by chemical deicers. Air entrainment also increases the workability of fresh concrete while eliminating or reducing segregation and bleeding. Materials used to achieve these desired effects can be selected from wood resin and their salts, natural resin and their salts, synthetic resin and their salts, sulfonated lignin and their salts, petroleum acids and their salts, proteinaceous material and their salts, fatty acids and their salts, resinous acids and their salts, alkylbenzene sulfonates, sulfonated hydrocarbons, vinsol resin, anionic surfactants, cationic surfactants, nonionic surfactants, natural rosin, synthetic rosin, an inorganic air entrainer, synthetic detergents, and their corresponding salts, and mixtures thereof. Solid materials can also be used, such as hollow plastic spheres, crushed brick, expanded clay or shale, or spheres of suitable diatomaceous earth. Air entrainers are added in an amount to yield a desired level of air in a cementitious composition. Examples of air entrainers that can be utilized in the admixture system include, but are not limited to MB AE 90, MB VR and MICRO AIR®, all available from BASF Admixtures Inc. of Cleveland, Ohio.

Alkali-aggregate reactivity inhibitors: Reduce alkali-aggregate reactivity expansion. Examples include barium salts, lithium nitrate, lithium carbonate, and lithium hydroxide.

Antiwashout admixtures: Cohesive concrete for underwater placements. Examples include cellulose and acrylic polymer.

Bonding admixtures: Increase bond strength. Examples include polyvinyl chloride, polyvinyl acetate, acrylics, and butadiene-styrene copolymers.

Coloring admixtures: Colored concrete. Examples include modified carbon black, iron oxide, phthalocyanine, umber, chromium oxide, titanium oxide, cobalt blue, and organic coloring agents.

Corrosion inhibitors: reduce steel corrosion activity in a chloride-laden environment. Examples include calcium nitrite, sodium nitrite, sodium benzoate, certain phosphates or fluosilicates, fluoaluminates, and ester amines.

Dampproofing admixtures: retard moisture penetration into dry concrete. Examples include soaps of calcium or ammonium stearate or oleate, butyl stearate, and petroleum products.

Foaming agents: produce lightweight, foamed concrete with low density. Examples include cationic and anionic surfactants, and hydrolyzed protein.

Fungicides, germicides, and insecticides: Inhibit or control bacterial and fungal growth. Examples include polyhalogenated phenols, dieldrin emulsions, and copper compounds.

Gas formers: Gas formers, or gas-forming agents, are sometimes added to concrete and grout in very small quantities to cause a slight expansion prior to hardening. The amount of expansion is dependent upon the amount of gas-forming material used and the temperature of the fresh mixture. Aluminum powder, resin soap and vegetable or animal glue, saponin or hydrolyzed protein can be used as gas formers.

Hydration control admixtures: Suspend and reactivate cement hydration with stabilizer and activator. Examples include carboxylic acids and phosphorus-containing organic acid salts.

Permeability reducers: Decrease permeability. Examples include latex and calcium stearate.

Pumping aids: Improve pumpability. Examples include organic and synthetic polymers, organic flocculants, organic emulsions of paraffin, coal tar, asphalt, acrylics, bentonite and pyrogenic silicas, and hydrated lime.

Retarders: Retard setting time, and can include water-reducing set-retarding admixtures, which reduce the water requirements of a concrete mixture for a given slump and increase time of setting (see water reducers), or those that increase set time of concrete without affecting the water requirements. In general, set retarders can be classified in four categories, any of which may be used in embodiments herein: 1) lignosulfonic acids and their salts and modifications and derivatives of these; 2) hydroxylated carboxylic acids and their salts and modifications and derivatives of these; 3) carbohydrate-based compounds such as sugars, sugar acids, and polysaccharides, and 4) inorganic salts such as borates and phosphates. Thus, set retarders include carbohydrates, i.e., saccharides, such as sugars, e.g., fructose, glucose, and sucrose, and sugar acids/bases and their salts, such as sodium gluconate and sodium glucoheptonate; phosphonates, such as nitrilotri(methylphosphonic acid), 2-phosphonobutane-1,2,4-tricarboxylic acid; and chelating agents, such as EDTA, Citric Acid, and nitrilotriacetic acid. Other saccharides and saccharide-containing admixes include molasses and corn syrup. In certain embodiments, the admixture is sodium gluconate. Other exemplary admixtures that can be of use as set retarders include sodium sulfate, citric acid, BASF Pozzolith XR, firmed silica, colloidal silica, hydroxyethyl cellulose, hydroxypropyl cellulose, fly ash (as defined in ASTM C618), mineral oils (such as light naphthenic), hectorite clay, polyoxyalkylenes, natural gums, or mixtures thereof, polycarboxylate superplasticizers, naphthalene HRWR (high range water reducer). Additional set retarders that can be used include, but are not limited to, an oxy-boron compound, lignin, a polyphosphonic acid, a carboxylic acid, a hydroxycarboxylic acid, polycarboxylic acid, hydroxylated carboxylic acid, such as fumaric, itaconic, malonic, borax, gluconic, and tartaric acid, lignosulfonates, ascorbic acid, isoascorbic acid, sulphonic acid-acrylic acid copolymer, and their corresponding salts, polyhydroxysilane, polyacrylamide. Further retarders include nitrilotri(methylphosphonic acid), and 2-phosphonobutane-1,2,4-tricarboxylic acid. Illustrative examples of retarders are set forth in U.S. Pat. Nos. 5,427,617 and 5,203,919, incorporated herein by reference

Shrinkage reducers: Reduce drying shrinkage. Examples include polyoxyalkylenes alkyl ether and propylene glycol.

Water reducers: Water-reducing admixtures (also called dispersants, especially HRWR) are used to reduce the quantity of mixing water required to produce concrete of a certain slump, reduce water-cement ratio, reduce cement content, or increase slump. Typical water reducers reduce the water content by approximately 5-10%; high range water reducers (HRWR) reduce water content even further. Adding a water-reducing admixture to concrete without reducing the water content can produce a mixture with a higher slump; for example, in certain cases in which high doses of carbon dioxide are used to carbonate a cement mix, slump may be reduced, and use of a water reducer may restore adequate slump/workability.

Water reducers for use in the compositions and methods herein may meet one of the seven types of water reducers of ASTM C494/C494M, which defines seven types: 1) Type A—water reducing admixtures; 2) Type B—retarding admixtures (described above); 3) Type C—accelerating admixtures (also described above); 4) Type D—water-reducing and retarding admixtures; 5) Type E—water reducing and accelerating admixtures; 6) Type F—water-reducing, high range admixtures; or 7) Type G—water-reducing, high-range, and retarding admixtures. Materials generally available for use as water-reducing admixtures typically fall into one of seven general categories, and formulations useful herein may include, but are not limited to, compounds from more than one category: 1) lignosulfonic acids and theirs salts and modifications and derivatives of these; 2) hydroxylated carboxylic acids and their salts and modifications and derivatives of these; 3) carbohydrate-based compounds such as sugars, sugar acids, and polysaccharides; 4) salts of Sulfonated melamine polycondensation products; 5) salts of sulfonated napthalene polycondensation products; 6) polycarboxylates; 7) other materials that can be used to modify formulations, including nonionic surface-active agents; amines and their derivatives; organic phosphonates, including zinc salts, borates, phosphates; and certain polymeric compounds, including cellulose-ethers, silicones, and Sulfonated hydrocarbon acrylate derivatives.

An increase in strength is generally obtained with water-reducing admixtures as the water-cement ratio is reduced. For concretes of equal cement content, air content, and slump, the 28-day strength of a water-reduced concrete containing a water reducer can be 10% to 25% greater than concrete without the admixture. Type A water reducers can have little effect on setting, while Type D admixtures provide water reduction with retardation (generally a retarder is added), and Type E admixtures provide water reduction with accelerated setting (generally an accelerator is added). Type D water-reducing admixtures usually retard the setting time of concrete by one to three hours. Some water-reducing admixtures may also entrain some air in concrete.

High range water reducer (HRWR, also called superplasticizer or plasticizer), Type F (water reducing) and G (water reducing and retarding), reduce water content by at least 12%.

Examples of water reducers include lignosulfonates, casein, hydroxylated carboxylic acids, and carbohydrates. Further examples, including HRWR (superplasticizers or plasticizers) include polycarboxylic ethers, polycarboxylates, polynapthalene sulphonates (sulfonated napthalene formaldehyde condensates (for example LOMAR DIM™ dispersant (Cognis Inc., Cincinnati, Ohio)), polymelamine sulphonates (sulfonated melamine formaldehyde condensates), polyoxyethylene phosphonates (phosphonates-terminated PEG brushes), vinyl copolymers. Further examples include beta naphthalene sulfonates, polyaspartates, or oligomeric dispersants.

Polycarboxylate dispersants (water reducers which are also called polycarboxylate ethers, polycarboxylate esters) can be used, by which is meant a dispersant having a carbon backbone with pendant side chains, wherein at least a portion of the side chains are attached to the backbone through a carboxyl group or an ether group. Examples of polycarboxylate dispersants can be found in U.S. Pub. No. 2002/0019459 A1, U.S. Pat. Nos. 6,267,814, 6,290,770, 6,310,143, 6,187,841, 5,158,996, 6,008,275, 6,136,950, 6,284,867, 5,609,681, 5,494,516; 5,674,929, 5,660,626, 5,668,195, 5,661,206, 5,358,566, 5,162,402, 5,798,425, 5,612,396, 6,063,184, 5,912,284, 5,840,114, 5,753,744, 5,728,207, 5,725,657, 5,703,174, 5,665,158, 5,643,978, 5,633,298, 5,583,183, and 5,393,343. The polycarboxylate dispersants of interest include but are not limited to dispersants or water reducers sold under the trademarks GLENIUM® 3030NS, GLENIUM® 3200 HES, GLENIUM 3000NS® (BASF Admixtures Inc., Cleveland, Ohio), ADVA® (W. R. Grace Inc., Cambridge, Mass.), VISCOCRETE® (Sika, Zurich, Switzerland), and SUPERFLUX® (Axim Concrete Technologies Inc., Middlebranch, Ohio).

Viscosity and rheology modifying admixtures. Viscosity-modifying admixtures (VMAs) are typically water-soluble polymers used in concrete to modify its rheological properties. VMAs influence the rheology of concrete by increasing its plastic viscosity; the effect of yield stress widely varies with the type of VMA, from no increase to a significant one. Plastic viscosity is defined as the property of a material that resists change in the shape or arrangement of its elements during flow, and the measure thereof, and yield stress is defined as the critical shear stress value below which a viscoplastic material will not flow and, once exceed, flows like a viscous liquid. Rheology modifying agents can be used to modulate, e.g., increase, the viscosity of cementitious compositions. Suitable examples of rheology modifier include firmed silica, colloidal silica, cellulose ethers (e.g., hydroxyethyl cellulose, hydroxypropyl methylcellulose), fly ash (as defined in ASTM C618), mineral oils (such as light naphthenic), hectorite clay, polyoxyalkylenes, polysaccharides, polyethylene oxides, polyacrylamides or polyvinyl alcohol, natural and synthetic gums, alginates (from seaweed), or mixtures thereof. Other materials include finely divided solids such as starches, clays, lime, and polymer emulsions. Rheology-modifying admixtures (RMA) are admixtures that affect the flow characteristics of concrete by lowering the yield stress or force required to initiate flow without necessarily changing the plastic viscosity. The addition of an RMA to concrete might not alter its slump but will improve workability and flow characteristics. RMAs have been used in low-slump concrete applications, for example, when concrete is placed using slipform paving machines to place concrete pavements, curbs, and barriers, and potentially in 3D printing. They can also be used in self-consolidating concrete (SCC) or highly workable concretes. Rheology-modifying admixtures include those reported by Bury and Bury, 2008, Concrete International, 30:42-45, incorporated herein by reference in its entirety.

Shrinkage reduction and compensation admixtures. The shrinkage compensation agent which can be used in the cementitious composition can include but is not limited to RO(AO)₁₋₁₀H, wherein R is a C₁₋₅ alkyl or C₅₋₆ cycloalkyl radical and A is a C₂₋₃ alkylene radical, alkali metal sulfate, alkaline earth metal sulfates, alkaline earth oxides, preferably sodium sulfate and calcium oxide. TETRAGUARD® is an example of a shrinkage reducing agent and is available from BASF Admixtures Inc. of Cleveland, Ohio. Exemplary shrinkage reduction admixtures (SRAs) include polyoxyalkylenes alkyl ethers or similar compositions. Exemplary shrinkage compensation admixtures (SCAs) include calcium sulfoaluminate and calcium aluminate, calcium hydroxide, magnesium oxide, hard-burnt and dead-burnt magnesium oxide.

Extended set-control admixtures. Extended set-control admixtures (ESCAs) or hydration-controlling admixtures (HCAs) are sued to stop or severely retard cement hydration process in unhardened concrete. They may be used to shut down ongoing hydration of cementitious products in returned/waste concrete or in wash water that has been treated in the truck or in a concrete reclaimer system, which allows these products to be recycled back into concrete production so that they need not be disposed of, or to stabilize freshly batched concrete to provide medium- to very long-term set retardation, which allows concrete to remain plastic during very long hauls or in long-distance pumping situations that require long slump life in a more predictable fashion than normal retarders. These differ from conventional set control admixtures because they stop the hydration process of both the silicate and aluminate phases in Portland cement. Regular set-control admixtures act only on the silicate phases. Examples include carboxylic acids and phosphorus-containing organic acids and salts.

Workability-retaining admixtures. Help retain workability retention of concrete. Examples include hydration-controlling and retarding admixtures that meet the requirements of ASTM C494/C494M Type B or D, or neutral set workability-retaining admixtures meeting the requirements of ASTM C494/C494M Type S. See, e.g., Daczko, 2010, Proceedings for the 6^{th} International Symposium on Self-compacting Concrete and the 4^{th} North American Conference on the Design and Use of Self-Consolidating Concrete, September

Corrosion-inhibiting admixtures. Reduces corrosion of steel in concrete, e.g., rebar. Examples include chromates, phosphates, hydrophosphates, alkalis, nitrites, and fluorides; amine carboxylate, amine-ester organic emulsion, and calcium nitrite.

Permeability-reducing admixtures. Permeability-reducing admixtures (PRAs) have been developed to improve concrete durability though controlling water and moisture movement, as well as by reducing chloride ion ingress and permeability. These typically include, but are not limited, to: 1) hydrophobic water repellants, such as materials based on soaps and long-chain fatty acid derivatives, vegetable oils such as tallows, soya-based materials, and greases, and petroleum such as mineral oil and paraffin waxes, e.g., calcium, ammonium, and butyl stearates; 2) polymer products, such as organic hydrocarbons supplied either as emulsions (latex) or in liquid form, such as coal tar pitches, bitumen or other resinous polymer, or prepolymer materials; 3) finely divided solids, such as inert and chemically active fillers such as talc, bentonite, silicious powders, clay, lime, silicates, and colloidal silica. Supplementary cementitious materials (SCMs) such as fly ash, raw or calcined natural pozzolans, silica fume, or slag cement, although not technically chemical admixtures, can contribute to reducing concrete permeability be a complementary component; 4) hydrophobic pore blockers; 5) crystalline products, which can be proprietary active chemicals provided in a carrier of cement and sand.

Bonding admixtures include an organic polymer dispersed in water (latex).

Coloring admixtures include natural or synthetic materials, in liquid or dry forms. Pigments include black iron oxide, carbon black, phthalocyanine blue, cobalt blue, red iron oxide, brown iron oxide, raw burnt umber, chromium oxide, phthalocyanine green, yellow iron oxide, and titanium dioxide.

Flocculating admixtures include synthetic polyelectrolytes, such as vinyl acetate-maleic anhydride copolymer.

Fungicidal, germicidal, and insecticidal admixtures include polyhalogenated phenols, dieldrin emulsion, and copper compounds.

Lithium admixtures to reduce deleterious expansion from alkali-silica reaction. Deleterious expansions from alkali-silica reaction (ASR) can occur in concrete when susceptible siliceous minerals are present in the aggregate. Exemplary admixtures that prevent these deleterious expansion reactions include solid forms (lithium hydroxide monohydrate and lithium carbonate) and liquid form (30 percent by weight lithium nitrate solution in water). Additional examples include lithium nitrite.

Expansive/gas forming admixtures include metallic aluminum, zinc or magnesium, hydrogen peroxide, nitrogen and ammonium compounds, and certain forms of activated carbon or fluidized coke.

Admixtures for cellular concrete/flowable fill include those based on protein or on synthetic surfactants.

Shotcrete admixtures. Shotcrete is defined as “mortar or concrete pneumatically projected at high velocity onto a surface.” Materials useful as shotcrete admixtures include accelerators, such as alkali-based accelerators, e.g., aqueous silicate or aluminate solutions or alkali-free accelerators such as those based on aluminum sulfates and aluminum hydroxysulfates; high-range water-reducing admixtures such as those known in the art specifically formulated for shotcrete mixtures; and extended set-control admixtures.

Admixtures for manufactured concrete products. These may be used to add production efficiency, improve or modify surface texture, enhance and maintain visual appeal, or provide value-added performance benefits. These include plasticizers such as soaps, surfactants, lubricants, and cement dispersants; accelerators both calcium chloride and non-chloride-based; and water-repellant/efflorescence control admixtures such as calcium/aluminum stearates, fatty acids, silicone emulsions, and wax emulsions.

Admixtures for flowing concrete. Flowing concrete is defined as “concrete that is characterized as having a slump greater than 7½ in (190 mm) while maintaining a cohesive nature.” Various admixtures may be used, such as mid-range water reducers and high-range water reducers, viscosity-modifying admixtures, set retarders, set accelerators, and workability-retaining admixtures, as described herein.

Admixtures for self-consolidating concrete (SCC). Exemplary admixtures for inclusion in SCC include high-range water-reducing admixtures, e.g., polycarboxylate-based HRWRAs such as blends of different polycarboxylate polymers that have different rates of absorption on the powder substrates; and viscosity-modifying admixtures.

Admixtures for very cold weather concrete. These allow placement of concrete in temperatures below freeing, and include water reducers, accelerators, retarders, corrosion inhibitors, and shrinkage reducers (for their added freezing point depression).

Admixture for very-high-early-strength concrete. VHESC is designed to achieve extremely high early strengths within the first few hours after placement. Admixture systems can include a high-range water reducer, set accelerator, and optionally air-entraining admixture. Also include may be workability-retaining admixtures.

Admixtures for previous concrete Pervious concrete is a low-slump, open-graded material consisting of Portland cement, uniform-sized aggregate, little or no fine aggregate, chemical admixtures, and water, which, when combined, produces hardened concrete with interconnected pores, or voids, that allow water to pass through the concrete easily. Exemplary admixtures include air-entraining admixtures, extended set-control admixtures, water-reducing admixtures, internal curing admixtures, viscosity-modifying admixtures, and latex admixtures.

Admixtures for 3D printing concrete. These include admixtures that allow the printed concrete to stand without forms and other admixtures suited to the requirements of 3D printing.

In certain embodiments, an admixture can comprise a commercially available admixture. In certain embodiments, an admixture can comprise one or more components of a commercially available admixture. See Table 2 for a non-inclusive list of commercially available admixtures and their formulations. It is to be understood that any suitable admixture or component of an admixture can be used. In certain embodiments, an admixture solution comprises a component of a commercially available admixture at a different concentration relative to one or more other components in the commercially available admixture. In certain embodiments, an admixture solution comprises a component of a commercially available admixture and one or more additional components. In these embodiments, the admixture demonstrates improved performance when used with carbonated cements.

Modification or influence on calcium carbonate. In certain embodiments, an admixture is used that modulates the formation of calcium carbonate, e.g., so that one or more polymorphic forms is favored compared to the mixture without the admixture, e.g., modulates the formation of amorphous calcium carbonate, e.g., aragonite, or calcite. Exemplary admixtures of this type include organic polymers such as polyacrylate and polycarboxylate ether, phosphate esters such as hydroxyamino phosphate ester, phosphonate and phosphonic acids such as nitrilotri(methylphosphonic acid), 2-phosphonobutane-1,2,4-tricarboxylic acid, chelators, such as sodium gluconate, ethylenediaminetetraacetic acid (EDTA), and citric acid, or surfactants, such as calcium stearate.

Further admixtures of interest include those that influence calcium carbonate formation, reactions, and other aspects of calcium carbonate. For example, magnesium can be a strong inhibitor to calcite growth, and the Mg/Ca ratio may affect the lifetime of amorphous calcium carbonate, e.g., high ratios may increase lifetime, and may influence the type of crystalline polymorph that forms as the initial and long-term product. CO₃²⁻/Ca²⁺ may also affect these, as may physical mixing, cither or both of which may be manipulated. See, e.g., see Blue, C. R., Giuffre, A., Mergelsberg, S., Han, N., De Yoreo, J. J., Dove, P. M., 2017. Chemical and physical controls on the transformation of amorphous calcium carbonate into crystalline CaCO₃ polymorphs. Geochimica et Cosmochimica Acta 196, 179-196. https://doi.org/10.1016/j.gca.2016.09.004, incorporated herein by reference in its entirety.

In certain embodiments, admixture can include one or more 2D substrates terminated with functional groups, which may also influence crystal phase, size, shape, and/or orientation. Exemplary strategies for preparing functional group substrates include Langmuir monolayer, surface carbonylation, and alkanethiol self-assembling monolayer (SAM). For example, a stearic acid monolayer has been used to direct CaCO₃ crystallization. Various functional groups can be micro-patterned on a substrate to guide CaCO3 crystallization. Thus, in certain embodiments 2D substrates with —COOH, —NH₂, —OH, SO₃H, —CH₃, —SH, and/or or PO₄H₂, can be used to control CaCO₃ mineralization. The physical and/or chemical properties of the substrate may be manipulated as suitable for desired outcome. These include chemical character, hydrophilicity, charge (or coordination number) and geometry (or spatial structure) of terminated functional groups, substrate metals and length of alkanethiol molecule. Additionally or alternatively, environmental factors such as temperature and/or initial concentration of Catt may be manipulated. ACC formation and transformation may be preferred on strong hydrophilic surfaces, for example, on —OH or —SH terminated SAMs. Without being bound by theory, it is thought that CaCO₃ nucleates via the same mechanism on —OH, NH₂, and —CH₃ terminated SAMs. Double-hydrophilic block copolymers based on poly(ethyleneglycol) (PEG), carboxylated polyanilines (c-PANIs) can be used to mediate CaCO₃ crystallization, and can provide control over crystal size, shape, and modification, e.g., promote production of purely crystalline calcite and/or vaterite. Addition of —OH and —COOH tailored functional polymer can potentially stabilize ACC precursor phase, which may gradually transform to calcites, if desired. Additionally or alternatively, charged functional groups can be coupled with Ca²⁺ ions to facilitate CaCO₃ crystallization. See, e.g., Deng, H., Shen, X.-C., Wang, X.-M., Du, C., 2013. Calcium carbonate crystallization controlled by functional groups: A mini-review. Frontiers of Materials Science 7, 62-68. https://doi.org/10.1007/s11706-013-0191-y, incorporated herein by reference in its entirety; in particular, see Table 1 for potential influences of various admixtures on morphologies.

In certain embodiments admixture may include one or more complexing agents, such as Ethylenediaminetetraaceticacid (EDTA) and/or 1-hydroxyethy-lidene-1,1-diphosphonic acid (HEDP). For example, without being bound by theory, EDTA is reported to retard the crystal growth of calcite and aragonite. Aquasoft 330, a commercial grade HEDP is reported to control the morphology of CaCO3 and calcium oxalate. See, e.g., Gopi, S. P., Subramanian, V. K., Palanisamy, K., 2015. Synergistic Effect of EDTA and HEDP on the Crystal Growth, Polymorphism, and Morphology of CaCO₃. Industrial & Engineering Chemistry Research 54, 3618-3625. https://doi.org/10.1021/ie5034039, incorporated herein by reference in its entirety.

In certain embodiments, admixture may include low molecular weight and polymeric additives, such as block copolymers, poly(ethylene glycol) (PEG), polyelectrolyte, polyacrylamide and cellulose, which can exhibit large influence on the crystallization of CaCO3. See, e.g., Xie et al., 2006; Xu et al., 2008; Xu et al., 2011, Sadowski et al., 2010; Su et al., 2010, all of which are incorporated by reference herein in their entireties. Among various templates, PEG is of particular interest because its molecules contain hydrophilic groups, which can act as a donor to metal ions to form metal complexes with diverse conformation. CaCO3 mineralized without PEG polymer formed rhombohedral calcite crystals of an average size of 12.5 and 21.5 μm after 5 min and 24 h of incubation, respectively. In contrast, CaCO₃ precipitates obtained in the presence of PEG but collected after 24 hours of incubation exhibited particles with diameters ranging from 13.4 to 15.9 μm. The slight increase in the particle size observed at a high polymer concentration may be caused by the flocculation effect. Thus, without being bound by theory, it is thought that the presence of poly(ethylene glycol) inhibits the growth of CaCO₃ particles in the system. It is known that low and high molecular weight additives can stabilize nonequilibrium morphologies by changing the relative growth rates of different crystal faces through molecular, specific interactions with certain surfaces that modify the surface energy or growth mechanism, or both. Further without being bound by theory, it is also thought that in aqueous solution, Ca²⁺ and CO₃²⁻ firstly form ACC, which quickly transforms into vaterite and calcite within minutes, but at the same time the polymer molecules adsorb on the surface of the particles, which can inhibit the growth of crystal during the process resulting in formation small particles. See, e.g., Polowczyk, I., Bastrzyk, A., Kozlecki, T., Sadowski, Z., 2013. Calcium carbonate mineralization. Part 1: The effect of poly(ethylene glycol) concentration on the formation of precipitate. Faculty of Geoengineering, Mining and Geology, Wroclaw University of Technology, Wroclaw. https://doi.org/10.5277/ppmp130222, which is incorporated by reference herein in its entirety.

In certain embodiments, admixture may include water-soluble macro-molecules as soluble additives which may, e.g., affect the crystallization of CaCO3; such additives may be present with insoluble matrices. Exemplary soluble additives include poly(acrylic acid) (PAA); PAAm: Poly(allylamine); PGA: Poly(glutamic acid) sodium salt; DNA: deoxyribonucleic acid, such as sodium salt from salmon sperm (DNA); these admixtures can be used with one or more substrates, when suitable, such as glass, Poly(ethylene-co-acrylic acid) (PEAA) (20 wt % acrylic acid), or chitosan. PEAA and chitosan contain carboxylic acid and amino groups, respectively. These polymers can be spin-coated on glass substrates. In the absence of soluble additives, rhombohedral calcite crystals can grow on all three substrates. Different substrate/macro-molecule combinations can have different effects. For example, for glass, there may be no crystallization with PAA or PAAm, whereas spherical crystals may be obtained with PGA additive (vaterite and calcite) or DNA (calcite). The same effects can be seen with additives on PEAA. With chitosan, PAA and PGA may give thin film states of CaCO₃. Without being bound by theory, the carboxylic acid of PAA and PGA and the amino group of chitosan may cause interactions, which results in the formation of thin film crystals. Spherical particles sporadically grow on the surfaces in the presence of DNA. For further discussion of these potential admixtures see, e.g., Kato, T., Suzuki, T., Amamiya, T., Irie, T., Komiyama, M., Yui, H., 1998. Effects of macromolecules on the crystallization of CaCO₃ the Formation of Organic/Inorganic Composites. Supramolecular Science 5, 411-415. https://doi.org/10.1016/S0968-5677 (98) 00041-8, incorporated by reference herein in its entirety.

The admixture (or each admixture) may be added to any suitable final percentage (bwc), such as in the range of 0.01-0.5%, or 0.01-0.3%, or 0.01-0.2%, or 0.01-0.1%, or 0.01-1.0%, or 0.01-0.05%, or 0.05% to 5%, or 0.05% to 1%, or 0.05% to 0.5%, or 0.1% to 1%, or 0.1% to 0.8%, or 0.1% to 0.7% per weight of cement. The admixture (or each admixture in a combination of admixtures) may be added to a final percentage of greater than 0.0001, 0.0002, 0.0005, 0.001, 0.002, 0.005, 0.01, 0.02, 0.03, 0.04, 0.05, 0.06, 0.07, 0.08, 0.09, 0.1, 0.15, 0.2, 0.3, 0.4, 0.5%, 0.6%, 0.7%, 0.8%, 0.9, or 1.0% bwc; in certain cases also less than 10, 5, 4, 3, 2, 1, 0.9, 0.8, 0.7, 0.6, 0.5, 0.4, 0.3, 0.2, 0.1, 0.09, 0.08, 0.07, 0.06, 0.05, 0.04, 0.03, 0.02, 0.01, 0.005, 0.002, 0.001, 0.0005, or 0.002% bwc. Other ranges and quantities are as described herein.

In certain embodiments, use of carbonation and admixture, as described herein, results in increased strength, e.g., compressive strength as measured by standard tests in the art, at one or more times, such as at 1, 7, or 28 days. In certain embodiments, the use of carbonation and an admixture containing an accelerant results in increased strength at least two of the times of 1, 7, or 28 days; in certain embodiments, the use of carbonation and an admixture containing an accelerant results in increased strength at all three of the times of 1, 7, or 28 days. The increase in strength, at any of the times, may be at least 0.5, 1.0, 1.5, 2.0, 2.5, 3.0, 3.5, 4.0, 4.5, 5.0, 6, 7, 8, 9, 10, 11, 12, 13, 14, 15, 17, 20, 22, 25, 27, 30, 32, 35, 40, 50, 60, 70, 80, 90 or 100%, compared to the same cement mix without carbonation and without the accelerant-containing admixture.

Other advantages, when compared to the same mix without carbonation or admixture, can include providing a strength safety factor and/or expanded performance space, reducing in-place concrete costs, permitting higher replacement levels of supplementary cementitious materials (SCMs), earlier stripping and reuse of forms, and reduction of carbon dioxide emissions associated with concrete, both because of the absorbed carbon dioxide and because of reduction in the amount of cement required for a given strength. Further advantages include reduced water content for a given level of workability, or improved workability at equal water content when compared to non-treated, reference concrete, normal setting characteristics, high early strength, superior slump retention, high ultimate strengths, optimum setting time, consistent air entrainment, dosage flexibility, reduced drying shrinkage (e.g., as much as 80% at 28 days, and up to 50% at one year and beyond), reduced stresses induced from one-dimensional surface drying in concrete slabs and floors, reduced carbonation (from atmosphere) after pouring, superior pumpability and/or finishability, increased flexural strength at one more ages, retarded setting (can be controlled retardation depending on, e.g., addition rate), dead-load deflection can take place (before concrete sets) in extended pours for bridge decks, cantilevers, nonshored structural elements, etc., minimal bleed water, cohesive and non-segregating, extended plasticity range, extended slump retention, optimized cement and pigment dispersion. Benefits can include faster concrete placement, superplasticizing effect for high-slump applications, rapid strength gain for energy savings and earlier stripping (for precast/prestressed concrete applications), earlier structural use of concrete, consistency in placement operations, optimized mixture costs, reduction in patching costs, ability to attain difficult combinations of high-early and late-age compressive strengths, increased productivity, improved operational efficiencies, less QC support, fewer rejected loads, faster form turnover, workability retention without retardation, reduced drying shrinkage cracking and microcracking thereby improving aesthetics, watertightness and durability, reduced prestress loss, reduced curling, improved resistance to damage from cyclic freezing and thawing, improved resistance to scaling from deicing salts, reduced permeability—increased watertightness, reduced segregation and bleeding, increased service life, superior finishing characteristics of flatwork and cast surfaces, flexibility in scheduling of placing and finishing operations, offsets effects of early stiffening during extended delays between mixing and placing, helps eliminate cold joints, lowered peak temperature and/or rate of temperature rise in mass concrete thereby reducing thermal cracking, higher modulus of elasticity, improved bond strength to steel, improved visual appeal, potentially reduced cement and color requirements, extends life of mold and other machine parts (e.g., when making blocks, pavers, dry cast), increased tolerance to variation of moisture content in the mix and consequent more homogeneous mix properties at higher w/c. In addition, structures made with a carbonated/admixture mix can have increased durability, decreasing/delaying maintenance and replacement costs and further reducing carbon footprint due to longer useful life.

In certain embodiments, the methods and compositions include a cement mix, e.g., a concrete mix, wherein carbon dioxide is added to the mix and at least one accelerator is added to the mix. The carbon dioxide can be added at any suitable dose, such as the doses described herein, e.g., a dose of 0.001-10.0% by weight cement (bwc), for example 0.001-5.0% or 0.001-2.0% or 0.001-1.0% or 0.005-1.0% or 0.005-0.5% bwc. The carbon dioxide can be added as one dose, or as two, three, four, five, or more than five divided doses. The carbon dioxide may be added in any suitable form, such as carbon dioxide comprising solid carbon dioxide, e.g., a mixture of gaseous and sold carbon dioxide produced from liquid carbon dioxide. The accelerator may be added with cement, e.g., as interground with cement, with mix water, or after mixing has commenced, or any combination thereof, in a single dose or as two, three, four, five, or more than five divided doses. If a dose of accelerant is added in mix water, then generally it will be present before carbon dioxide addition. In this case, carbon dioxide can be added after accelerator (i.e., after mixing starts) at any suitable time, as described herein. Additional accelerator may be added during or after carbon dioxide addition. As will be appreciated, any suitable combination of doses and timing, as described herein, may be used. Suitable accelerators include those described herein. In certain embodiments, an accelerator including one or more alkanolamines is used, such as triethylamine (TEA), and/or higher trialkanolamines. The term “higher trialkanolamine” as used herein includes tertiary amine compounds which are tri(hydroxyalkyl) amines having at least one C₃-C₅ hydroxyalkyl (preferably a C₃-C₄ hydroxyalkyl) group therein. The remaining, if any, hydroxyalkyl groups of the subject tertiary amine can be selected from C₁-C₂ hydroxyalkyl groups (preferably C₂ hydroxyalkyl). Examples of such compounds include hydroxyethyl di(hydroxypropyl)amine, di(hydroxyethyl) hydroxypropylamine, tri(hydroxypropyl)amine, hydroxyethyl di(hydroxy-n-butyl)amine, tri(2-hydroxybutyl)amine, hydroxybutyl di(hydroxypropyl)amine, and the like. In certain embodiments, a set accelerator including one, two, or three of triisopropanolamine (TIPA), N,N-bis(2-hydroxyethyl)-N-(2-hydroxypropyl)amine (BHEHPA) and tri(2-hydroxybutyl)amine (T2BA) is used, for example, a set accelerator comprising TIPA. Any suitable dose may be used, such as 0.0001-0.5% bwc, such as 0.001-0.1%, or 0.005-0.03% bwc. See U.S. Pat. No. 5,084,103. Additional admixtures may be used, such as one or more set balancers, hydration seeds, dispersants, air controllers, rheology modifiers, and/or colorants. One suitable combination of accelerant and other admixtures is Master X-Seed 55™ (BASF Corporation, Cleveland, OH). In certain embodiments, one or more set retarders may be used in the mix. Suitable set retarders include those described herein. Compositions provided by these methods are also included.

In certain embodiments, the methods and compositions include a cement mix, e.g., a concrete mix, wherein carbon dioxide is added to the mix and at least one admixture that acts to offset acceleration provided by the CO₂, e.g., set retarder is added to the mix. The carbon dioxide can be added at any suitable dose, such as the doses described herein, e.g., a dose of 0.001-10.0% by weight cement (bwc), for example 0.001-5.0% or 0.001-2.0% or 0.001-1.0% or 0.005-1.0% or 0.005-0.5% bwc. The carbon dioxide can be added as one dose, or as two, three, four, five, or more than five divided doses. The carbon dioxide may be added in any suitable form, such as carbon dioxide comprising solid carbon dioxide, e.g., a mixture of gaseous and sold carbon dioxide produced from liquid carbon dioxide. The admixture that acts to offset acceleration provided by the CO₂, e.g., retarder may be added with the cement, e.g., as interground with cement, with mix water, or after mixing has commenced, or any combination thereof, in a single dose or as two, three, four, five, or more than five divided doses. If a dose of admixture that acts to offset acceleration provided by the CO₂, e.g., retarder is added in mix water, then generally it will be present before carbon dioxide addition. In this case, carbon dioxide can be added after admixture that acts to offset acceleration provided by the CO₂, e.g., retarder (i.e., after mixing starts) at any suitable time, as described herein. Additional admixture that acts to offset acceleration provided by the CO₂, e.g., retarder may be added during or after carbon dioxide addition. As will be appreciated, any suitable combination of doses and timing, as described herein, may be used. Suitable admixture that acts to offset acceleration provided by the CO₂, e.g., set retarders include those described herein.

In certain embodiments, the methods and compositions include a cement mix, e.g., a concrete mix, wherein carbon dioxide is added to the mix and at least one admixture that acts to develop or stabilize Ca²⁺ in solution is added to the mix. The carbon dioxide can be added at any suitable dose, such as the doses described herein, e.g., a dose of 0.001-10.0% by weight cement (bwc), for example 0.001-5.0% or 0.001-2.0% or 0.001-1.0% or 0.005-1.0% or 0.005-0.5% bwc. The carbon dioxide can be added as one dose, or as two, three, four, five, or more than five divided doses. The carbon dioxide may be added in any suitable form, such as carbon dioxide comprising solid carbon dioxide, e.g., a mixture of gaseous and sold carbon dioxide produced from liquid carbon dioxide. The admixture that acts to develop or stabilize Ca²⁺ in solution may be added with the cement, e.g., interground with cement, with mix water, or after mixing has commenced, or any combination thereof, in a single dose or as two, three, four, five, or more than five divided doses. If a dose of admixture that acts to develop or stabilize Ca²⁺ in solution is added in mix water, then generally it will be present before carbon dioxide addition. In this case, carbon dioxide can be added after admixture that acts to develop or stabilize Ca²⁺ in solution (i.e., after mixing starts) at any suitable time, as described herein. Additional admixture that acts to develop or stabilize Ca²⁺ in solution may be added during or after carbon dioxide addition. As will be appreciated, any suitable combination of doses and timing, as described herein, may be used.

In certain embodiments, the methods and compositions include a cement mix, e.g., a concrete mix, wherein carbon dioxide is added to the mix and at least one admixture that acts to prevent carbonate reaction products from coarsening or flocculating is added to the mix. The carbon dioxide can be added at any suitable dose, such as the doses described herein, e.g., a dose of 0.001-10.0% by weight cement (bwc), for example 0.001-5.0% or 0.001-2.0% or 0.001-1.0% or 0.005-1.0% or 0.005-0.5% bwc. The carbon dioxide can be added as one dose, or as two, three, four, five, or more than five divided doses. The carbon dioxide may be added in any suitable form, such as carbon dioxide comprising solid carbon dioxide, e.g., a mixture of gaseous and sold carbon dioxide produced from liquid carbon dioxide. The admixture that acts to prevent carbonate reaction products from coarsening or flocculating may be added with cement, e.g., as interground with cement, with mix water, or after mixing has commenced, or any combination thereof, in a single dose or as two, three, four, five, or more than five divided doses. If a dose of admixture that acts to prevent carbonate reaction products from coarsening or flocculating is added in mix water, then generally it will be present before carbon dioxide addition. In this case, carbon dioxide can be added after admixture that acts to prevent carbonate reaction products from coarsening or flocculating (i.e., after mixing starts) at any suitable time, as described herein. Additional admixture that acts to prevent carbonate reaction products from coarsening or flocculating may be added during or after carbon dioxide addition. As will be appreciated, any suitable combination of doses and timing, as described herein, may be used.

In certain embodiments, the methods and compositions include a cement mix, e.g., a concrete mix, wherein carbon dioxide is added to the mix and at least one admixture that acts to modulate carbonate reaction product size or geometry is added to the mix. The carbon dioxide can be added at any suitable dose, such as the doses described herein, e.g., a dose of 0.001-10.0% by weight cement (bwc), for example 0.001-5.0% or 0.001-2.0% or 0.001-1.0% or 0.005-1.0% or 0.005-0.5% bwc. The carbon dioxide can be added as one dose, or as two, three, four, five, or more than five divided doses. The carbon dioxide may be added in any suitable form, such as carbon dioxide comprising solid carbon dioxide, e.g., a mixture of gaseous and sold carbon dioxide produced from liquid carbon dioxide. The admixture that acts to modulate carbonate reaction product size or geometry may be added with cement, e.g., as interground with cement, with mix water, or after mixing has commenced, or any combination thereof, in a single dose or as two, three, four, five, or more than five divided doses. If a dose of admixture that acts to modulate carbonate reaction product size or geometry is added in mix water, then generally it will be present before carbon dioxide addition. In this case, carbon dioxide can be added after admixture that acts to modulate carbonate reaction product size or geometry (i.e., after mixing starts) at any suitable time, as described herein. Additional admixture that acts to modulate carbonate reaction product size or geometry may be added during or after carbon dioxide addition. As will be appreciated, any suitable combination of doses and timing, as described herein, may be used. Suitable admixture that acts to modulate carbonate reaction product size or geometry include those described herein.

In certain embodiments, the methods and compositions include a cement mix, e.g., a concrete mix, wherein carbon dioxide is added to the mix and at least one admixture that acts to promote homogenous nucleation of CaCO₃ is added to the mix. The carbon dioxide can be added at any suitable dose, such as the doses described herein, e.g., a dose of 0.001-10.0% by weight cement (bwc), for example 0.001-5.0% or 0.001-2.0% or 0.001-1.0% or 0.005-1.0% or 0.005-0.5% bwc. The carbon dioxide can be added as one dose, or as two, three, four, five, or more than five divided doses. The carbon dioxide may be added in any suitable form, such as carbon dioxide comprising solid carbon dioxide, e.g., a mixture of gaseous and sold carbon dioxide produced from liquid carbon dioxide. The admixture that acts to promote homogenous nucleation of CaCO₃ may be added with cement, e.g., as interground with cement, with mix water, or after mixing has commenced, or any combination thereof, in a single dose or as two, three, four, five, or more than five divided doses. If a dose of admixture that acts to promote homogenous nucleation of CaCO₃ is added in mix water, then generally it will be present before carbon dioxide addition. In this case, carbon dioxide can be added after admixture that acts to promote homogenous nucleation of CaCO₃ (i.e., after mixing starts) at any suitable time, as described herein. Additional admixture that acts to promote homogenous nucleation of CaCO₃ may be added during or after carbon dioxide addition. As will be appreciated, any suitable combination of doses and timing, as described herein, may be used.

In certain embodiments, the methods and compositions include a cement mix, e.g., a concrete mix, wherein carbon dioxide is added to the mix and at least one admixture that acts to influence the interaction of the CO₂ with sulfates, ferrites, aluminates and/or magnesiates, e.g., inhibiting or promoting, is added to the mix. The carbon dioxide can be added at any suitable dose, such as the doses described herein, e.g., a dose of 0.001-10.0% by weight cement (bwc), for example 0.001-5.0% or 0.001-2.0% or 0.001-1.0% or 0.005-1.0% or 0.005-0.5% bwc. The carbon dioxide can be added as one dose, or as two, three, four, five, or more than five divided doses. The carbon dioxide may be added in any suitable form, such as carbon dioxide comprising solid carbon dioxide, e.g., a mixture of gaseous and sold carbon dioxide produced from liquid carbon dioxide. The admixture that acts to influence the interaction of the CO₂ with sulfates, ferrites, aluminates and/or magnesiates, e.g., inhibiting or promoting, may be added with cement, e.g., as interground with cement, with mix water, or after mixing has commenced, or any combination thereof, in a single dose or as two, three, four, five, or more than five divided doses. If a dose of admixture that acts to influence the interaction of the CO₂ with sulfates, ferrites, aluminates and/or magnesiates, e.g., inhibiting or promoting, is added in mix water, then generally it will be present before carbon dioxide addition. In this case, carbon dioxide can be added after admixture that acts to influence the interaction of the CO₂ with sulfates, ferrites, aluminates and/or magnesiates, e.g., inhibiting or promoting (i.e., after mixing starts) at any suitable time, as described herein. Additional admixture that acts to influence the interaction of the CO₂ with sulfates, ferrites aluminates and/or magnesiates, e.g., inhibiting or promoting, may be added during or after carbon dioxide addition. As will be appreciated, any suitable combination of doses and timing, as described herein, may be used.

In certain embodiments, the methods and compositions include a cement mix, e.g., a concrete mix, wherein carbon dioxide is added to the mix and at least one admixture that acts to influence the actions of sulfates, ferrites, aluminates and/or magnesiates, e.g., inhibiting or promoting, is added to the mix. The carbon dioxide can be added at any suitable dose, such as the doses described herein, e.g., a dose of 0.001-10.0% by weight cement (bwc), for example 0.001-5.0% or 0.001-2.0% or 0.001-1.0% or 0.005-1.0% or 0.005-0.5% bwc. The carbon dioxide can be added as one dose, or as two, three, four, five, or more than five divided doses. The carbon dioxide may be added in any suitable form, such as carbon dioxide comprising solid carbon dioxide, e.g., a mixture of gaseous and sold carbon dioxide produced from liquid carbon dioxide. The admixture that acts to influence the actions of sulfates, ferrites, aluminates and/or magnesiates, e.g., inhibiting or promoting, may be added with cement, e.g., as interground with cement, with mix water, or after mixing bas commenced, or any combination thereof, in a single dose or as two, three, four, five, or more than five divided doses. If a dose of admixture that acts to influence the actions of sulfates, ferrites and/or aluminates, e.g., inhibiting or promoting, is added in mix water, then generally it will be present before carbon dioxide addition. In this case, carbon dioxide can be added after admixture that acts to influence the actions of sulfates, ferrites, aluminates and/or magnesiates, e.g., inhibiting or promoting (i.e., after mixing starts) at any suitable time, as described herein. Additional admixture that acts to influence the actions of sulfates, ferrites, aluminates and/or magnesiates, e.g., inhibiting or promoting, may be added during or after carbon dioxide addition. As will be appreciated, any suitable combination of doses and timing, as described herein, may be used.

In certain embodiments, the methods and compositions include a cement mix, e.g., a concrete mix, wherein carbon dioxide is added to the mix and at least one admixture that acts to offset workability loss associated with the carbonation is added to the mix. The carbon dioxide can be added at any suitable dose, such as the doses described herein, e.g., a dose of 0.001-10.0% by weight cement (bwc), for example 0.001-5.0% or 0.001-2.0% or 0.001-1.0% or 0.005-1.0% or 0.005-0.5% bwc. The carbon dioxide can be added as one dose, or as two, three, four, five, or more than five divided doses. The carbon dioxide may be added in any suitable form, such as carbon dioxide comprising solid carbon dioxide, e.g., a mixture of gaseous and sold carbon dioxide produced from liquid carbon dioxide. The admixture that acts to offset workability loss associated with the carbonation may be added with cement, e.g., as interground with cement, with mix water, or after mixing has commenced, or any combination thereof, in a single dose or as two, three, four, five, or more than five divided doses. If a dose of admixture that acts to offset workability loss associated with the carbonation is added in mix water, then generally it will be present before carbon dioxide addition. In this case, carbon dioxide can be added after admixture that acts to offset workability loss associated with the carbonation (i.e., after mixing starts) at any suitable time, as described herein. Additional admixture that acts to offset workability loss associated with the carbonation may be added during or after carbon dioxide addition. As will be appreciated, any suitable combination of doses and timing, as described herein, may be used. Suitable admixtures that act to offset workability loss associated with the carbonation include those described herein, for example, plasticizers and set retarders.

In certain embodiments, the methods and compositions include a cement mix, e.g., a concrete mix, wherein carbon dioxide is added to the mix and at least one admixture that acts to control, modify or otherwise impact the nature of the carbonate reaction product formed (e.g., size, chemical composition, and/or crystallinity) is added to the mix. The carbon dioxide can be added at any suitable dose, such as the doses described herein, e.g., a dose of 0.001-10.0% by weight cement (bwc), for example 0.001-5.0% or 0.001-2.0% or 0.001-1.0% or 0.005-1.0% or 0.005-0.5% bwc. The carbon dioxide can be added as one dose, or as two, three, four, five, or more than five divided doses. The carbon dioxide may be added in any suitable form, such as carbon dioxide comprising solid carbon dioxide, e.g., a mixture of gaseous and sold carbon dioxide produced from liquid carbon dioxide. The admixture that acts to control, modify or otherwise impact the nature of the carbonate reaction product formed (e.g., size, chemical composition, and/or crystallinity) may be added with the cement, e.g., as interground with cement, with mix water, or after mixing has commenced, or any combination thereof, in a single dose or as two, three, four, five, or more than five divided doses. If a dose of admixture that acts to control, modify or otherwise impact the nature of the carbonate reaction product formed (e.g., size, chemical composition, and/or crystallinity) is added in mix water, then generally it will be present before carbon dioxide addition. In this case, carbon dioxide can be added after admixture that acts to control, modify or otherwise impact the nature of the carbonate reaction product formed (e.g., size, chemical composition, and/or crystallinity) (i.e., after mixing starts) at any suitable time, as described herein. Additional admixture that acts to control, modify or otherwise impact the nature of the carbonate reaction product formed (e.g., size, chemical composition, and/or crystallinity) may be added during or after carbon dioxide addition. As will be appreciated, any suitable combination of doses and timing, as described herein, may be used.

In certain embodiments, the methods and compositions include a cement mix, e.g., a concrete mix, wherein carbon dioxide is added to the mix and at least one admixture that acts to control, modify or otherwise impact the development of hydration products that develop on the carbonate product is added to the mix. The carbon dioxide can be added at any suitable dose, such as the doses described herein, e.g., a dose of 0.001-10.0% by weight cement (bwc), for example 0.001-5.0% or 0.001-2.0% or 0.001-1.0% or 0.005-1.0% or 0.005-0.5% bwc. The carbon dioxide can be added as one dose, or as two, three, four, five, or more than five divided doses. The carbon dioxide may be added in any suitable form, such as carbon dioxide comprising solid carbon dioxide, e.g., a mixture of gaseous and sold carbon dioxide produced from liquid carbon dioxide. The admixture that acts to control, modify or otherwise impact the development of hydration products that develop on the carbonate product may be added with cement, e.g., as interground with cement, with mix water, or after mixing has commenced, or any combination thereof, in a single dose or as two, three, four, five, or more than five divided doses. If a dose of admixture that acts to control, modify or otherwise impact the development of hydration products that develop on the carbonate product is added in mix water, then generally it will be present before carbon dioxide addition. In this case, carbon dioxide can be added after admixture that acts to control, modify or otherwise impact the development of hydration products that develop on the carbonate product (i.e., after mixing starts) at any suitable time, as described herein. Additional admixture that acts to control, modify or otherwise impact the development of hydration products that develop on the carbonate product may be added during or after carbon dioxide addition. As will be appreciated, any suitable combination of doses and timing, as described herein, may be used. Suitable admixtures include anionic surfactants, e.g., dodecyl sulfate sodium salt (SDS), and cationic surfactants, e.g., cetyltrimethylammonium bromide (CTAB), cetylpyridinium bromide (CPB) and tetra(decyl) ammonium bromide (TDAB). The presence of particular anions can also modulate development of hydration products that develop on the carbonate product; thus, in certain embodiments, an admixture may contain nitrate, chloride, or hydroxide, e.g., nitrate. See, e.g., Moghaddam et al., J. Materials Chem. A, DOI 10 1039/c6ta09389b, 2016.

In certain embodiments, a method of producing a cement mix is provided, comprising mixing a hydraulic cement, such as Portland cement, e.g., OPC with carbon dioxide and an admixture. In certain embodiments, the admixture comprises a dispersant, a water reducer, an air entrainer, or a combination thereof. In certain embodiments, the admixture comprises polyacrylate, such as sodium polyacrylate; polycarboxylate, such as polycarboxylate ether; lignin, such as a lignin polymer, a lignosulphate, a lignosulfonate triethanolamine; triethanolamine (TEA); a nitrate, such as sodium nitrate; a thiocyanate, such as sodium thiocyanate; or a combination thereof. The carbon dioxide can be present in any suitable amount, such as at least 0.01, 0.02, 0.03, 0.04, 0.05, 0.07, 0.1, 0.15, 0.2, 0.25, 0.3, 0.35, 0.4, 0.45, 0.5, 0.6, 0.7, 0.8, 0.9, or 1.0% by weight cement (bwc) and/or not more than 0.02, 0.03, 0.04, 0.05, 0.07, 0.1, 0.15, 0.2, 0.25, 0.3, 0.35, 0.4, 0.45, 0.5, 0.6, 0.7, 0.8, 0.9, 1.0, 2.0, or 5% bwc, in certain embodiments at least 0.1%, such as 0.1-0.5%, preferably 0.1-0.4%; in certain embodiments at least 0.2%, such as 0.2-0.5%, preferably 0.3-0.5%. In certain embodiments, the admixture comprises a polycarboxylate or polycarboxylate derivative, such as a polycarboxylate ether; the polycarboxylate or polycarboxylate derivative can be present in any suitable amount, such as from 0.1 to 1% bwc, preferably 0.2 to 1% bwc, even more preferably 0.2 to 0.8%. In certain embodiments, the admixture comprises a lignin or a lignin derivative, such as lignosulfate, lingnosulfonate, or a combination thereof. The lignin or lignin derivative can be present in any suitable amount, such as in an amount from 0.2 to 8% bwc, preferably 0.2 to 6% bwc, even more preferably 0.3 to 0.5%. In certain embodiments the admixture comprises a polyacrylate or polyacrylate derivative. The polyacrylate or polyacrylate derivative can be present in any suitable amount, such as from 0.02 to 0.3% bwc, preferably 0.04 to 0.2% bwc, even more preferably 0.06 to 0.2%. In certain embodiments, a hydraulic cement is used that, in combination with carbon dioxide alone, and/or in combination with admixture alone, has a compressive strength at one or more time points that is less than compressive strength without the carbon dioxide or without the admixture. The carbon dioxide can be present in such an amount, such as an amount described previously in this paragraph, and admixture present as a type and in such an amount, such as a type and amount described previously in this paragraph, to provide a cement mix with compressive strength at one or more time points that is at least as great as the compressive strength without carbon dioxide and admixture, and in many cases a greater compressive strength. In these embodiments, the carbon dioxide and the admixture demonstrate a synergistic effect.

In addition, compositions are provided that result from the methods of the previous paragraph, for example, a composition comprising (i) a hydraulic cement, such as Portland cement, e.g., OPC; (ii) water; (iii) carbon dioxide and/or reaction products of carbon dioxide with the hydraulic cement, e.g., in an amount from 0.01 to 2% bwc; and (iv) an admixture in an amount from 0.01 to 2% bwc. In certain embodiments, the admixture comprises polyacrylate, such as sodium polyacrylate; polycarboxylate, such as polycarboxylate ether; lignin, such as a lignin polymer, a lignosulphate, a lignosulfonate triethanolamine; triethanolamine (TEA); a nitrate, such as sodium nitrate; a thiocyanate, such as sodium thiocyanate; or a combination thereof. In certain embodiments the admixture comprises a polycarboxylate or polycarboxylate derivative, such as a polycarboxylate ether, in any suitable amount, such as an amount from 0.1 to 1% bwc, preferably 0.2 to 1% bwc, even more preferably 0.2 to 0.8%. In certain embodiments the admixture comprises a lignin or lignin derivative, such as lignosulfate, lignosulfonate, in any suitable amount, such as an amount from 0.2 to 8% bwc, preferably 0.2 to 6% bwc, even more preferably 0.3 to 0.5%. In certain embodiments, the admixture comprises a polyacrylate or polyacrylate derivative, in any suitable amount, such as an amount from 0.02 to 0.3% bwc, preferably 0.04 to 0.2% bwc, even more preferably 0.06 to 0.2%.

### EMBODIMENTS

In embodiment 1 provided herein is a method for producing a cement mix comprising mixing water, cement, carbon dioxide, an admixture, and, optionally, aggregates, wherein the combination of carbon dioxide and admixture results in a concrete mix with a compressive strength at one or more time points that is greater than the same concrete mix with just admixture, and/or the same concrete mix with just carbon dioxide.

In embodiment 2 provided herein is the method of embodiment 1 wherein the carbon dioxide is present in an amount of at least 0.01, 0.02, 0.03, 0.04, 0.05, 0.07, 0.1, 0.15, 0.2, 0.25, 0.3, 0.35, 0.4, 0.45, 0.5, 0.6, 0.7, 0.8, 0.9, or 1.0% by weight cement (bwc) and/or not more than 0.02, 0.03, 0.04, 0.05, 0.07, 0.1, 0.15, 0.2, 0.25, 0.3, 0.35, 0.4, 0.45, 0.5, 0.6, 0.7, 0.8, 0.9, 1.0, 2.0, or 5% bwc, in certain embodiments at least 0.1%, such as 0.1-0.5%, preferably 0.1-0.4%; in certain embodiments at least 0.2%, such as 0.2-0.5%, preferably 0.3-0.5%.

In embodiment 3 provided herein is the method of embodiment 1 or embodiment 2 wherein the admixture comprises a dispersant, a water reducer, an air entrainer, or a combination thereof.

In embodiment 4 provided herein is the method of any one of embodiments 1 through 3 wherein the admixture comprises polyacrylate, such as sodium polyacrylate; polycarboxylate, such as polycarboxylate ether; lignin, such as a lignin polymer, a lignosulphate, a lignosulfonate triethanolamine; triethanolamine (TEA); a nitrate, such as sodium nitrate; a thiocyanate, such as sodium thiocyanate; or a combination thereof.

In embodiment 5 provided herein is the method of any one of embodiments 1 through 4 wherein the admixture is present in an amount of at least 0.02, 0.04, 0.06, 0.08, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.2, 1.4, 1.6, 1.8, or 2.0% bwc and/or not more than 0.04, 0.06, 0.08, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.2, 1.4, 1.6, 1.8, 2.0, 3.0, 4.0, or 5% bwc; in certain embodiments 0.05-1%, such as 0.1 to 0.8%.

In embodiment 6 provided herein is the method of any one of embodiments 1 through 5 wherein the admixture comprises a polycarboxylate or polycarboxylate derivative.

In embodiment 7 provided herein is the method of embodiment 6 wherein the admixture comprises a polycarboxylate ether.

In embodiment 8 provided herein is the method of embodiment 7 wherein the polycarboxylate or polycarboxylate derivative is present in an amount from 0.1 to 1% bwc, preferably 0.2 to 1% bwc, even more preferably 0.2 to 0.8%.

In embodiment 9 provided herein is the method of any one of embodiments 1 through 5 wherein the admixture comprises a lignin or lignin derivative.

In embodiment 10 provided herein is the method of embodiment 9 wherein the admixture comprises lignosulfate, lignosulfonate, or a combination thereof.

In embodiment 11 provided herein is the method of embodiment 9 or embodiment 10 wherein the admixture is present in an amount from 0.2 to 8% bwc, preferably 0.2 to 6% bwc, even more preferably 0.3 to 0.5%.

In embodiment 12 provided herein is the method of any one of embodiments 1 through 5 wherein the admixture comprises a polyacrylate or polyacrylate derivative.

In embodiment 13 provided herein is the method of embodiment 12 wherein the admixture is present in an amount from 0.02 to 0.3% bwc, preferably 0.04 to 0.2% bwc, even more preferably 0.06 to 0.2%.

In embodiment 14 provided herein is the method of any of the previous embodiments wherein the combination of carbon dioxide and admixture results in a concrete mix with a setting time that is within allowable limits, whereas the same concrete mix with just admixture, and/or the same concrete mix with just carbon dioxide results in a concrete mix with a setting time that is not within allowable limits.

In embodiment 15 provided herein is a composition comprising (i) a hydraulic cement; (ii) water; (iii) carbon dioxide and/or reaction products of carbon dioxide with the hydraulic cement, in an amount from 0.01 to 5% bwc; and (iv) an admixture in an amount from 0.01 to 2% bwc.

In embodiment 16 provided herein is the composition of embodiment 15 wherein the admixture comprises polyacrylate, such as sodium polyacrylate; polycarboxylate, such as polycarboxylate ether; lignin, such as a lignin polymer, a lignosulphate, a lignosulfonate triethanolamine; triethanolamine (TEA); a nitrate, such as sodium nitrate; a thiocyanate, such as sodium thiocyanate; or a combination thereof.

In embodiment 17 provided herein is the composition of embodiment 16 wherein the admixture comprises a polycarboxylate or polycarboxylate derivative.

In embodiment 18 provided herein is the composition of embodiment 17 wherein the admixture comprises a polycarboxylate ether.

In embodiment 19 provided herein is the composition of embodiment 18 wherein the polycarboxylate or polycarboxylate derivative is present in an amount from 0.1 to 1% bwc, preferably 0.2 to 1% bwc, even more preferably 0.2 to 0.8%.

In embodiment 20 provided herein is the composition of embodiment 16 wherein the admixture comprises a lignin or lignin derivative.

In embodiment 21 provided herein is the composition of embodiment 20 wherein the admixture comprises lignosulfate, lignosulfonate, or a combination thereof.

In embodiment 22 provided herein is the composition of embodiment 20 or embodiment 21 wherein the admixture is present at a concentration of is present in an amount from 0.2 to 8% bwc, preferably 0.2 to 6% bwc, even more preferably 0.3 to 0.5%.

In embodiment 23 provided herein is the composition of embodiment 16 wherein the admixture comprises a polyacrylate or polyacrylate derivative.

In embodiment 24 provided herein is the composition of embodiment 23 wherein the admixture is present in an amount from 0.02 to 0.3% bwc, preferably 0.04 to 0.2% bwc, even more preferably 0.06 to 0.2%.

In embodiment 25 provided herein is a method comprising adding one or more admixtures to water to produce an admixture solution.

In embodiment 26 provided herein is the method of embodiment 25, wherein the admixture comprises polyacrylate, such as sodium polyacrylate; polycarboxylate, such as polycarboxylate ether; lignin, such as a lignin polymer, a lignosulphate, a lignosulfonate triethanolamine; triethanolamine (TEA); a nitrate, such as sodium nitrate; a thiocyanate, such as sodium thiocyanate; or a combination thereof.

In embodiment 27 provided herein is the method of embodiment 26 wherein the admixture comprises a polycarboxylate or polycarboxylate derivative.

In embodiment 28 provided herein is the method of embodiment 27 wherein the admixture comprises a polycarboxylate ether.

In embodiment 29 provided herein is the method of embodiment 28 wherein the polycarboxylate or polycarboxylate derivative is present in an amount from 10 to 80%, preferably 20 to 80%, even more preferably 20 to 60%.

In embodiment 30 provided herein is the method of embodiment 26 wherein the admixture comprises a lignin or lignin derivative.

In embodiment 31 provided herein is the method of embodiment 30 wherein the admixture comprises lignosulfate, lignosulfonate, or a combination thereof.

In embodiment 32 provided herein is the method of embodiment 30 or embodiment 31 wherein the admixture is present at a concentration of is present in an amount from 20 to 80%, preferably 20 to 60%, even more preferably 30 to 50%.

In embodiment 33 provided herein is the method of embodiment 26 wherein the admixture comprises a polyacrylate or polyacrylate derivative.

In embodiment 34 provided herein is the method of embodiment 33 wherein the admixture is present in an amount from 2 to 30%, preferably 4 to 20%, even more preferably 6 to 20%.

In embodiment 35 provided herein is the method of any one of embodiments 25-34, wherein the water comprises potable water.

In embodiment 36 provided herein is the method of any one of embodiments 25-34, wherein the water comprises process water.

In embodiment 37 provided herein is the method of embodiment 36, wherein the water comprises process water comprising wash water,

In embodiment 38 provided herein is the method of any one of embodiments 36-37, wherein the water comprises solids.

In embodiment 39 provided herein is the method of embodiment 38, further comprising removing at least a portion of the solids are prior to adding the one or more admixtures.

In embodiment 40 provided herein is the method of any one of embodiments 25-39, further comprising carbonating the water.

In embodiment 41 provided herein is the method of embodiment 40, wherein the water is carbonated prior to adding one or more admixtures.

In embodiment 42 provided herein is the method of embodiment 40, wherein the water is carbonated after adding one or more admixtures.

In embodiment 43 provided herein is the method of any one of embodiments 25-42, further comprising adding the admixture solution to a composition comprising water, cement, carbon dioxide, and, optionally, aggregates and/or one or more additional admixtures.

In embodiment 44 provided herein is the method of embodiment 43, wherein the combination of carbon dioxide and admixture results in a concrete mix with a compressive strength at one or more time points that is greater than the same concrete mix with just admixture, and/or the same concrete mix with just carbon dioxide.

In embodiment 45 provided herein is a composition comprising one or more admixtures and water.

In embodiment 46 provided herein is the composition of embodiment 45, wherein the admixture comprises polyacrylate, such as sodium polyacrylate; polycarboxylate, such as polycarboxylate ether; lignin, such as a lignin polymer, a lignosulphate, a lignosulfonate triethanolamine; triethanolamine (TEA); a nitrate, such as sodium nitrate; a thiocyanate, such as sodium thiocyanate; or a combination thereof.

In embodiment 47 provided herein is the composition of embodiment 46 wherein the admixture comprises a polycarboxylate or polycarboxylate derivative.

In embodiment 48 provided herein is the composition of embodiment 47 wherein the admixture comprises a polycarboxylate ether.

In embodiment 49 provided herein is the composition of embodiment 48 wherein the polycarboxylate or polycarboxylate derivative is present in an amount from 10 to 80%, preferably 20 to 80%, even more preferably 20 to 60%.

In embodiment 50 provided herein is the composition of embodiment 46 wherein the admixture comprises a lignin or lignin derivative.

In embodiment 51 provided herein is the composition of embodiment 50 wherein the admixture comprises lignosulfate, lignosulfonate, or a combination thereof.

In embodiment 52 provided herein is the composition of embodiment 50 or embodiment 51 wherein the admixture is present at a concentration of is present in an amount from 20 to 80%, preferably 20 to 60%, even more preferably 30 to 50%.

In embodiment 53 provided herein is the composition of embodiment 46 wherein the admixture comprises a polyacrylate or polyacrylate derivative.

In embodiment 54 provided herein is the composition of embodiment 53 wherein the admixture is present in an amount from 2 to 30%, preferably 4 to 20%, even more preferably 6 to 20%.

In embodiment 55 provided herein is the composition of any one of embodiments 45-54, wherein the water comprises potable water.

In embodiment 56 provided herein is the composition of any one of embodiments 45-54, wherein the water comprises concrete reclaimed water.

In embodiment 57 provided herein is the composition of embodiment 56, wherein the water comprises concrete reclaimed water comprising wash water.

In embodiment 58 provided herein is the composition of any one of embodiments 56-57, wherein the water comprises solids.

In embodiment 59 provided herein is the composition of embodiment 58, wherein at least a portion of the solids are removed prior to adding the one or more admixtures.

In embodiment 60 provided herein is the composition of any one of embodiments 25-59, wherein the water is carbonated.

In embodiment 61 provided herein is the composition of any one of embodiments 25-60, further comprising water, cement, carbon dioxide, and, optionally, aggregates and/or one or more additional admixtures.

In embodiment 62 provided herein is the composition of embodiment 61, wherein the combination of carbon dioxide and admixture results in a concrete mix with a compressive strength at one or more time points that is greater than the same concrete mix with just admixture, and/or the same concrete mix with just carbon dioxide.

In embodiment 63 provided herein is an apparatus for producing an admixture solution comprising (A) a source of water, (B) one or more sources of admixture, and (C) a vessel, wherein the source of water and the one or more sources of admixture are operably connected to the vessel.

In embodiment 64 provided herein is the apparatus of embodiment 63, wherein the apparatus is configured to combine water from the source of water and one or more admixtures from the one or more sources of admixture in the vessel.

In embodiment 65 provided herein is the apparatus of embodiment 63 or 64, further comprising: (D) a source of gas, and/or (E) a mixer configured to mix the water and one or more sources of admixture in the vessel.

In embodiment 66 provided herein is the apparatus of embodiment 65, further comprising (i) a first conduit operably connected to the vessel at a proximal end of the first conduit, wherein the first conduit allows the admixture solution to flow through it from the proximal end and out of it at a distal end; and (ii) a second conduit situated inside the first conduit, wherein the second conduit is operably connected to the source of gas and is configured to allow the gas to flow into it and to flow out of it into the admixture solution in the first conduit.

In embodiment 67 provided herein is the apparatus of embodiment 65 or 66, wherein the gas comprises carbon dioxide.

In embodiment 68 provided herein is the apparatus of embodiment 66 or 67, wherein the diameter of the first conduit is 0.5-5 inches and the diameter of the second conduit is 0.3-3 inches.

In embodiment 69 provided herein is the apparatus of any one of embodiments 66-68, further comprising a control system comprising (a) a sensor to sense a characteristic of the admixture solution and transmit information regarding the characteristic to (b) a controller that processes the information from the sensor, and (c) an actuator that receives a signal from the controller based, at least in part, on the processed information from the sensor.

In embodiment 70 provided herein is the apparatus of embodiment 69, wherein the characteristic comprises one or more of (1) pH of the admixture solution, (2) rate of delivery of carbon dioxide to the admixture solution, (3) total amount of admixture solution in the vessel, (4) temperature of the admixture solution, (5) specific gravity of the admixture solution, (6) concentration of one or more ions in the admixture solution, (7) age of the admixture solution, (8) circulation rate of the admixture solution, (9) timing of circulation of the admixture solution, (10) appearance of bubbles at surface of the admixture solution, (11) carbon dioxide concentration of the air above the admixture solution, (12) electrical conductivity of the admixture solution, (13) optical characteristics of the admixture solution, and (14) amount of admixture added to the admixture solution.

In embodiment 71 provided herein is the apparatus of embodiment 69 or 70, wherein the controller comprises at least two sensors, wherein the seconds are configured to monitor at least two characteristics.

In embodiment 72 provided herein is the apparatus of embodiment 69 or 70, wherein the controller comprises at least three sensors, wherein the seconds are configured to monitor at least three characteristics.

In embodiment 73 provided herein is the apparatus of embodiment 69 or 70, wherein the controller comprises at least four sensors, wherein the seconds are configured to monitor at least four characteristics.

In embodiment 74 provided herein is the apparatus of embodiment 69 or 70, wherein the controller comprises at least five sensors, wherein the seconds are configured to monitor at least five characteristics.

In embodiment 75 provided herein is the apparatus of any one of embodiments 63-74, wherein the source of water comprises potable water.

In embodiment 76 provided herein is the apparatus of any one of embodiments 63-74, wherein the source of water comprises concrete reclaimed water.

In embodiment 77 provided herein is the apparatus of embodiment 76, wherein the concrete reclaimed water comprises wash water.

In embodiment 78 provided herein is the apparatus of embodiment 76 or 77, wherein the vessel comprises a reclaimer.

In embodiment 79 provided herein is the apparatus of embodiment 76 or 77, wherein the vessel is operably connected to a reclaimer.

In embodiment 80 provided herein is the apparatus of any one of embodiments 76 through 79, wherein the apparatus is configured to remove at least a portion of solids from the concrete reclaimed water.

### EXAMPLES

### Example 1

Unless otherwise indicated, the following protocol was used in the Examples:

150 g of cement and 150 g of water were weighed out. Admixture was portioned, if needed, into a syringe. Solid CO2 was portioned according to the desired dosage, if needed.

The water was poured into a container (e.g., a 1 liter bottle) followed by the cement. If appropriate, the admixture was added into the soda stream bottle using a syringe

The contents were mixed using a vortex blender for 2 minutes.

CO2 was added and mixed for another 2 minutes

Around 100 g of the mixture was poured into a calorimetry cup and secured with a lid. The sample was placed in an isothermal calorimeter and energy release was logged for a minimum of 20 hr.

CO2 dosages used were 0.05%, 0.1%, 0.2%, 0.3% and 0.4% CO2 by mass of cement. A dose of 0.1% was 0.15 g of solid CO2 flakes.

The reactivity calculation was made using the control containing the same admix at the rest of the test series, if available.

Compositions and properties of cements used in Examples are shown in the Tables below:

Chemical composition of cements

| | | Monarch | Exshaw | National Lebec |
|---|---|---|---|---|
| | Unit | GU | GUL | GUL |
| SiO2 | % | 21.21 | 18.6 | 18.24 |
| Fe2O3 | % | 2.81 | 3.5 | 3.35 |
| Al2O3 | % | 4.34 | 3.8 | 3.67 |
| CaO | % | 63.92 | 61.4 | 64.45 |
| MgO | % | 1.81 | 4.3 | 1.5 |
| SO3 | % | 2.87 | 3.2 | 2.9 |
| LOI | % | 1.59 | 4.7 | 9 |
| CO2 | | N.D. | | 7.9 |
| Insoluble residue | % | 0.28 | 0.36 | 0.84 |
| Free lime | % | 1.33 | N.D. | 0.63 |
| Na2O | % | 0.21 | N.D. | N.D. |
| K2O | % | 0.51 | N.D. | N.D. |
| Eg. Alkalis | % | 0.55 | N.D. | 0.52 |
| Inorganic processing | % | 2.1 | N.D. | N.D. |
| addition | | | | |

Potential Bogue Composition

| | | | | |
|---|---|---|---|---|
| C3S | % | 58.5 | 62.2 | 58 |
| C2S | % | 16.6 | 14.9 | 7.1 |
| C3A | % | 6.5 | 4.6 | 3.9 |
| C4AF | % | 8.4 | 12.2 | 10.2 |
| Limestone content | % | N.A. | 9.5 | 14.7 |
| CaCO3 in limestone | % | N.A. | N.D. | 98.1 |
| Blaine fineness | m2/kg | 387 | 489 | 626 |

Physical properties of cement

| | | | | |
|---|---|---|---|---|
| 325 Sieve passing | % | 96 | 99.4 | 98.6 |
| Initial time of setting | min | 130 | 112 | 105 |
| Final time of setting | min | 240 | N.D. | 235 |
| Spec. Gravity | | 3.13 | 3.11 | N.D. |
| Air content (mortar) | % | 7 | N.D. | 8 |
| Autoclave expansion | % | 0.03 | 0.05 | N.D. |
| Compressive strength 1 Day | psi | 2495 | 3437 | 2420 |
| Compressive strength 3 Days | psi | 3704 | 5178 | N.D. |
| Compressive strength 7 Days | psi | 4826 | 5874 | N.D. |
| Compressive strength 28 | psi | N.D. | 6208 | N.D. |
| Days | | | | |

### Example 2

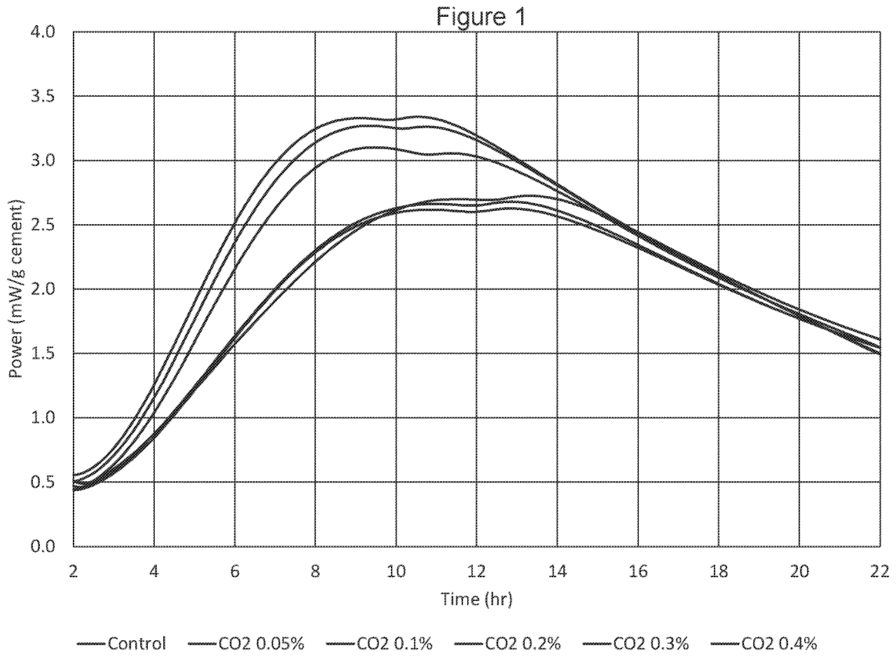

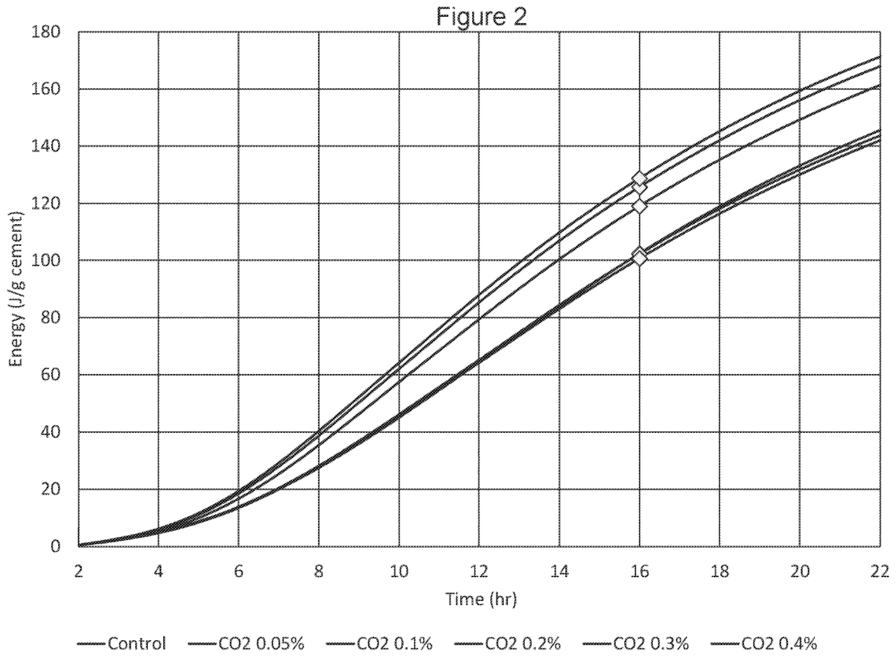

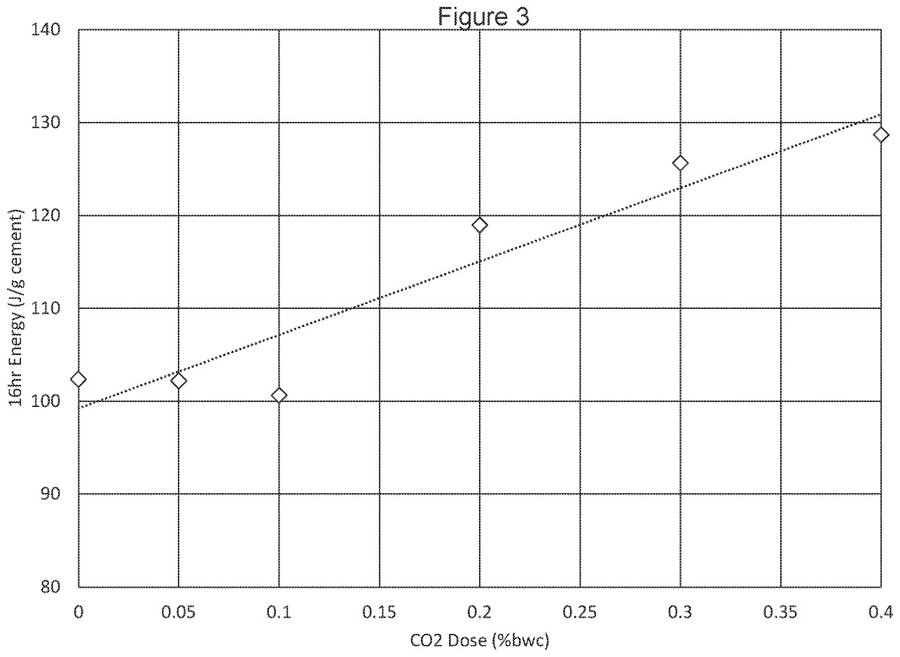

This was an example of a cement response calculation. FIGS. 1-3 show power curves, energy curves, with energies at 16 hours highlighted, and plot of energy at 15 hours vs. the CO2 dose, respectively. The slope through the points can be taken to be the reactivity of the cement+CO2 system. A higher slope indicated a more responsive cement.

### Example 3

In this example, Exshaw GUL cement was used, with various CO2 doses and no admixture.

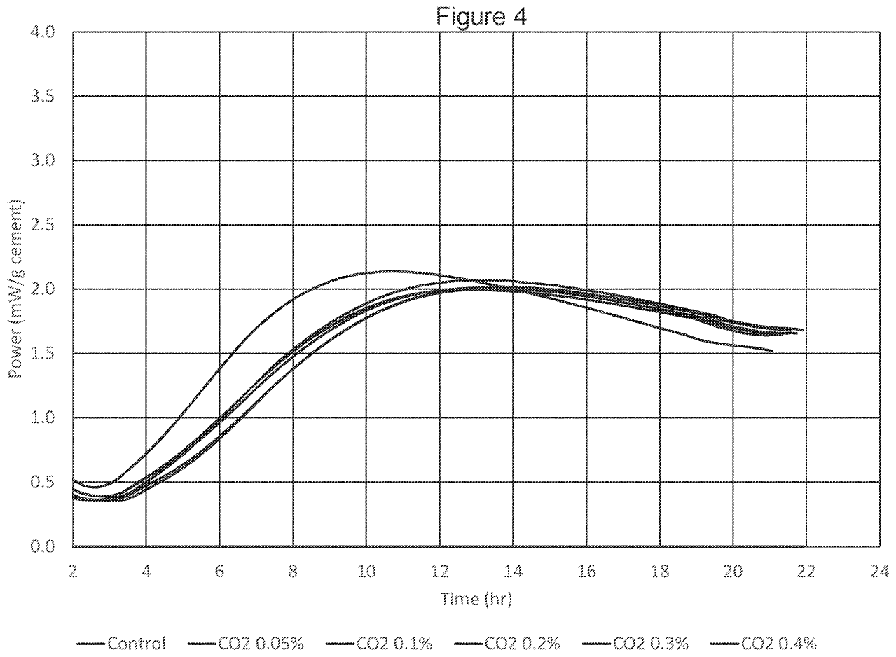

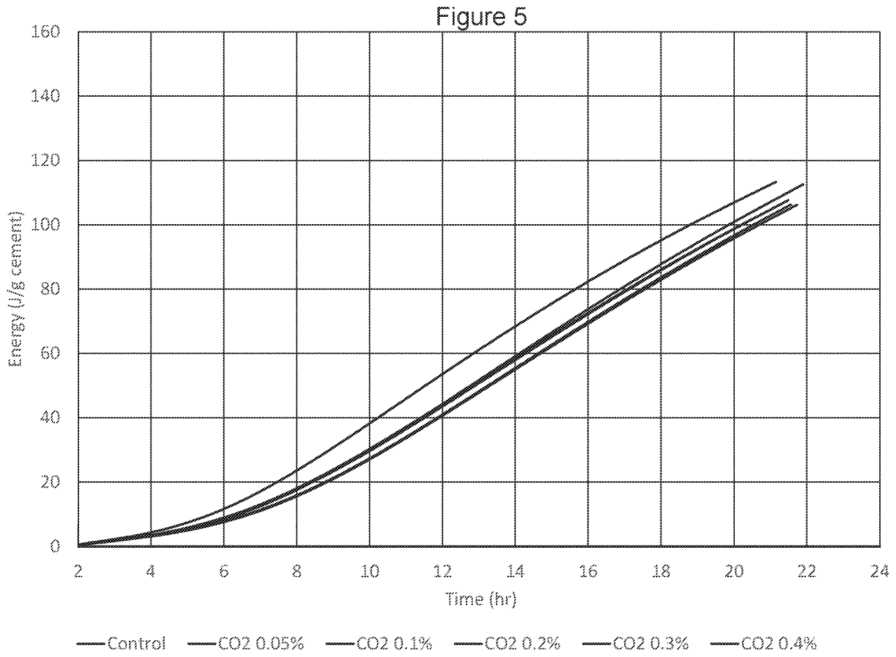

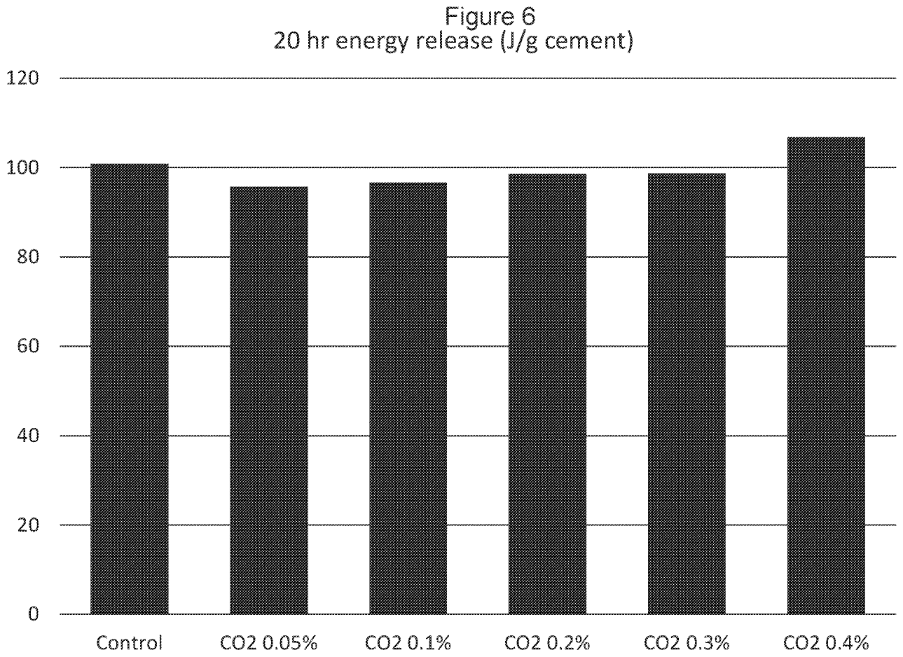

FIGS. 4-6 show Power curves, Energy curves, and plot of energy at 20 hours vs the CO2 dose, respectively. Reactivity score using the 20 hr data=0

This Example demonstrates a type of cement that is relatively unresponsive to carbon dioxide alone, at least at lower doses.

### Example 4

In this Example, the same cement as in Example 3 was used, with various CO2 doses, and an admixture (PAANa, sodium polyacrylate), a dispersant, at 0.08%.

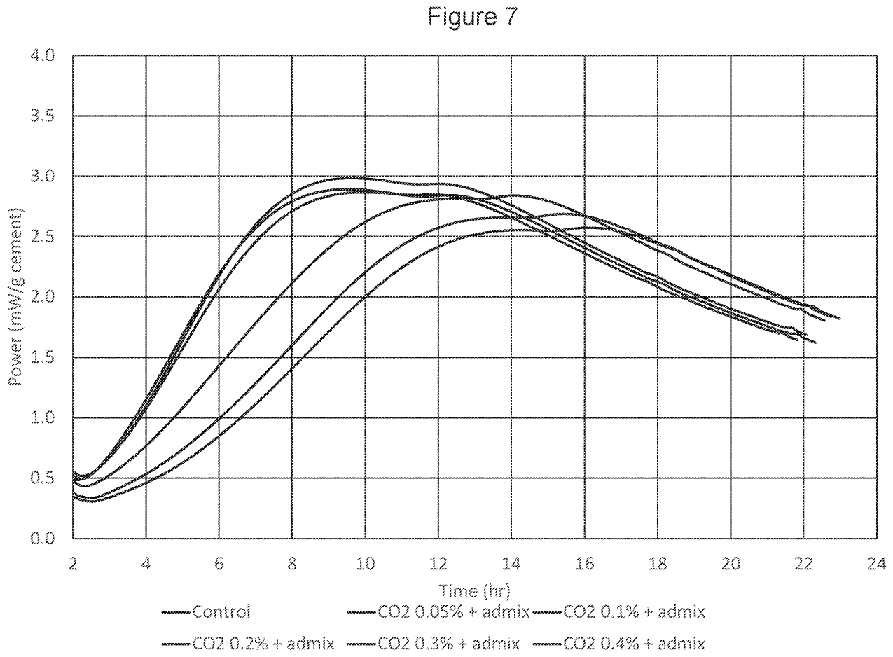

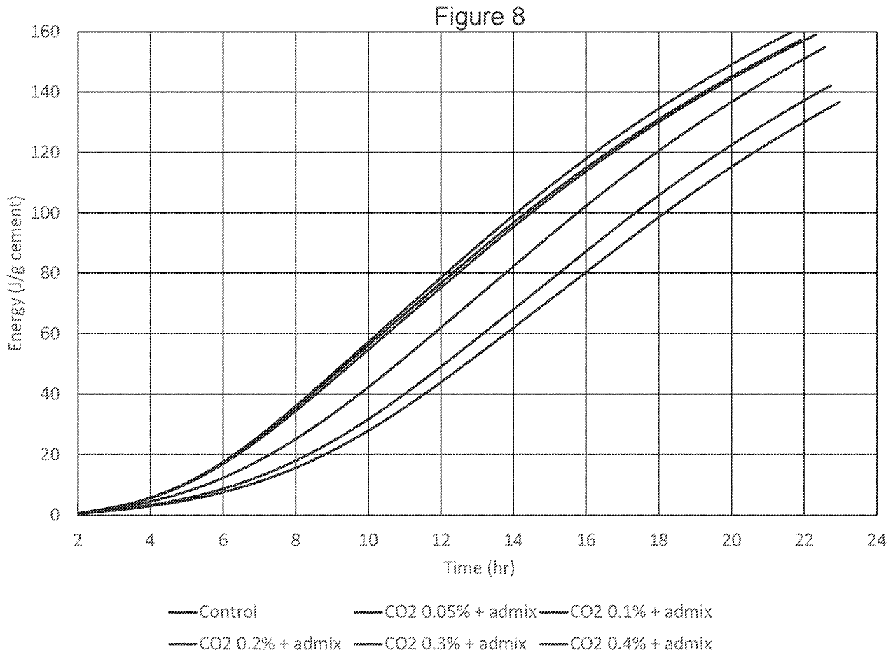

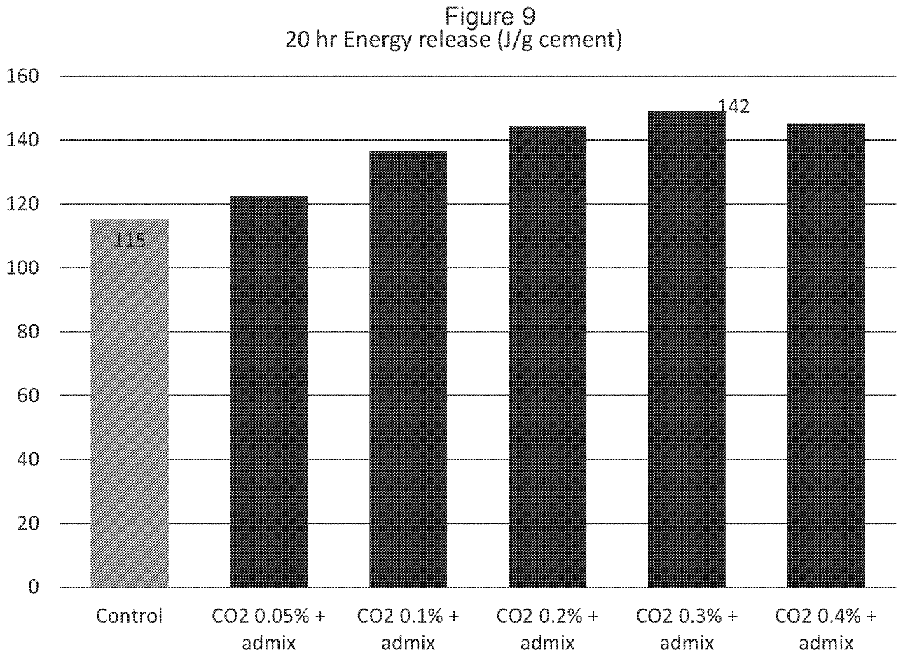

FIGS. 7-9 show power curve, energy curves, and plot of energy at 20 hours vs the CO2 dose, respectively. Reactivity score using the 20 hr data=7

This Example demonstrates that a combination of carbon dioxide and admixture, in this case a sodium polyacrylate dispersant, leads to greater energy release (assumed to be proportional to, e.g., compressive strength to be achieved) at all doses of carbon dioxide, reaching a plateau at doses of 0.2% carbon dioxide and above.

### Example 5

In this Example, the same cement as in Example 3 was used, with various CO2 doses, and an admixture (PAANa, sodium polyacrylate), a dispersant, at 0.16%.

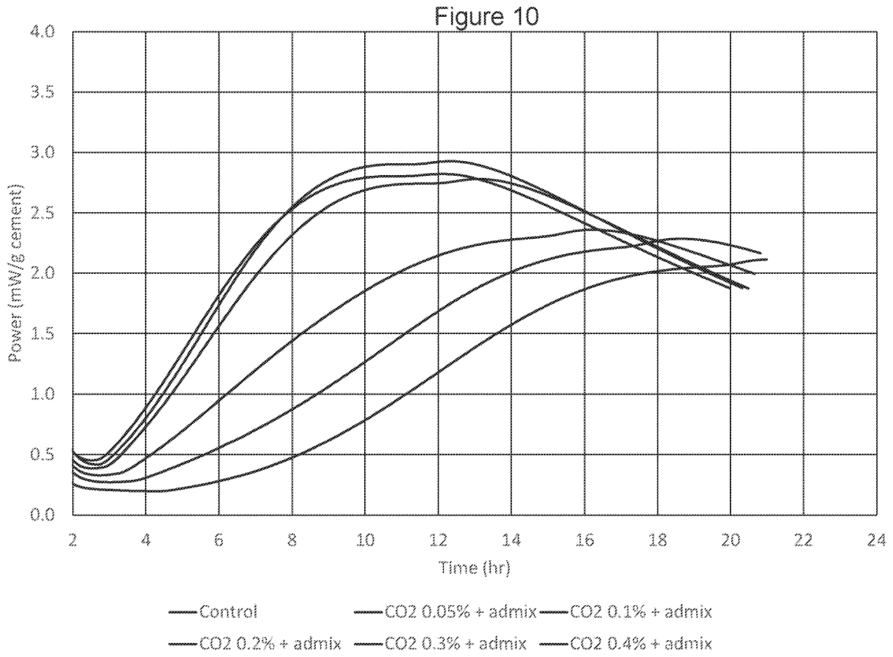

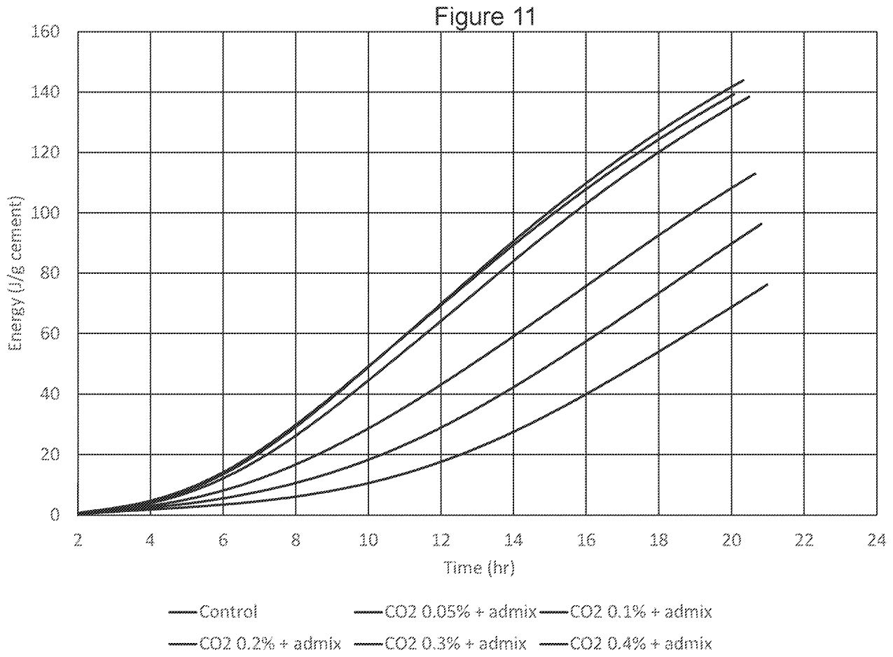

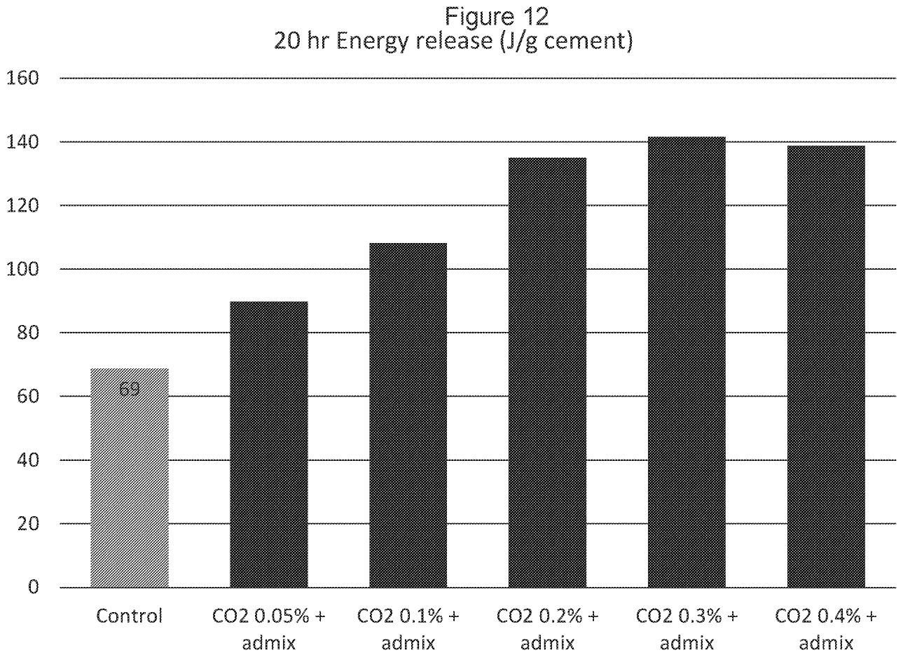

FIGS. 10-12 show power curves, energy curves, and plot of energy at 20 hours vs the CO2 dose, respectively. Reactivity score using the 20 hr data=176

This Example demonstrates that a combination of carbon dioxide and admixture, in this case a sodium polyacrylate dispersant at higher dose than the previous Example, leads to even greater energy release (assumed to be proportional to, e.g., compressive strength to be achieved) at all doses of carbon dioxide, compared to control, with a peak over 100% greater than control at 0.3% carbon dioxide.

### Example 6

In this Example, the same cement as in Example 3 was used, with various CO2 doses, and an admixture, GCP Zyla 610, a polycarboxylate Ether (PCE) based water reducer, at 0.2%.

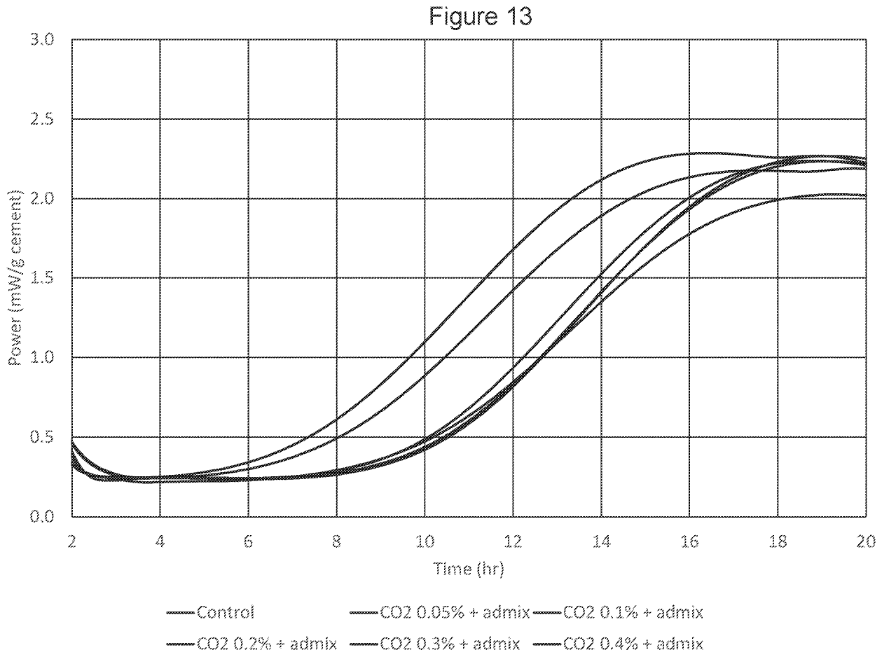

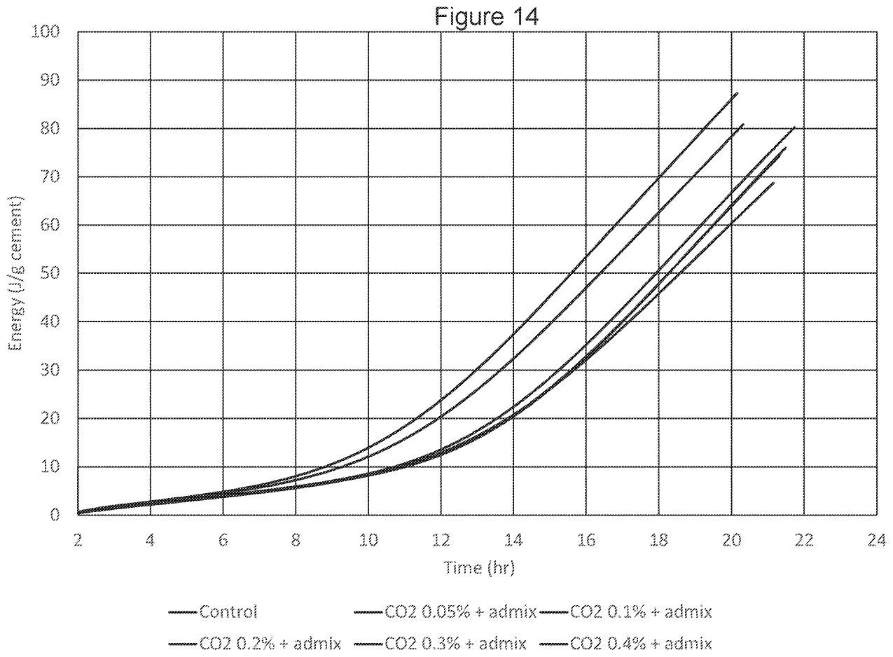

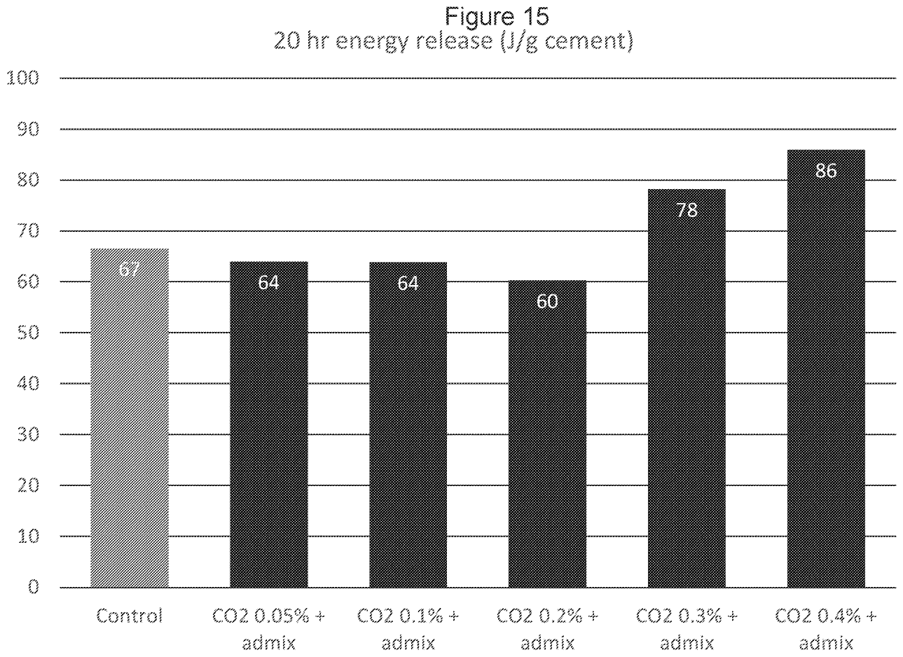

FIGS. 13-15 show power curves, energy curves, and plot of energy at 20 hours vs the CO2 dose, respectively. Reactivity score using the 20 hr data=52

This Example demonstrates that a combination of carbon dioxide and admixture, in this case a PCE based water producer, requires a higher dose of carbon dioxide, 0.3 or 0.4%, to reach greater energy release, compared to control.

### Example 7

In this Example, the same cement as in Example 3 was used, with various CO2 doses, and an admixture, GCP Zyla 610, a polycarboxylate Ether (PCE) based water reducer, at 0.8%.

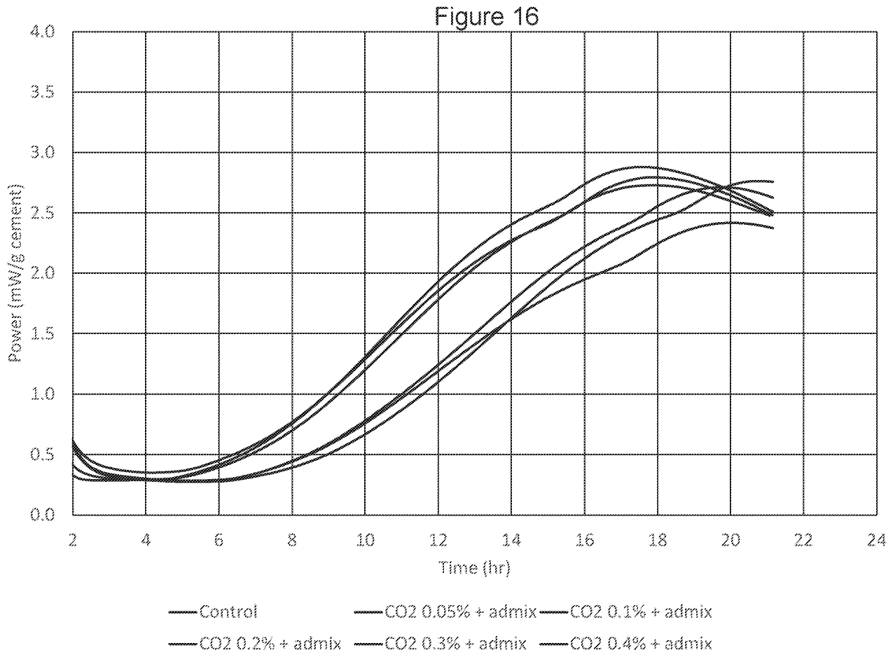

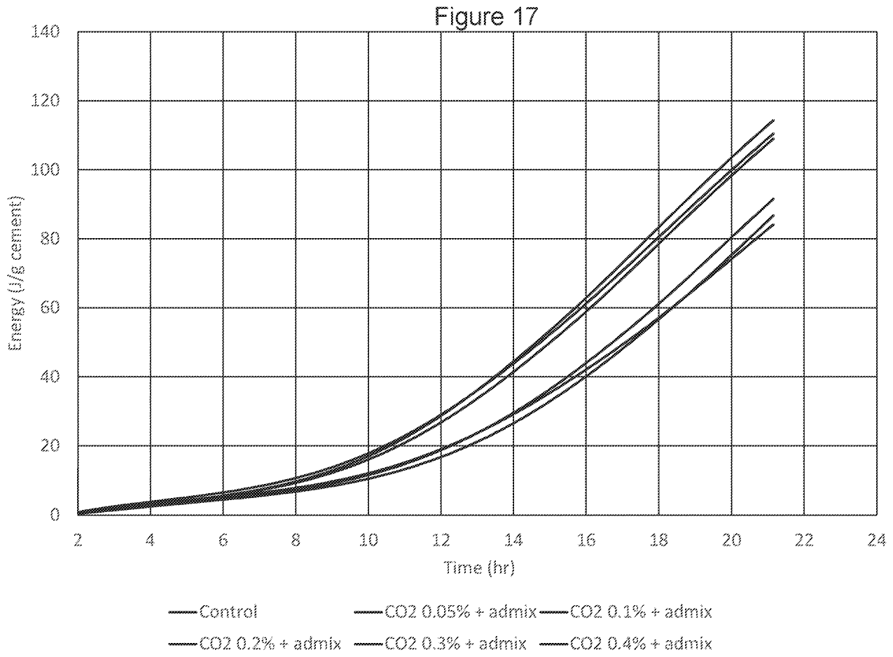

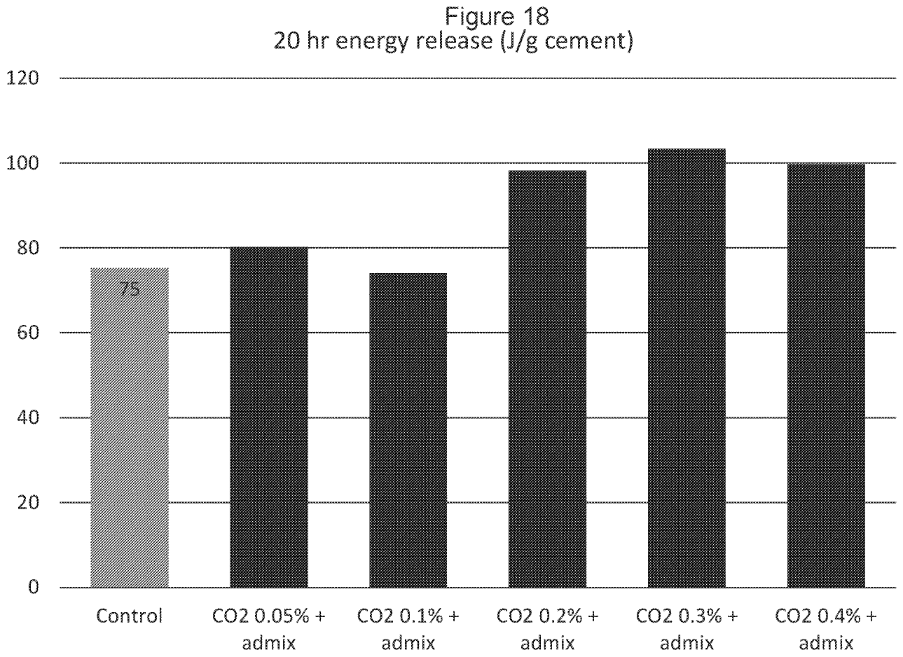

FIGS. 16-18 show power curves, energy curves, and plot of energy at 20 hours vs the CO2 dose, respectively. Reactivity score using the 20 hr data=76.

This Example demonstrates that a combination of carbon dioxide and admixture, in this case a PCE based water producer at a higher dose than the previous Example, allows similar energy release to control at lower doses (0.05 and 0.1%) and greater energy release at higher doses, 0.2, 0.3 and 0.4%.

### Example 8

In this example, National Lebec Type IL cement was used, with various CO2 doses and no admixture.

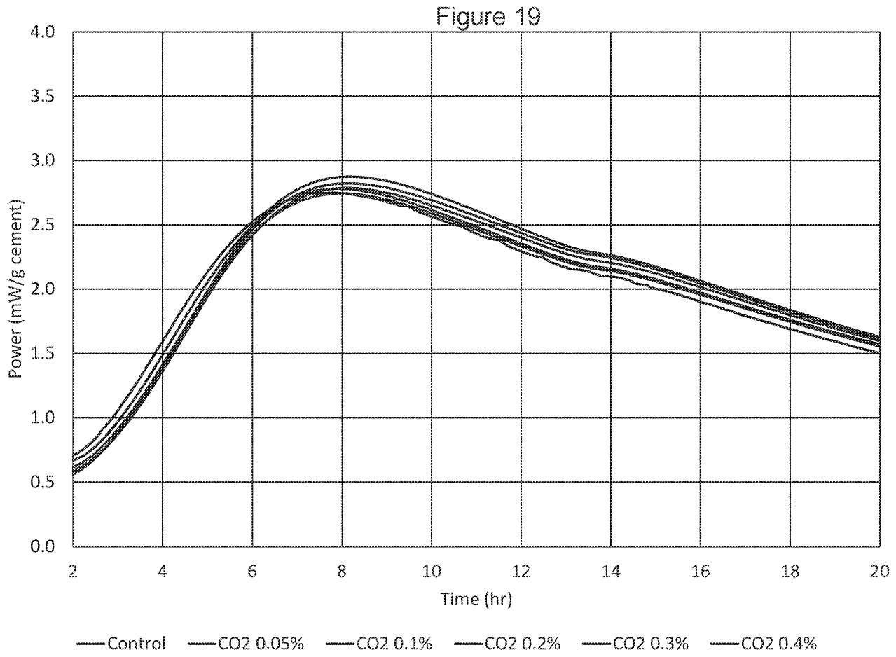

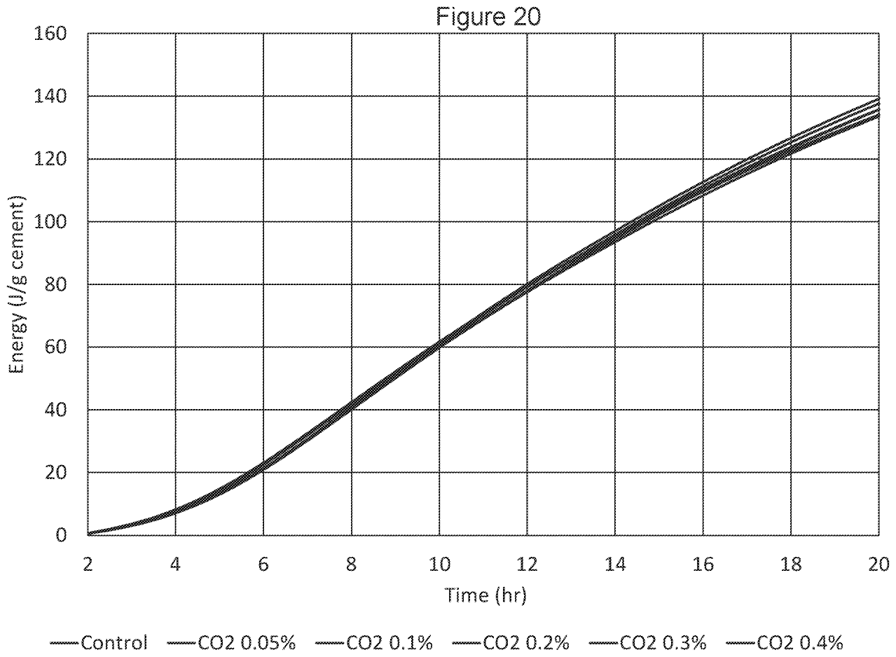

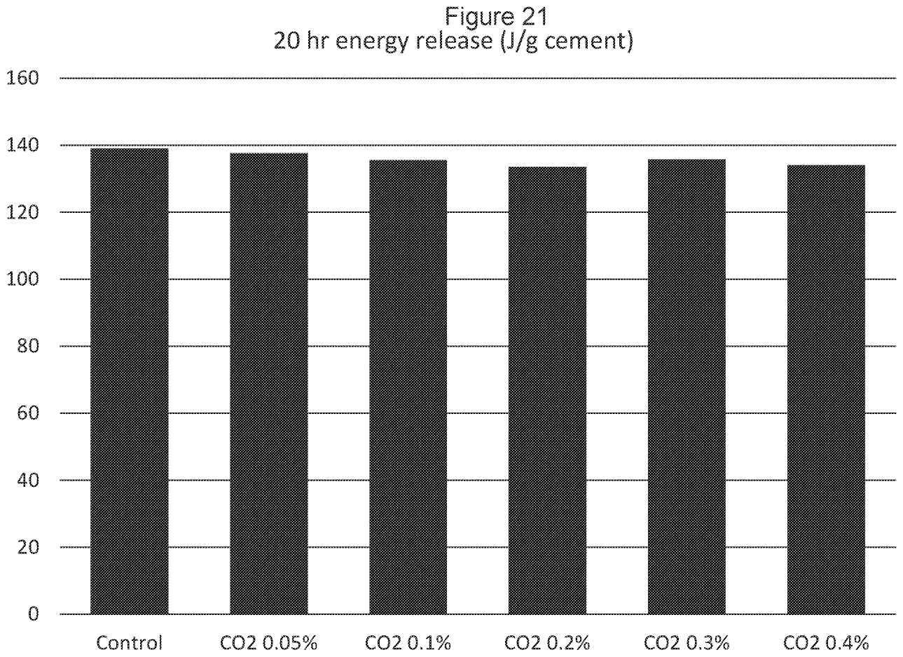

FIGS. 19-21 show power curves, energy curves, and plot of energy at 20 hours vs the CO2 dose, respectively. Reactivity score using the 20 hr data=−10.

This Example demonstrates a type of cement that is unresponsive to carbon dioxide alone at all doses, or slightly less energy release than control.

### Example 9

In this Example, the same cement as in Example 8 was used, with various CO2 doses, and an admixture, 0.385% Euclid Plastol 6400, a polycarboxylate Ether (PCE) based high range water reducer.

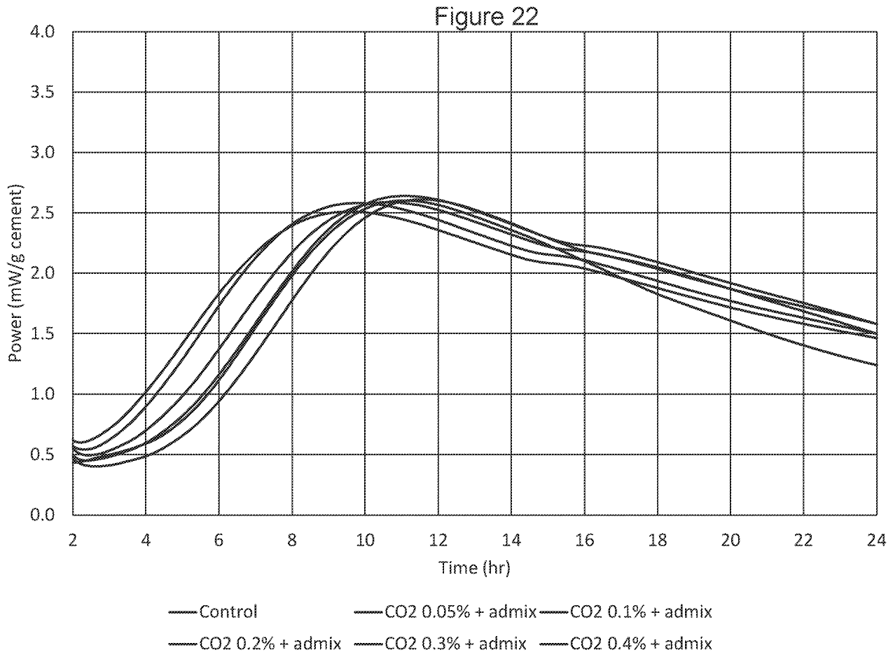

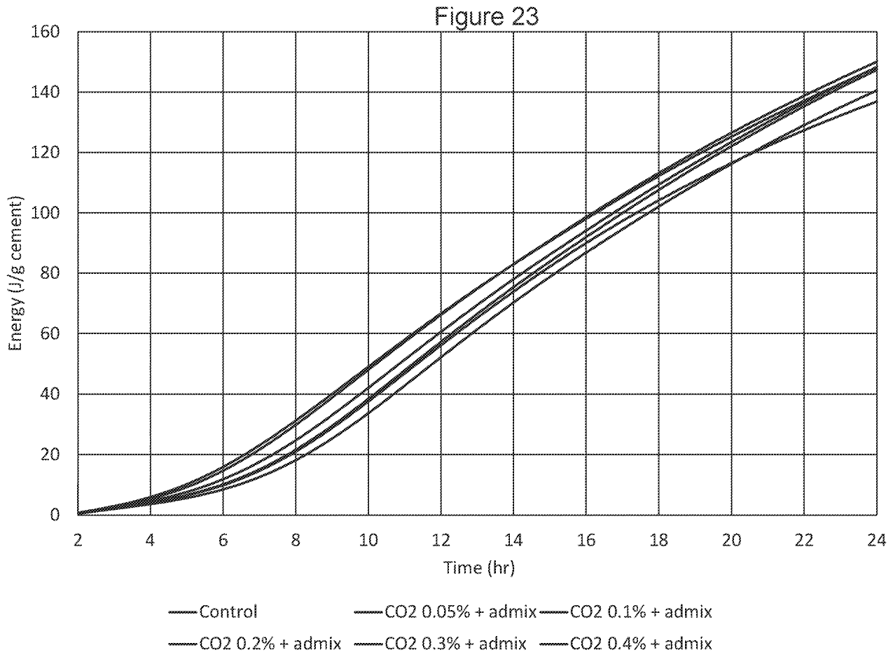

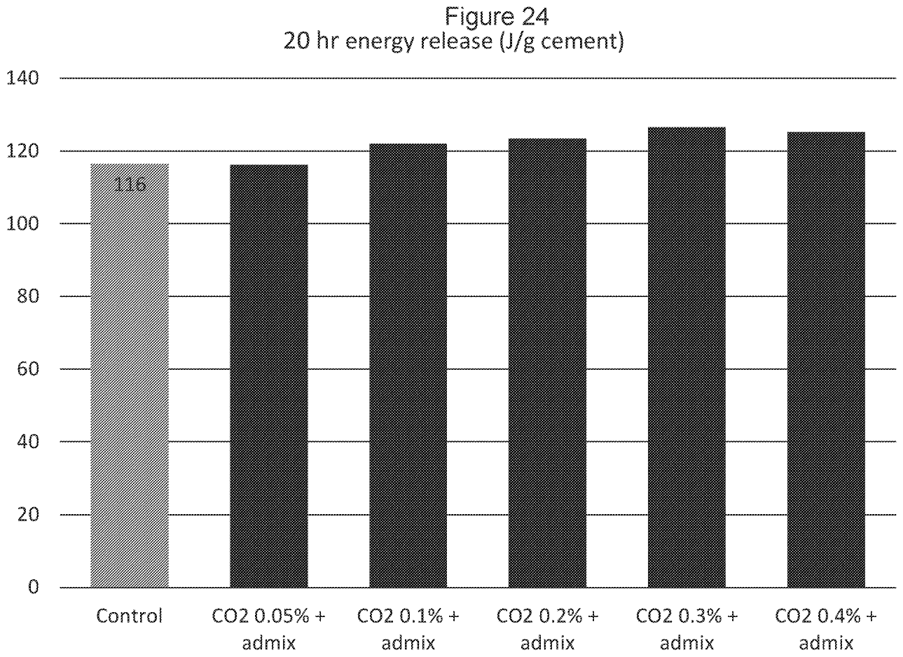

FIGS. 22-24 show power curves, energy curves, and plot of energy at 20 hours vs the CO2 dose, respectively. Reactivity score using the 20 hr data=25.

This Example demonstrates that a combination of carbon dioxide and admixture, in this case a PCE based high range water reducer, allows similar energy release to control at lowest doses (0.05%) and greater energy release at higher doses, 0.1, 0.2, 0.3 and 0.4%.

### Example 10

In this Example, the same cement as in Example 8 was used, with various CO2 doses, and an admixture, 0.385% Euclid Plastol 6400, a polycarboxylate Ether (PCE) based high range water reducer.

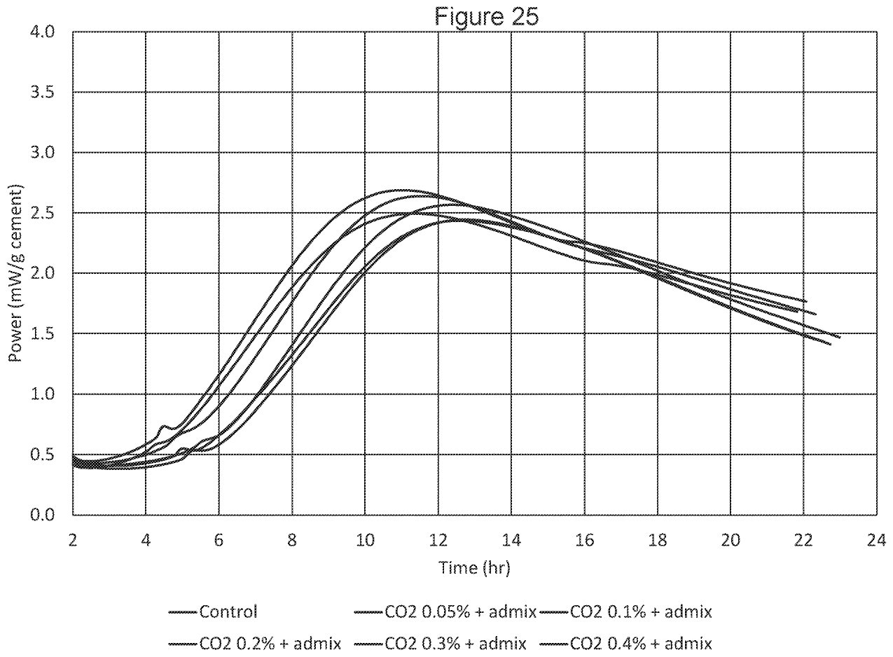

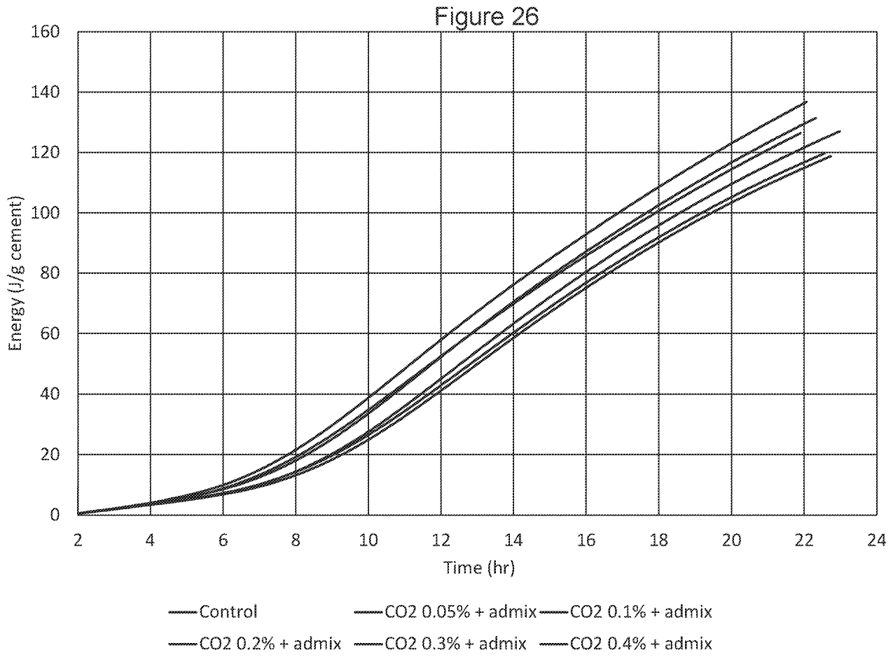

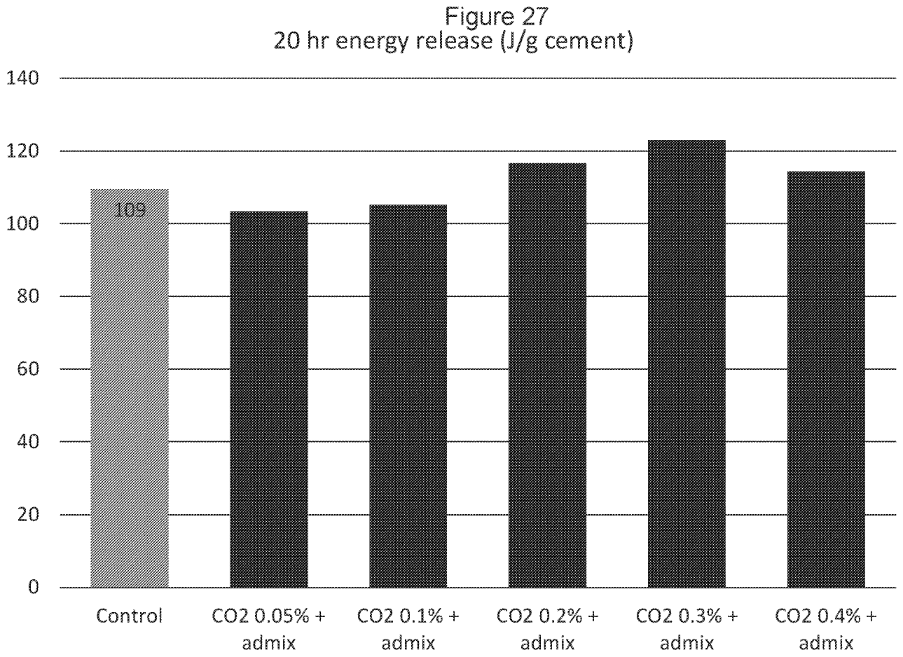

FIGS. 25-27 show power curves, energy curves, and plot of energy at 20 hours vs the CO2 dose, respectively. Reactivity score using the 20 hr data=34

This Example demonstrates, similar to the previous Example, that a combination of carbon dioxide and admixture, in this case a PCE based high range water reducer, allows similar energy release to control at lowest doses (0.05 and 1%) and greater energy release at higher doses, 0.2, 0.3 and 0.4%.

### Example 10A

In this example, Monarch cement was used, with various CO2 doses and no admixture. The Monarch cement in the absence of an admixture was assessed to have a reactivity of 58 (data not shown).

### Example 11

In this Example, the same cement as in Example 8 was used, with various CO2 doses, and an admixture, 0.37% Sika Plastocrete 161, a lignin polymer-based water reducer.

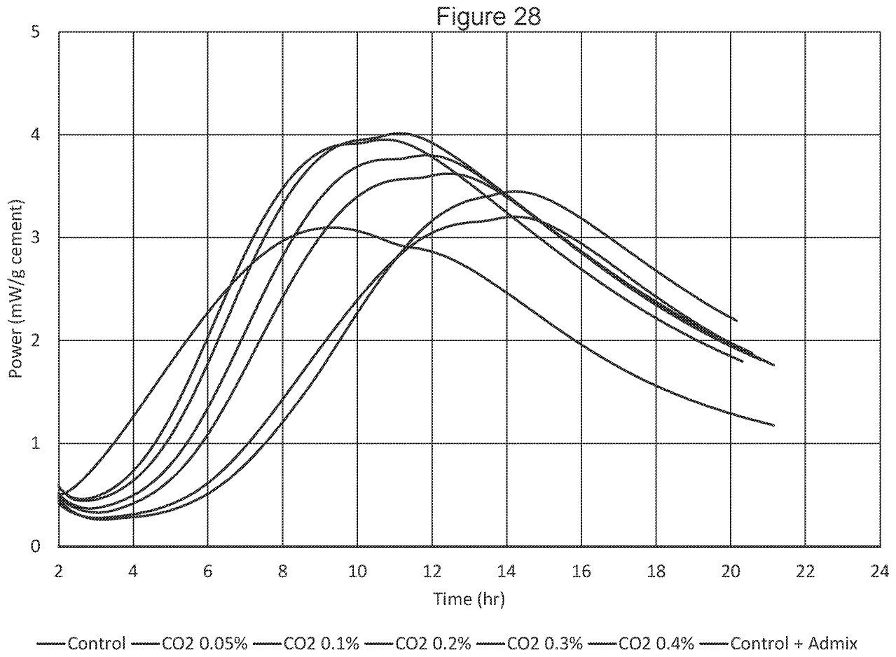

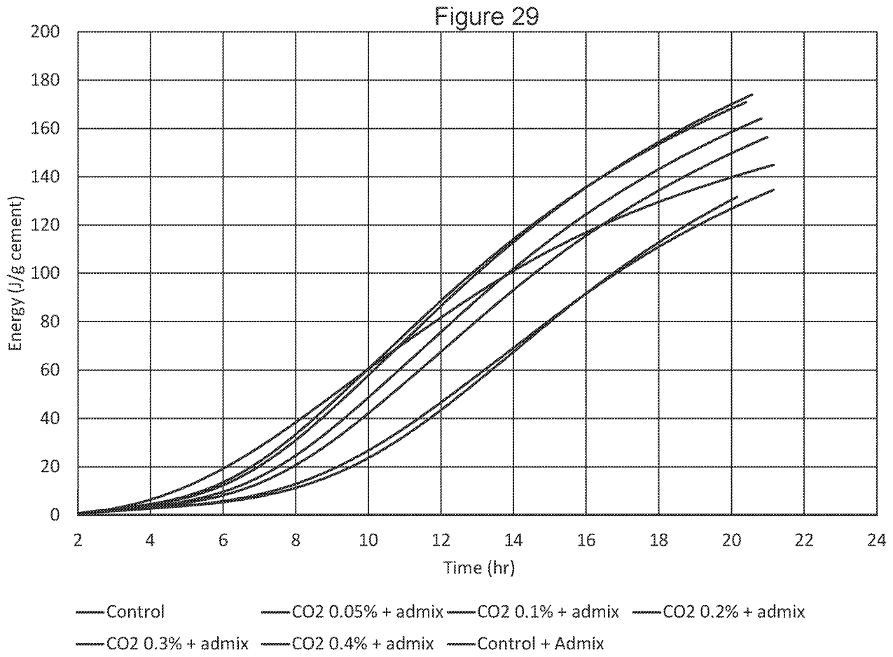

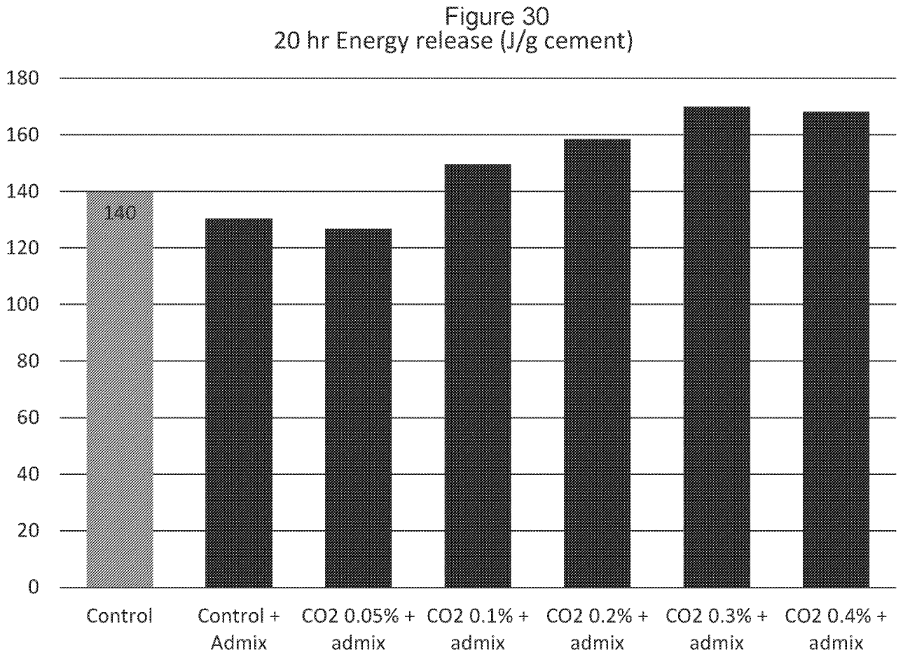

FIGS. 28-30 show power curves, energy curves, and plot of energy at 20 hours vs the CO2 dose, respectively. Reactivity score using the 20 hr data=34.

This Example demonstrates that a combination of carbon dioxide and admixture, in this case a lignin polymer based water reducer, still has lower energy release than control at lowest doses (0.05 and 1%), but greater energy release at higher doses, 0.2, 0.3 and 0.4%.

### Example 12

In this Example, the same cement as in Example 8 was used, with various CO2 doses, and an admixture, 0.59% MasterPolyheed 997, a lignosulfonate triethanolamine based medium-range water reducer.

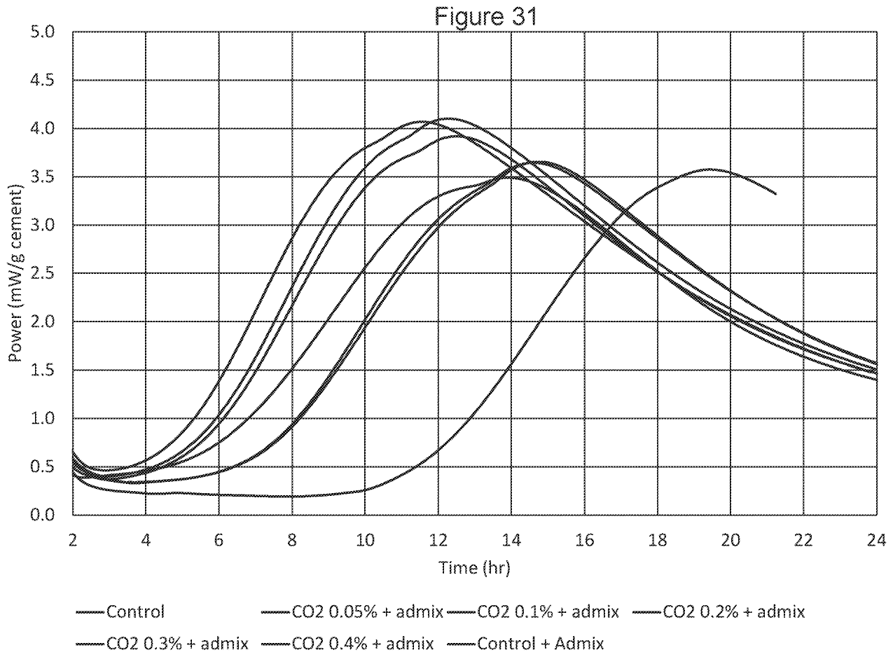

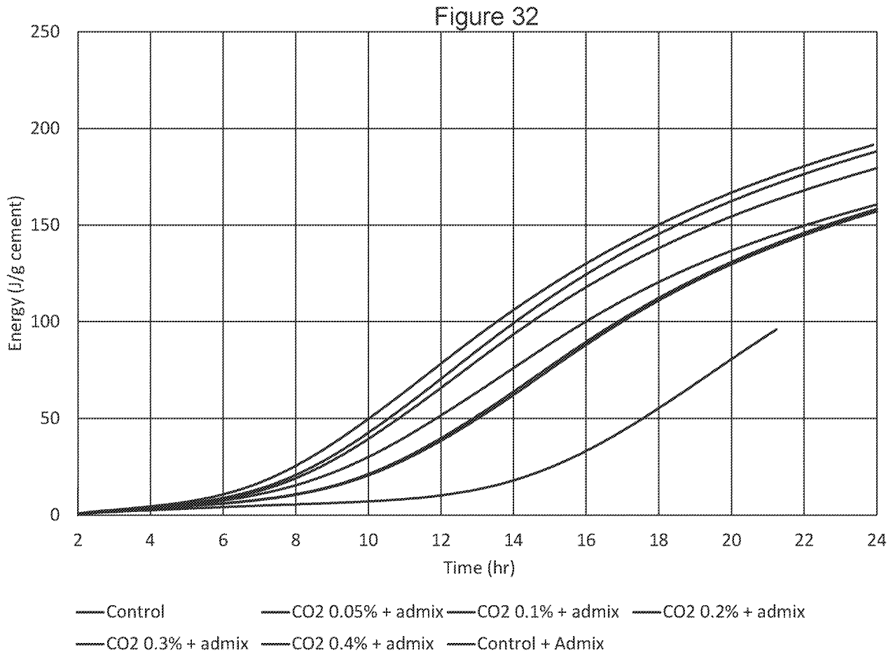

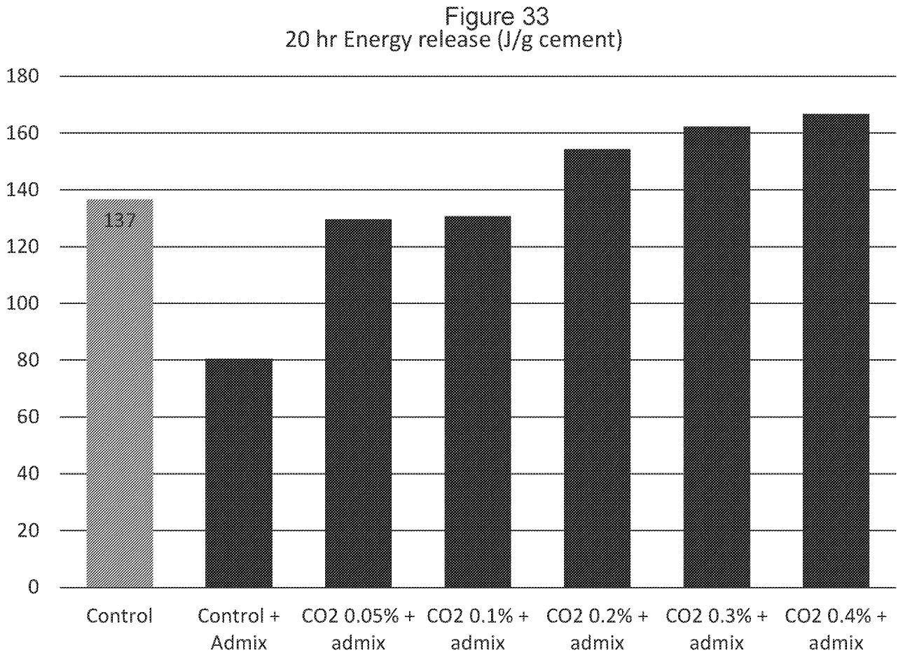

FIGS. 31-33 show power curves, energy curves, and plot of energy at 20 hours vs the CO2 dose, respectively. Reactivity score using the 20 hr data=182.

This Example demonstrates that use of admixture alone produces an energy release less than ⅔ control, but a combination of carbon dioxide and admixture, in this case a lignosulfonate triethanolamine based medium-range water reducer, achieves energy release close to control at lowest doses (0.05 and 1%), and greater energy release at higher doses, 0.2, 0.3 and 0.4%. This Example demonstrates a synergistic effect of admixture and carbon dioxide, where carbon dioxide alone does not produce an increase in energy release (see Example 8), admixture alone causes a marked decrease in energy release, but admixture and carbon dioxide together cause, at higher doses of carbon dioxide, a marked increase in energy release.

### Example 13

In this Example, the effect of admixture alone, and admixture in combination with carbon dioxide, on setting time was explored.

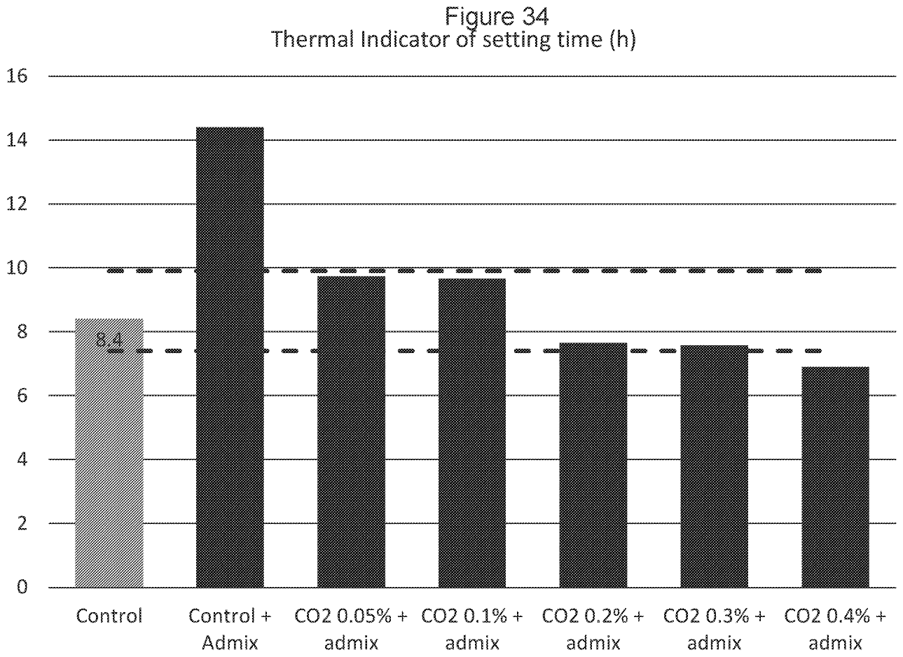

Results are shown in FIG. 34—The thermal indicator of setting time. This is defined as the hydration time to reach a thermal power of 50% of the maximum value of the main hydration peak in ASTM C1679 Standard Practice for Measuring Hydration Kinetics of Hydraulic Cementitious Mixtures Using Isothermal calorimetry. The use of the water reducer caused a retardation. The addition of CO2 brought it back within the requirements of setting time (no more that 30 minutes earlier or 60 minutes later than the reference).

This Example demonstrates that, for an admixture which produces an undesirable increase in setting time, addition carbon dioxide can bring the setting time back to allowable limits.

### Example 14

In this Example, the same cement as in Example 8 was used, with various CO2 doses, and an admixture, 0.39% Euclid Eucon WR, a lignosulphate based water reducer.

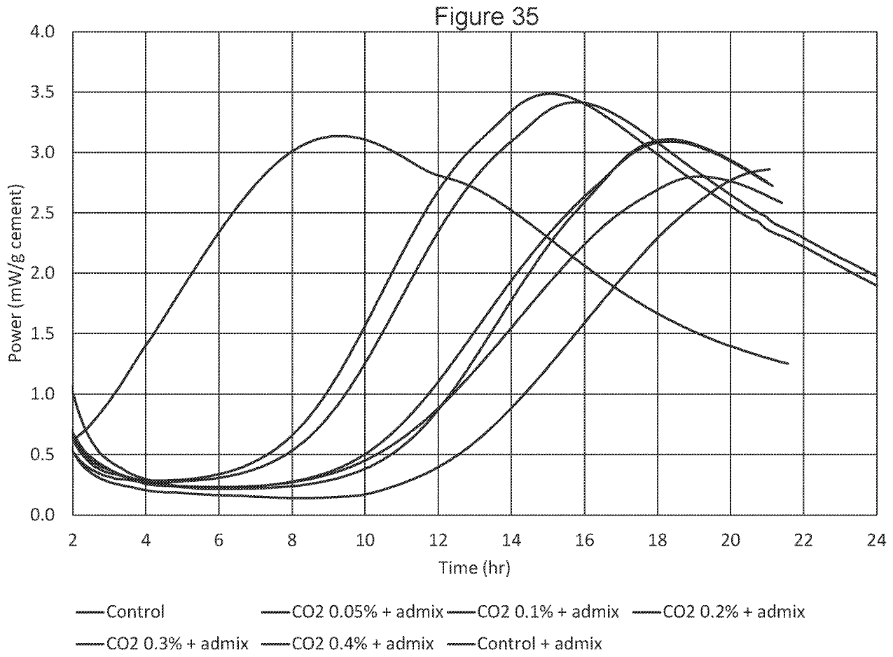

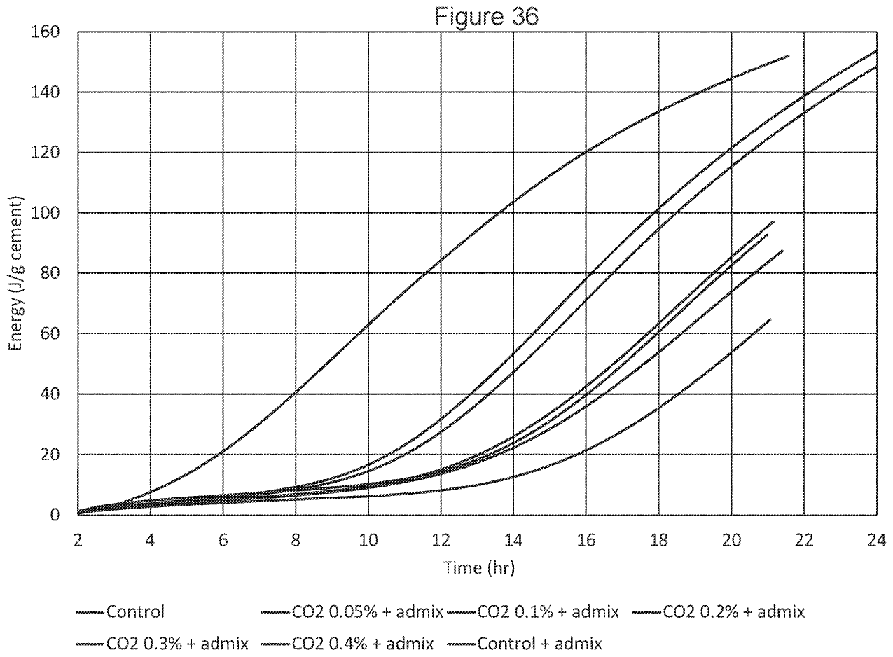

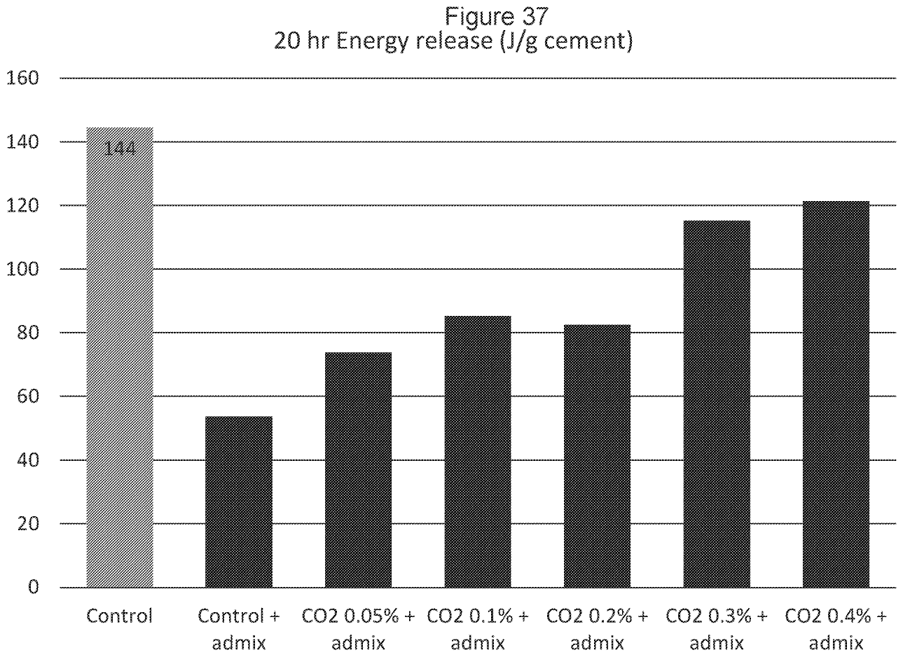

FIGS. 34-37 show power curves, energy curves, and plot of energy at 20 hours vs the CO2 dose, respectively. Reactivity score using the 20 hr data=158.

This Example demonstrates that use of admixture alone produces an energy release less than ½ control, but a combination of carbon dioxide and admixture, in this case a lignosulfonate based water reducer, achieves greater energy release, though it does not reach control even at highest dose carbon dioxide used. This Example demonstrates a synergistic effect of admixture and carbon dioxide, where carbon dioxide alone does not produce an increase in energy release (see Example 8), admixture alone causes a marked decrease in energy release, but admixture and carbon dioxide together cause, at higher doses of carbon dioxide, a marked increase in energy release.

### Example 15

In this Example, the same cement as in Example 8 was used, with various CO2 doses, and an admixture, 0.29% MasterGlenium3030, a polycarboxylate Ether (PCE) based high range water reducer

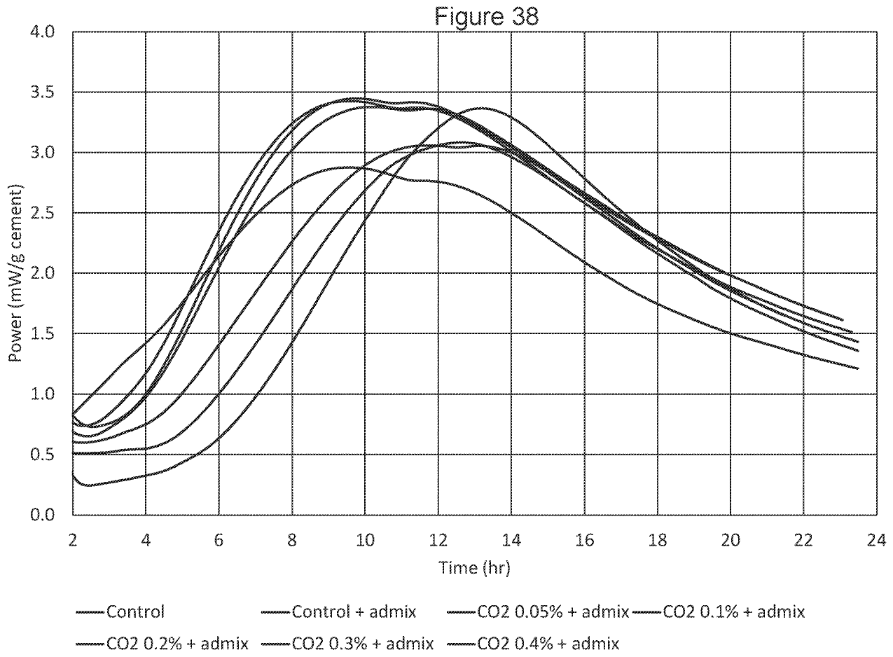

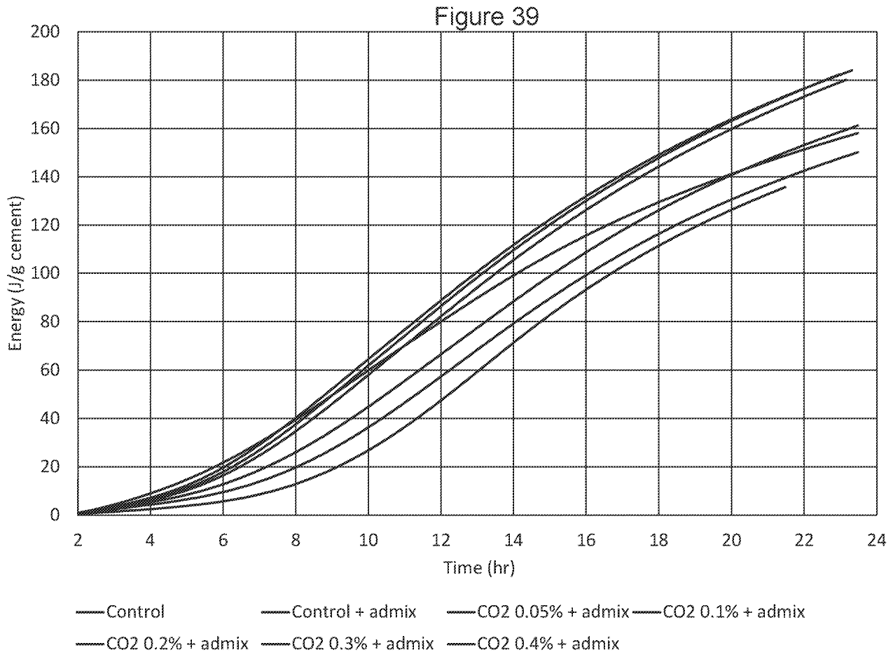

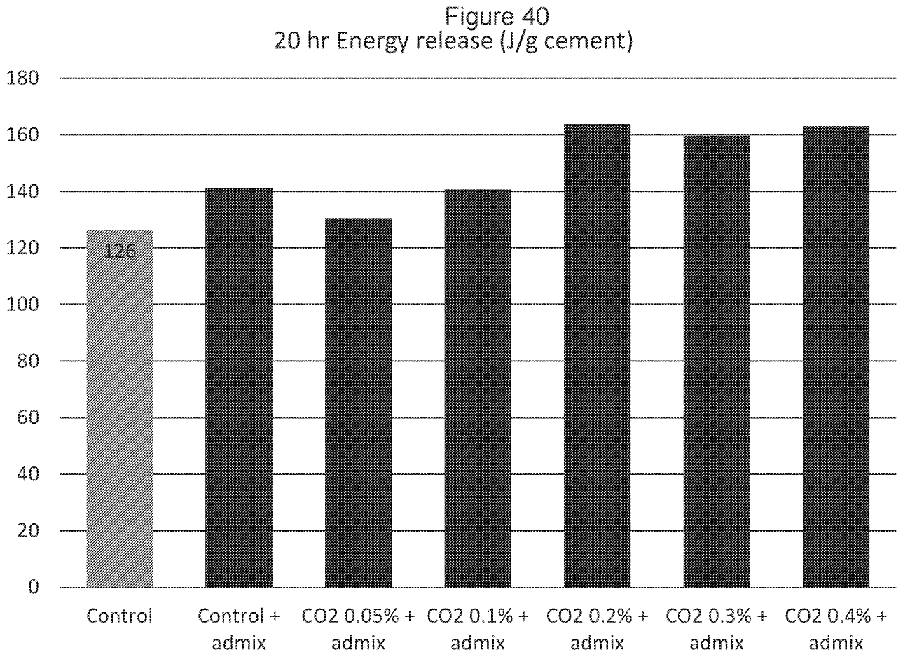

FIGS. 38-40 show power curves, energy curves, and plot of energy at 20 hours vs the CO2 dose, respectively. Reactivity score using the 20 hr data=77.

In this Example, admixture alone produced better results than no admixture, but admixture together with carbon dioxide produced even better results at doses of 0.2% and above.

### Example 16

In this Example, the same cement as in Example 8 was used, with various CO2 doses, and an admixture, 0.49% Sika Viscocrete 1000, a polycarboxylate Ether (PCE) based high range water reducer.

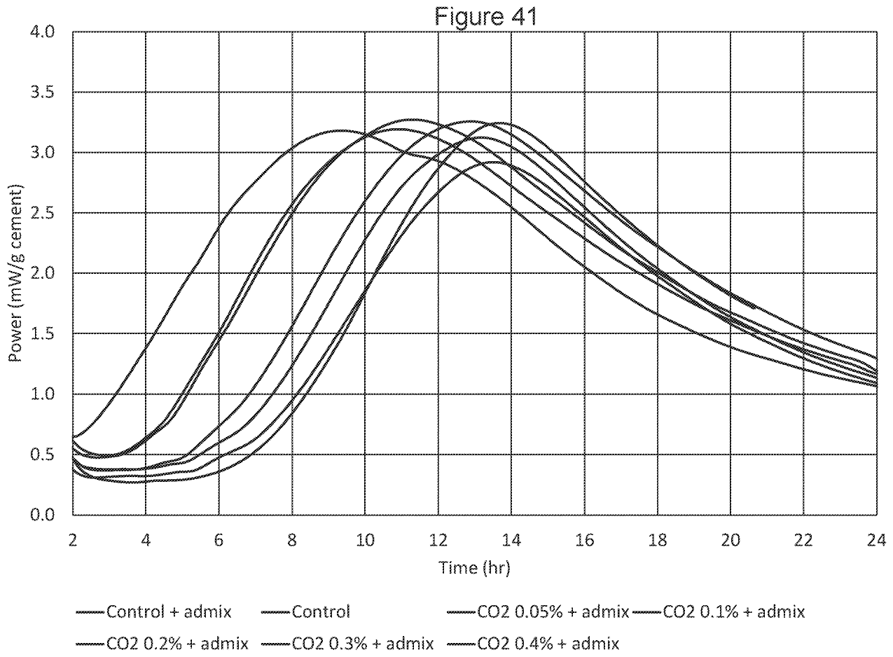

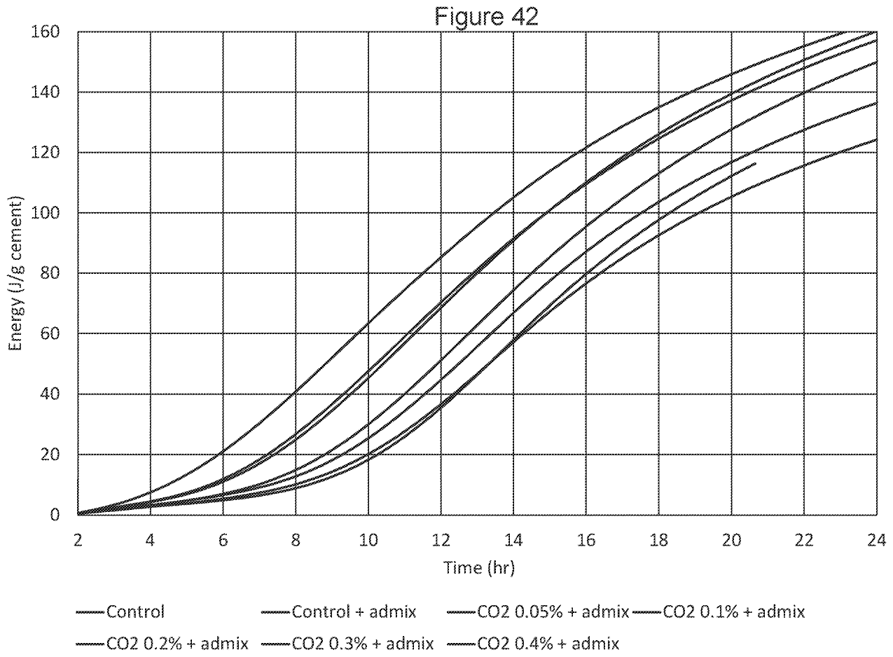

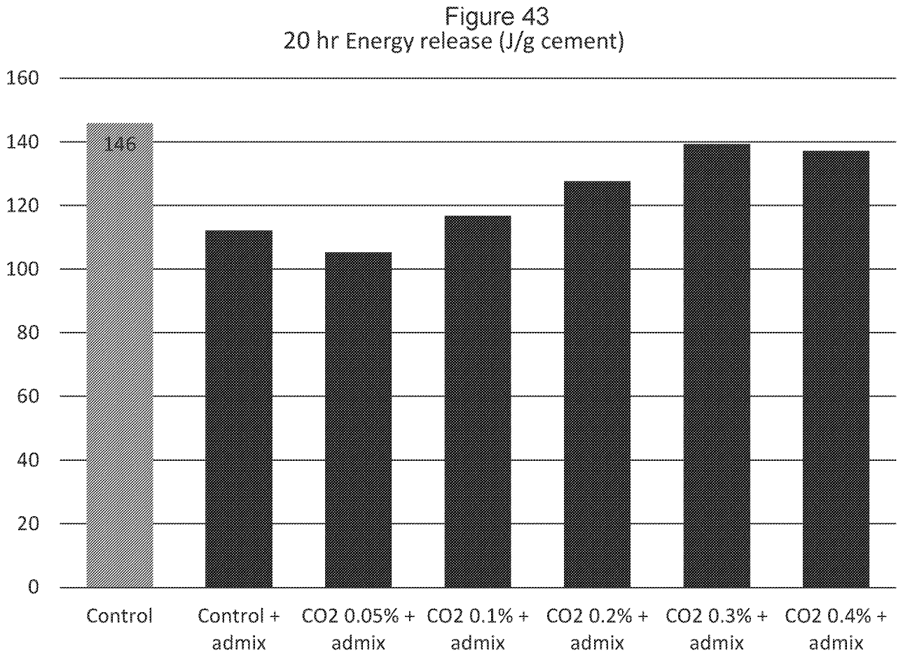

FIGS. 41-43 show power curves, energy curves, and plot of energy at 20 hours vs the CO2 dose, respectively. Reactivity score using the 20 hr data=84.

This Example demonstrates that use of admixture alone produces an energy release less than control, but a combination of carbon dioxide and admixture, in this case a polycarboxylate Ether (PCE) based high range water reducer, achieves greater energy release, though it does not reach control even at highest dose carbon dioxide used.

### Example 17

In this Example, the effect of admixture alone, and admixture in combination with carbon dioxide, on setting time was explored.

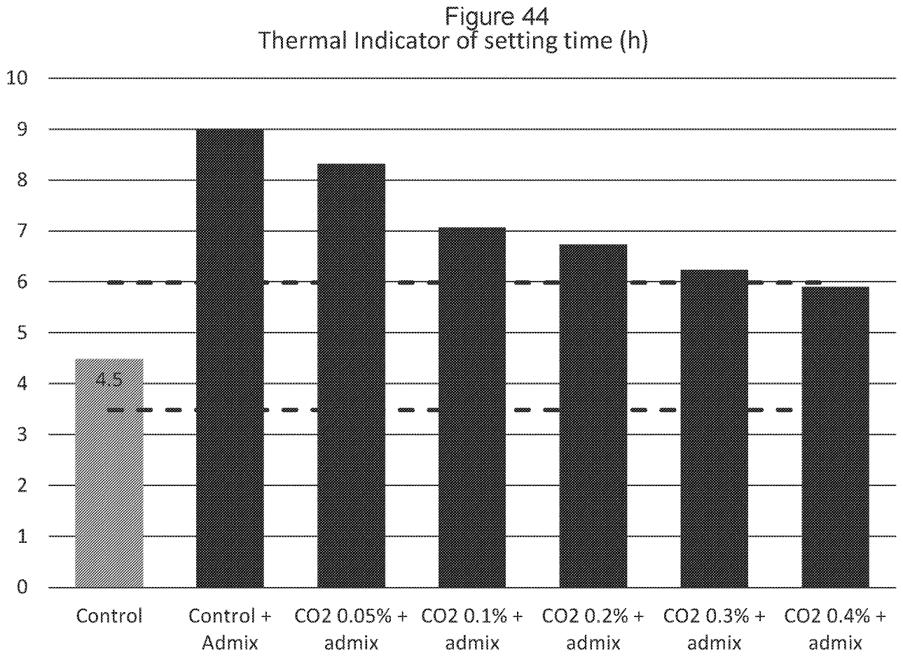

Results are shown in FIG. 44—The thermal indicator of setting time. This is defined as the hydration time to reach a thermal power of 50% of the maximum value of the main hydration peak in ASTM C1679 Standard Practice for Measuring Hydration Kinetics of Hydraulic Cementitious Mixtures Using Isothermal calorimetry. The use of the water reducer caused a retardation. The addition of CO2 brought it back within the requirements of setting time (no more that 30 minutes earlier or 60 minutes later than the reference).

This Example demonstrates that, for an admixture which produces an undesirable increase in setting time, addition carbon dioxide can bring the setting time back to allowable limits. In this Example, a higher dose of carbon dioxide was required to bring setting time into allowable limits.

### Example 18

In this Example, the same cement as in Example 8 was used, with various CO2 doses, and an admixture, 0.26% GCP Zyla 640, a polycarboxylate Ether (PCE) based water reducer

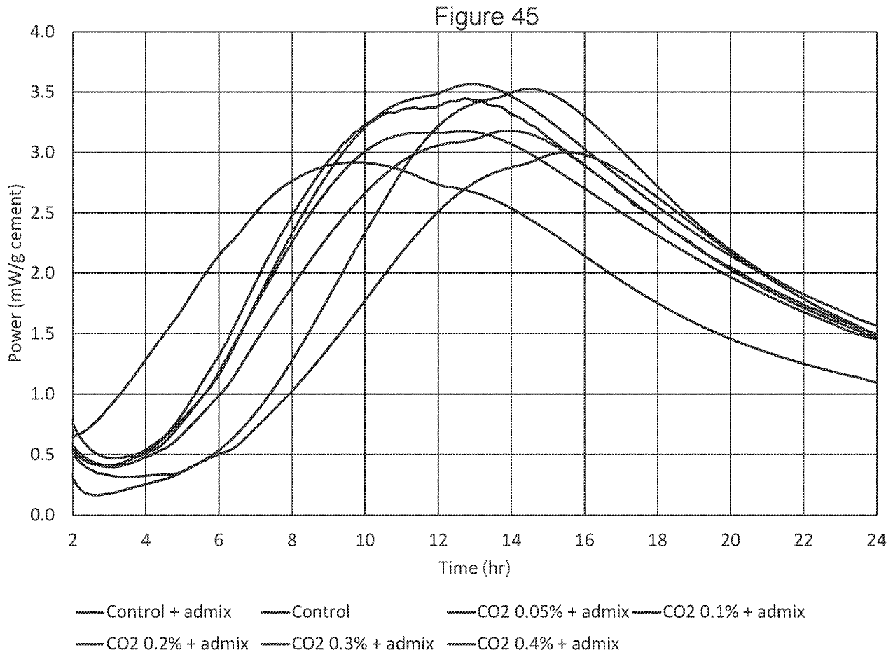

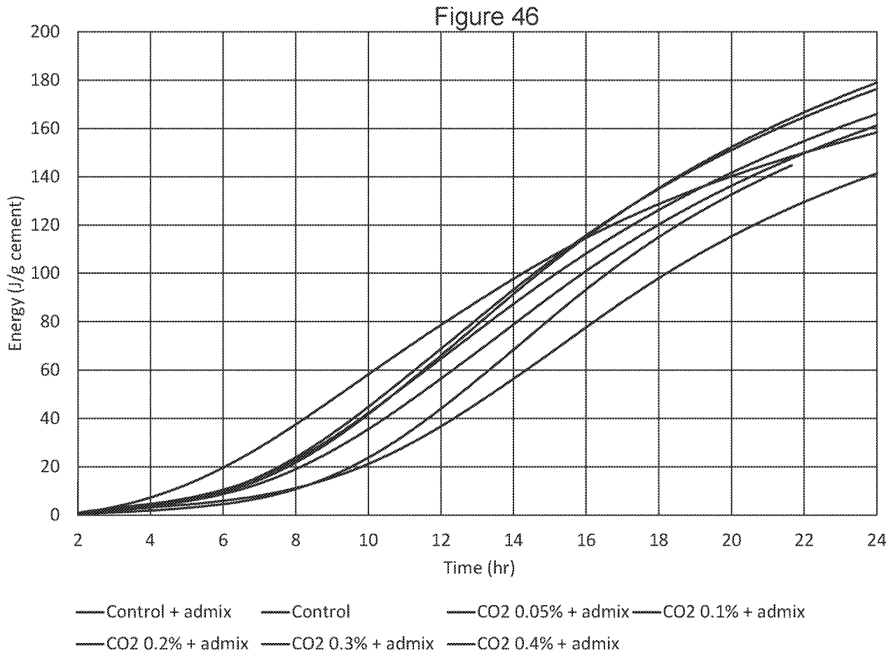

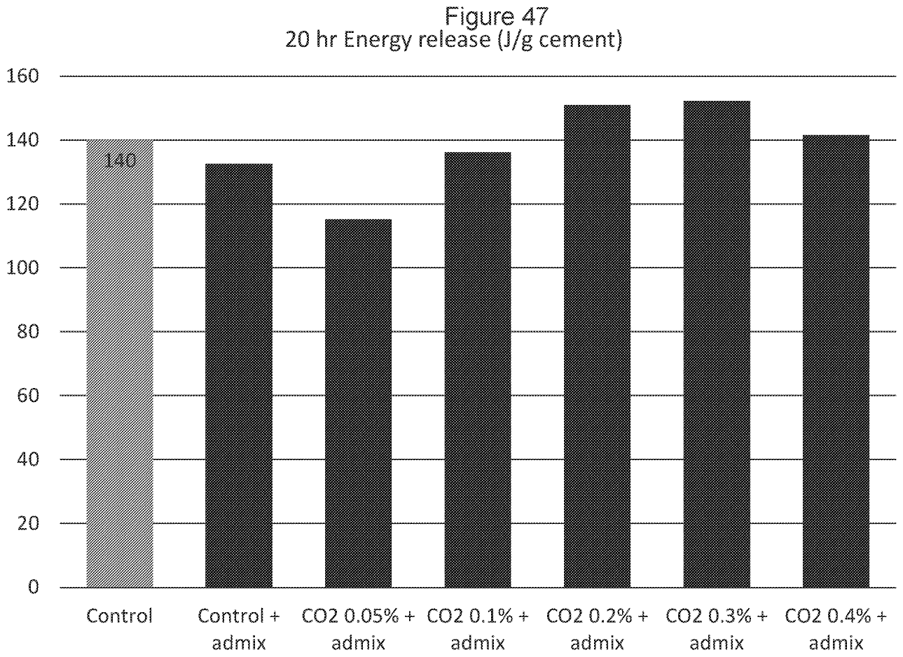

FIGS. 45-47 show power curves, energy curves, and plot of energy at 20 hours vs the CO2 dose, respectively. Reactivity score using the 20 hr data=58.

This Example demonstrates that use of admixture alone produces an energy release less than control, and combination of low dose carbon dioxide and admixture, in this case a polycarboxylate Ether (PCE) based water reducer, can achieves comparable or greater energy release, but the effect is dose-dependent.

### Example 19

In this Example, the same cement as in Example 8 was used, with various CO2 doses, and an admixture, 0.20% SikaControl Air 160, an air entraining admixture.

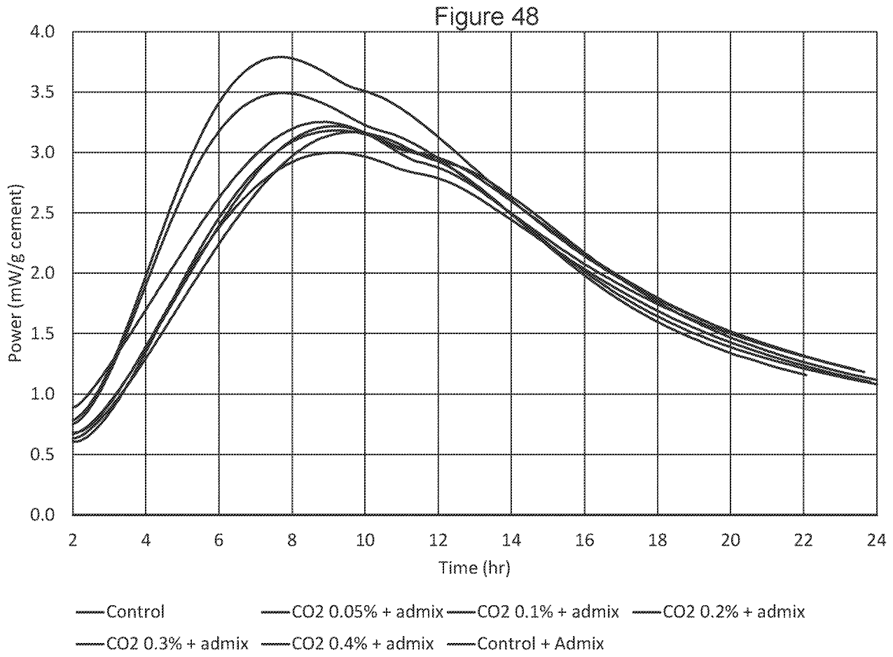

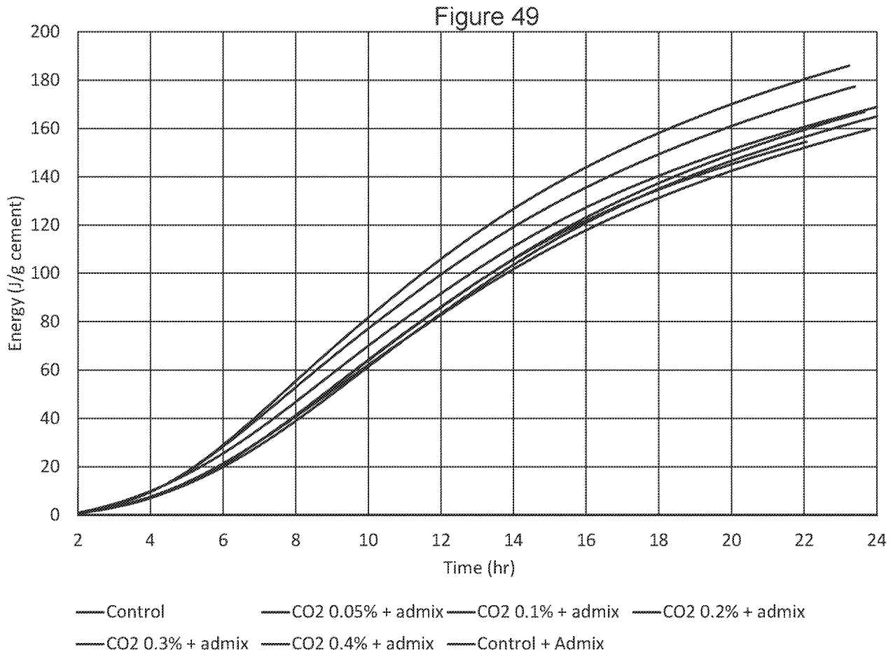

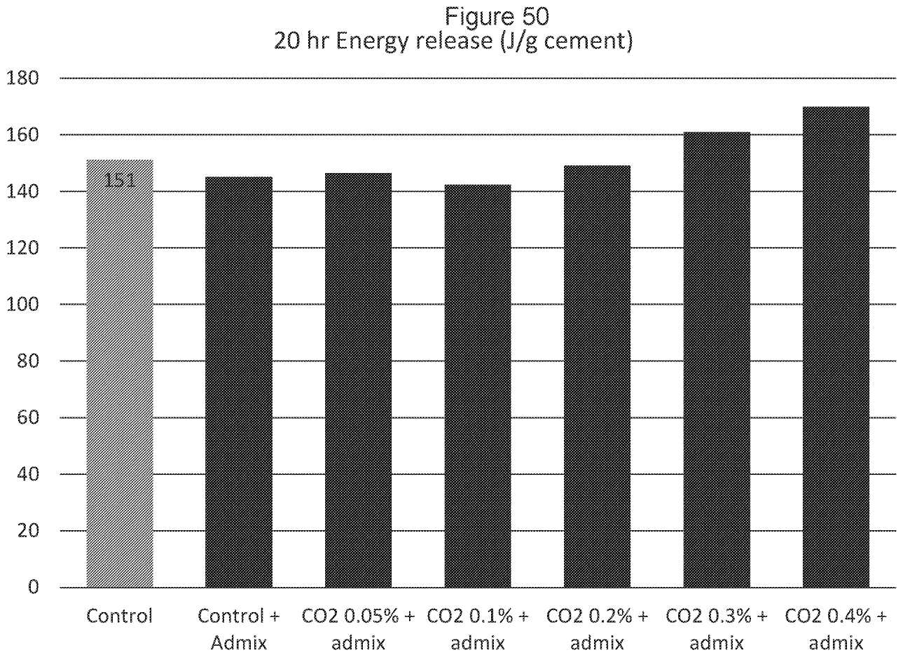

FIGS. 48-50 show power curves, energy curves, and plot of energy at 20 hours vs the CO2 dose, respectively. Reactivity score using the 20 hr data=65

This Example demonstrates that use of admixture alone produces an energy release less than control, and combination of low dose carbon dioxide and admixture, in this case an air entraining admixture, can achieves comparable or greater energy release, but the effect is dose-dependent.

### Example 20

In this Example, the effects of admixture with carbon dioxide on compressive strength at 7 and 28 days was explored.

### Case 1

Admix Mapei KB1200

7-day strength

$$Count - control = 10 , CO 2 = 10$$

$$Dose CO 2 - 0.2 \%$$

CO2 result is 1% lower than the control at 7 days

### Case

Admix Polychem 400NC

7 and 28-day strength

$$Count - control = 9 , CO 2 = 8$$

$$CO 2 Dose - 0.2 \%$$

CO2 result is 5% greater than the control at 7 days and +6% greater @ 28 days

### Admixture Chemistries

### Mapei KB 1200

Mid-range water reducing admixture

$$0 - 20 \% Sodium Nitrate$$

$$5 - 10 \% TEA$$

$$1 - 2.5 \% Sodium Thiocyanate$$

### Mapei Polychem 400 NC

Water reducing admixture

$$2.5 - 5 \% TEA$$

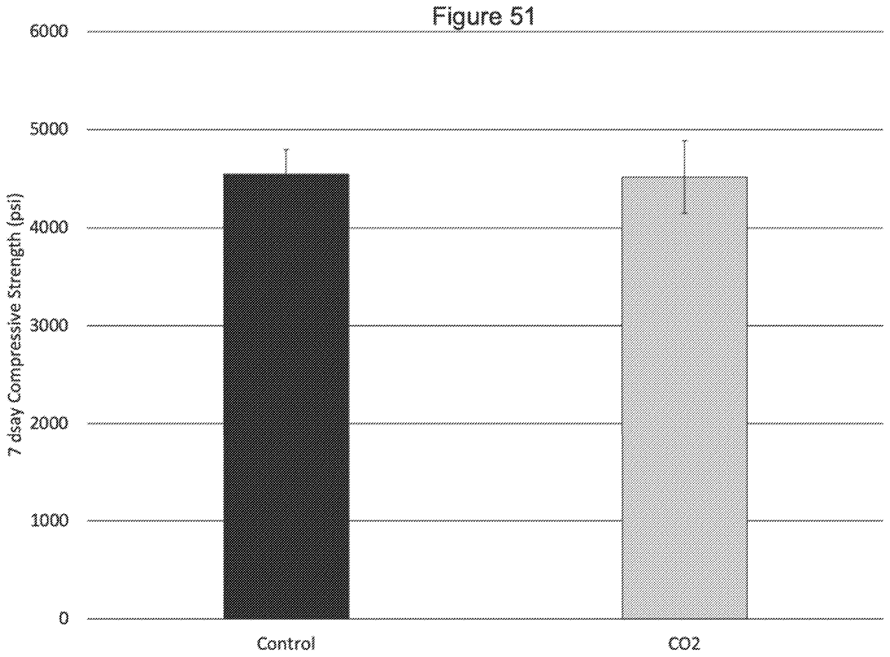

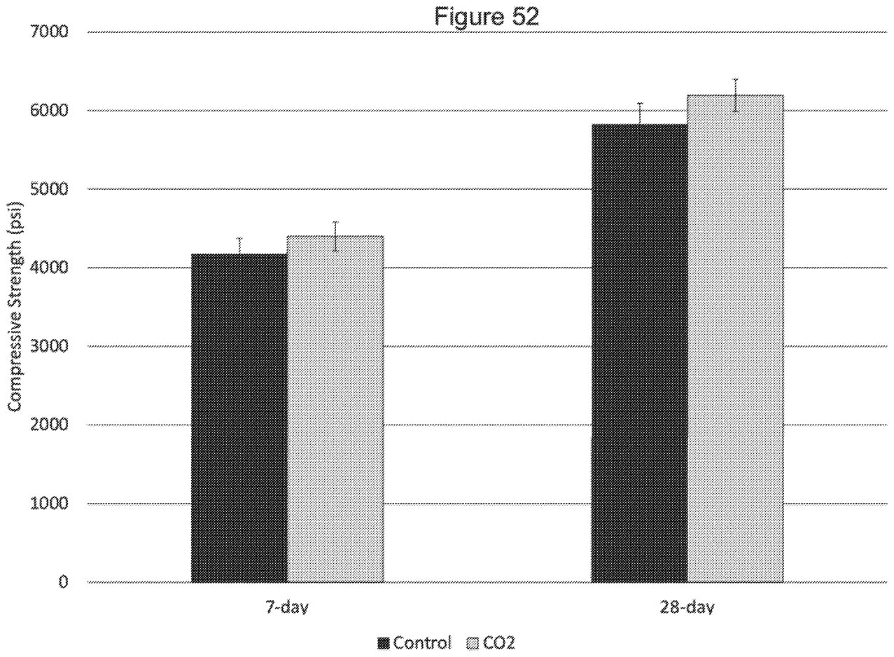

The results are shown in FIGS. 51 and 52.

This Example demonstrates that effects of carbon dioxide and admixture can be admixture-dependent. In this case, a mind-range water reducer with sodium nitrate (optional), TEA, and sodium thiocyanate, in combination with carbon dioxide, results in compressive strength, at least at 7 days, lower than control, while a water reducer containing just TEA, in combination with carbon dioxide, results in higher compressive strengths than control at both 7 and 28 days.

### Example 21

In this example, the effect of different water to cement ratios (0.6, 0.8, 1.0 and 1.2) and increasing doses of CO₂ (0.05, 0.1, 0.2, 0.3 and 0.4% by weight of cement) on the reactivity of the cement mix was explored. Samples were measured for 20 hours using isothermal calorimetry to determine the change in released heat due to the introduction of CO₂. An increase in heat could be correlated to an increase in hydration reaction which would be believed to create stronger concrete specimens, i.e., result in a higher compressive strength.

Cement, water, and water reducer were mixed in a vortex mixer for 2-minutes. Solid CO₂ was added at the desired amount and the batch was mixed for an additional 2-minutes. Reactivity to CO₂ was measured with the isothermal calorimetry. The produced energy curves from all CO₂ doses were then compared at 16 hours (see FIG. 51) to determine the cumulative energy at that point in time. These energy values were then plotted against the CO₂ dose added for the given sample (see FIG. 52) to produce an approximately linear relationship, with the slope of the best fit line going through these data points indicating reactivity. The higher the slope the more reactive the cement, conversely if the line is completely horizontal the cement would be seen as non-reactive.

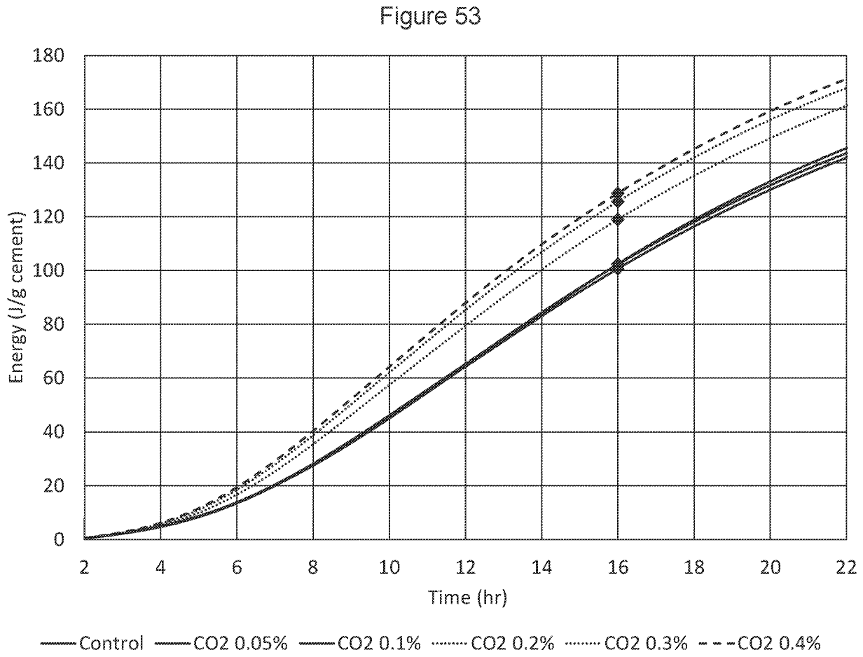

This Example demonstrates that there is a linear relationship between increasing water to cement ratio and increasing CO₂ reactivity (FIG. 53). Further, it shows that the more space available for the CO₂ reaction, the greater the response will be, and the greater the compressive strength of the concrete.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

What is claimed is:

1. A method for producing a cement mix comprising mixing water, cement, carbon dioxide, an admixture, and, optionally, aggregates, wherein the combination of carbon dioxide and admixture results in a concrete mix with a compressive strength at one or more time points that is greater than the same concrete mix with just admixture, and/or the same concrete mix with just carbon dioxide.

2. The method of claim 1 wherein the carbon dioxide is present in an amount from 0.01 to 5% by weight cement (bwc).

3. The method of claim 1 wherein the admixture comprises a dispersant, a water reducer, an air entrainer, or a combination thereof.

4. The method of claim 1 wherein the admixture comprises polyacrylate, such as sodium polyacrylate; polycarboxylate, such as polycarboxylate ether; lignin, such as a lignin polymer, a lignosulphate, a lignosulfonate triethanolamine; triethanolamine (TEA); a nitrate, such as sodium nitrate; a thiocyanate, such as sodium thiocyanate; or a combination thereof.

5. The method of claim 1 wherein the admixture is present in an amount from 0.1 to 5% by weight cement (bwc).

6. The method of claim 4 wherein the admixture comprises a polycarboxylate or polycarboxylate derivative.

7. The method of claim 6 wherein the admixture comprises a polycarboxylate ether.

8. The method of claim 6 wherein the polycarboxylate or polycarboxylate derivative is present in an amount from 0.1 to 1% by weight cement (bwc).

9. The method of claim 1 wherein the admixture comprises a lignin or lignin derivative.

10. The method of claim 9 wherein the admixture comprises lignosulfate, lignosulfonate, or a combination thereof.

11. The method of claim 9 wherein the admixture is present in an amount from 0.2 to 5% by weight cement (bwc).

12. The method of claim 1 wherein the admixture comprises a polyacrylate or polyacrylate derivative.

13. The method of claim 12 wherein the admixture is present in an amount from 0.02 to 0.3% by weight cement (bwc).

14. The method of claim 1 wherein the combination of carbon dioxide and admixture results in a concrete mix with a setting time that is within allowable limits, whereas the same concrete mix with just admixture, and/or the same concrete mix with just carbon dioxide results in a concrete mix with a setting time that is not within allowable limits.

15. A composition comprising
(i) a hydraulic cement;
(ii) water;
(iii) carbon dioxide and/or reaction products of carbon dioxide with the hydraulic cement, in an amount from 0.01 to 5% bwc; and
(iv) an admixture in an amount from 0.01 to 5% bwc.

16. The composition of claim 15 wherein the admixture comprises polyacrylate, such as sodium polyacrylate; polycarboxylate, such as polycarboxylate ether; lignin, such as a lignin polymer, a lignosulphate, a lignosulfonate triethanolamine; triethanolamine (TEA); a nitrate, such as sodium nitrate; a thiocyanate, such as sodium thiocyanate; or a combination thereof.

17. The composition of claim 16 wherein the admixture comprises a polycarboxylate or polycarboxylate derivative.

18. The composition of claim 17 wherein the admixture comprises a polycarboxylate ether.

19. The composition of claim 17 wherein the polycarboxylate or polycarboxylate derivative is present in an amount from 0.1 to 1% by weight cement (bwc).

20. The composition of claim 16 wherein the admixture comprises a lignin or lignin derivative.

21. The composition of claim 20 wherein the admixture comprises lignosulfate, lignosulfonate, or a combination thereof.

22. The composition of claim 20 wherein the admixture is present at a concentration of is present in an amount from 0.2 to 5% by weight cement (bwc).

23. The composition of claim 16 wherein the admixture comprises a polyacrylate or polyacrylate derivative.

24. The composition of claim 23 wherein the admixture is present in an amount from 0.02 to 0.3% (bwc).

25-80. (canceled)
